(19) United States
(12) Patent Application Publication
(10) Pub. No.: US 2002/0150374 A1
(43) Pub. Date: Oct. 17, 2002

(54) Mechanism for retrofitting an optical assembly housing

(76) Inventor: Cameron D. Hinman, Woodside, CA (US)

Correspondence Address: SAWYER LAW GROUP LLP, P O BOX 51418, PALO ALTO, CA, 94303, US

(21) Appl. No.: 10/099,733

(22) Filed: Mar. 15, 2002

Related U.S. Application Data
(60) Provisional application No. 60/276,639, filed on Mar. 16, 2001.
(60) Provisional application No. 60/276,636, filed on Mar. 16, 2001.

(51) Int. Cl. G02B 6/36

(52) U.S. Cl. 385/136; 385/53

(57) ABSTRACT

The present invention provides a harness for retrofitting optical subassemblies in an optical assembly housing. Each optical subassembly resides in a feature in the harness. The features of the harness constrain the optical subassemblies in the six possible degrees of freedom without requiring assistance from the housing. When residing with the housing, the harness is also constrained in the six possible degrees of freedom. When an optical subassembly is to be upgraded or replaced, a harness with different features may be used to facilitate the upgrade or replacement. In addition, the harness with different features may be used to change or add a characteristic of the assembled device without requiring significant changes to the optical assembly housing. The harness thus reduces the difficulties in adding or changing the assembly optical device, which may also reduce the costs of the addition or change.

### FIELD OF THE INVENTION

The present invention relates to optical assemblies, and more particularly to the housing of optical assemblies.

### BACKGROUND OF THE INVENTION

Devices which comprise transmitter optical subassemblies (TOSA) and/or receiver optical subassemblies (ROSA) are well known in the art. These subassemblies necessarily require a housing in which the TOSA, ROSA, and other components, such as a circuit board, can reside. Typically, the housing is designed for specific types of TOSA and ROSA. This is due to the requirement that the TOSA and ROSA be firmly constrained within the housing to ensure consistent performance. However, when either the TOSA or the ROSA is to be replaced or upgraded to a different type, the housing may require redesign. This may result in an undesirable increase in costs for retooling for the manufacturing of the housing, for the new manufacturing line, for the new tests which may be required, and possibly new certification as well.

Accordingly, there exists a need for a mechanism for retrofitting an optical assembly housing. The mechanism should reduce the costs for retooling when an optical subassembly is to be replaced or upgraded. The present invention addresses such a need.

### SUMMARY OF THE INVENTION

A harness, apparatus, and method of manufacturing the harness or apparatus for retrofitting optical subassemblies in an optical assembly housing is provided.

In one aspect of the invention, the harness secures a firs toptical subassembly in a housing, wherein the housing has been previously designed to hold a second optical subassembly having a form factor different than the first optical subassembly. The harness comprises a harness body having an external surface adapted to conform with at least one surface feature on the interior of the housing, wherein the interface between the harness body and the surface feature on the interior of the housing secures the harness body from moving within the housing. The harness body forms a cavity adapted to conform with at least one surface feature on the firs toptical subassembly, wherein tehinterface between the harness body and the surface feature on the firs toptical subassembly secures the first optical subassembly from moving within the harness.

In another aspect of the invention, a harness with different internal features that correspond to the replacement subassembly may be used in the optical assembly housing. Retooling for changes in the optical assembly housing is not required. By retaining the external features, the characteristics of the harness, such as its electromagnetic intererference, electrical, and thermal properties, remain consistent. For example, an optical assembly housing with a non-grating stabilized laser can be retrofitted for a grating stabilized laser utilizing the harness. The internal features of this harness would correspond to the features on the grating stabilized laser.

In another aspect of the invention, the harness is manufacturing utilizing molds. The same mold may be used to manufacture a great number of harnesses, thus reducing the cost of manufacturing. When an optical subaseembly is to be replaced or upgraded, the portion of the mold pertaining to the internal features of the harness can be changed without requiring change in the portion pertaining to the external features.

In another aspect of the invention, the harness with different features may be used to change or add a characteristic of the assembled device without requiring significant changes to the optical assembly housing. Alternatively, one or more of the characteristics of the device may be molded into the harness rather than the housing to facilitate easier upgrades/replacements in the future.

In another aspect of the invention, the features of the harness constrain the optical subassemblies in the six possible degrees of freedom without requiring assistance from the housing. When residing with the housing, the harness is also constrained in the six possible degrees of freedom. This allows the harness and the optical subassemblies to be assembled as a unit without the requirement that they reside within the optical assembly housing.

### BRIEF DESCRIPTION OF THE FIGURES

FIGS. 1A-1D illustrate a top perspective view, bottom perspective view, side view, and top view, respectively, of the bottom portion of the first embodiment of the harness in accordance with the present invention.

FIGS. 1E-3H illustrates a top perspective view, bottom perspective view, side view, and top view, respectively, of the top portion of the first embodiment of the harness in accordance with the present invention.

FIG. 1I illustrates a top perspective view of a combination of the bottom portion and to portion of the first embodiment of the harness, with a receiver optical subassembly (ROSA) and a transmitter optical subassembly (TOSA), in accordance with the present invention.

FIG. 1J illustrates a top view and an end view of the combination of the bottom portion and top portion of the first embodiment of the harness, with approximate dimensions, in accordance with the present invention.

FIGS. 2 illustrates a top perspective view of the bottom portion of a first embodiment of an optical assembly housing which can be retrofitted by the first embodiment of the harness in accordance with the present invention.

FIG. 3 illustrates a top perspective view of a combination of the bottom portion of the first embodiment of the harness and the bottom portion of the first embodiment of the optical assembly housing in accordance with the present invention.

FIG. 4 illustrates a top perspective view of a combination of the bottom portion of the first embodiment of the harness, the bottom portion of the first embodiment of the housing, a receiver optical subassembly (ROSA), and a transmitter optical subassembly (TOSA), in accordance with the present invention.

FIG. 5 illustrates a top perspective view of a combination of a top portion and the bottom portion of the first embodiment of the harness, the bottom portion of the first embodiment of the housing, the ROSA, and the TOSA, in accordance with the present invention.

FIG. 6 illustrates a top perspective view of the first embodiment of the optical assembly housing retrofitted with the first embodiment of the harness in accordance with the present invention.

FIGS. 7A-7D illustrate a top perspective view, bottom perspective view, end view, and top view, respectively, of the bottom portion of the second preferred embodiment of the harness in accordance with the present invention.

FIGS. 7E-7H illustrate a top perspective view, bottom perspective view, end view, and top view, respectively, of the top portion of the second preferred embodiment of the harness in accordance with the present invention.

FIG. 7I illustrates a top perspective view of a combination of the bottom portion and to portion of the first embodiment of the harness, with a ROSA and a TOSA, in accordance with the present invention.

FIG. 7J illustrates a top view and an end view of the combination of the bottom portion and top portion of the first embodiment of the harness, with approximate dimensions, in accordance with the present invention.

FIG. 8A illustrates a top perspective view of a combination of the bottom portion of the second embodiment of the harness and the bottom portion of the second embodiment of the optical assembly housing in accordance with the present invention.

FIG. 8B illustrates a top perspective view of the bottom portion of the second embodiment of the harness, the bottom portion of the second embodiment of the housing, a ROSA, and a TOSA, in accordance with the present invention.

FIG. 9 illustrates a top perspective view of a combination of a top portion and the bottom portion of the first embodiment of the harness, the bottom portion of the housing, the ROSA, and the TOSA, in accordance with the present invention.

FIG. 10 illustrates a top perspective view of the second embodiment of the optical assembly housing retrofitted with the second embodiment of the harness in accordance with the present invention.

FIGS. 11A-11D illustrate a top perspective view, a bottom perspective view, a side view and a top view, respectively, of the bottom portion of the third embodiment of the harness in accordance with the present invention.

FIGS. 12A-12D illustrate a top perspective view, a bottom perspective view, a side view, and a top view of the top portion of the third embodiment of the harness in accordance with the present invention.

FIG. 12E illustrates a top view and an end view of the combination of the bottom portion and top portion of the third embodiment of the harness, approximate dimensions, in accordance with the present invention.

FIG. 13 illustrates a top perspective view of the bottom portion of a third embodiment of an optical assembly housing which can be retrofitted by the third embodiment of the harness in accordance with the present invention.

FIG. 14 illustrates a top perspective view of a combination of the bottom portion of the third embodiment of the harness and the bottom portion of the third embodiment of the optical assembly housing in accordance with the present invention.

FIG. 15 illustrates a top perspective view of a combination of the top and bottom portions of the third embodiment of the harness, the bottom portion of the third embodiment of the housing, the ROSA, and the TOSA, in accordance with the present invention.

FIG. 16 illustrates a top perspective view of the third embodiment of the optical assembly housing retrofitted with the third embodiment of the harness in accordance with the present invention.

FIGS. 17A-17D illustrate a top perspective view, a bottom perspective view, a side view, and a top view, respectively, of the bottom portion of the fourth embodiment of the harness in accordance with the present invention.

FIGS. 18A-18D illustrates a top perspective view, a bottom perspective view, a side view, and a top view, respectively, of the top portion of the fourth embodiment of the harness in accordance with the present invention.

FIG. 19 illustrates a top perspective view of a combination of the bottom portion and top portion of the harness in accordance with the present invention.

FIGS. 20A-20D illustrate a top perspective view, a bottom perspective view, a side view, and a top view of the clip of the fourth embodiment of the harness in accordance with the present invention.

FIG. 21A illustrates a top perspective view of a combination of the bottom portion, top portion, and clip of the fourth embodiment of the harness in accordance with the present invention.

FIG. 21B illustrates a top view and an end view of the combination of the bottom portion, top portion, and clip of the fourth embodiment of the harness, with approximate dimensions, in accordance with the present invention.

FIG. 22 illustrates a top perspective view of the bottom portion of the fourth embodiment of the housing which can be retrofitted by the fourth embodiment of the harness in accordance with the present invention.

FIG. 23 illustrates a top perspective view of a combination of the harness and bottom portion of the optical assembly housing in accordance with the present invention.

FIG. 24 illustrates a bottom perspective view of the top portion of the fourth embodiment of the housing which can be retrofitted by the fourth embodiment of the harness in accordance with the present invention.

FIG. 25 illustrates a top perspective view of the fourth embodiment of the optical assembly housing retrofitted with the fourth embodiment of the harness in accordance with the present invention.

FIGS. 26A-26D illustrate a top perspective view, a bottom perspective view, of the bottom portion of the fifth embodiment of the harness in accordance with the present invention.

FIG. 27 illustrates a top perspective view of a combination of the bottom portion of the fifth embodiment of the harness, a ROSA, a TOSA, and a thermal electric cooler (TEC), in accordance with the present invention.

FIG. 28 illustrates in more detail a top perspective view of the thermal conductive material (TCM) for the fifth embodiment of the harness in accordance with the present invention.

FIGS. 29A-29D illustrate a top perspective view, a bottom perspective view, a side view, and a top view of the top portion of the fifth embodiment of the harness in accordance with the present invention.

FIG. 29E illustrates a top perspective view of a combination of the bottom and top portions of the harness with the ROSA and TOSA, in accordance with the present invention.

FIG. 29F illustrates a top view and an end view of the combination of the bottom portion and top portion of the fifth embodiment of the harness, with approximate dimensions, in accordance with the present invention.

FIG. 30 illustrates a top perspective view of a combination of the bottom portion of the fifth embodiment of the harness with the TEC and the bottom portion of the second embodiment of the housing in accordance with the present invention.

FIG. 31 illustrates a top perspective view of a combination of the top and bottom portions of the fifth embodiment of the harness, the bottom portion of the second embodiment of the housing, the ROSA, and the TOSA, in accordance with the present invention.

FIG. 32 illustrates a top perspective view of the second embodiment of the optical assembly housing retrofitted by the fifth embodiment of the harness in accordance with the present invention.

FIGS. 33A-33D illustrate a top perspective view, bottom perspective view, end view, and top view, respectively, of a bottom portion of the sixth embodiment of a harness for retrofitting an optical assembly housing in accordance with the present invention.

FIGS. 34A-34D illustrate a top perspective view, bottom perspective, end view, and top view, respectively, of the top portion of the sixth embodiment of the harness in accordance with the present invention.

FIG. 35 illustrates a top perspective view of a combination of the bottom portion and top portion of the sixth embodiment of the harness, with a ROSA and TOSA, in accordance with the present invention.

FIG. 36 illustrates a top view, end view, and side view of the combination of the bottom portion and top portion of the sixth embodiment of the harness, with approximate dimensions, in accordance with the present invention.

FIG. 37 illustrates a top perspective view of a combination of the bottom portion of the sixth embodiment of the harness with a bottom portion of the third embodiment of the housing in accordance with the present invention.

FIG. 38 illustrates a top perspective view of the combination of the bottom portion of the sixth embodiment of the harness, the bottom portion of the third embodiment of the housing, the ROSA, and the TOSA, in accordance with the present invention.

FIG. 39 illustrates a top perspective view of a combination of the sixth embodiment of the harness, the bottom portion of the third embodiment of the housing, the ROSA, and TOSA in accordance with the present invention.

FIG. 40 illustrates a top perspective view of the third embodiment of the optical assembly housing retrofitted with the sixth embodiment of the harness in accordance with the present invention.

FIGS. 41A-41D illustrate a top perspective view, bottom perspective view, end view, and top view, respectively, of the seventh embodiment of the harness in accordance with the present invention.

FIG. 42A illustrates a top perspective view of the seventh embodiment of the harness with a ROSA and a TOSA, in accordance with the present invention.

FIG. 42B illustrates a top view and an end view of the seventh embodiment of the harness with the ROSA and TOSA, with approximately dimensions, in accordance with the present invention.

FIG. 43 illustrates a top perspective view of a combination of the seventh embodiment of the harness, a bottom portion of the fifth embodiment of the housing, the ROSA, and the TOSA, in accordance with the present invention.

FIG. 44 illustrates a top perspective view of the fifth embodiment of the housing retrofitted with the seventh embodiment of the harness in accordance with the present invention.

FIGS. 45A-45B illustrate front and rear perspective views of a back plate of an eighth embodiment of the harness for retrofitting an optical assembly housing in accordance with the present invention.

FIG. 46 illustrates a top perspective view of the back plate of the eighth embodiment of the harness with a ROSA and a TOSA, in accordance with the present invention.

FIGS. 47A-47B illustrate front and rear perspective view of a front plate of the eighth embodiment of the harness in accordance with the present invention.

FIGS. 48A-48B illustrate a top perspective view, side view, cross-sectional top view, and enlarged side view of the back plate 4550 and the front plate 4700 of the eighth embodiment of the harness 4500, with the ROSA 402 and TOSA 404, in accordance with the present invention.

FIG. 48C illustrates a side view and top view of the eighth embodiment of the harness 4500, with approximate dimensions, in accordance with the present invention.

FIG. 49 illustrates a top perspective view of a bottom portion of a sixth embodiment of an optical assembly housing which can be retrofitted by the eighth embodiment of the harness in accordance with the present invention. FIG. 50 illustrates a top perspective view of a combination of the eighth embodiment of the harness, the bottom portion of the sixth embodiment of the housing, a ROSA, and TOSA in accordance with the present invention.

FIG. 51 illustrates a top perspective view of the sixth embodiment of the optical assembly housing retrofitted with the eighth embodiment of the harness in accordance with the present invention.

### DETAILED DESCRIPTION

The present invention provides a mechanism for retrofitting an optical assembly housing. The following description is presented to enable one of ordinary skill in the art to make and use the invention and is provided in the context of a patent application and its requirements. Various modifications to the preferred embodiment will be readily apparent to those skilled in the art and the generic principles herein may be applied to other embodiments. Thus, the present invention is not intended to be limited to the embodiment shown but is to be accorded the widest scope consistent with the principles and features described herein.

An exemplary embodiment of the present invention provides a harness which fits within an existing optical assembly housing. A “housing”, as used in this specification, refers to any surface or combination of surfaces on or in which at least part of the harness may reside. Each optical subassembly resides in a feature in the harness. The features of the harness constrain the optical subassemblies in the six possible degrees of freedom without requiring assistance from the housing. When residing with the housing, the harness is also constrained in the six possible degrees of freedom. When an optical subassembly is to be upgraded or replaced, a harness with different features may be used to facilitate the upgrade or replacement. In addition, the harness with different features may be used to change or add a characteristic of the assembled device without requiring significant changes to the optical assembly housing. Only the harness would need to be tested for this characteristic. For example, a harness with a different coating may be used to provide different EMI shielding or thermal dissipation characteristics. Alternatively, one or more of the characteristics of the device may be molded into the harness rather than the housing to facilitate easier upgrades/replacements in the future. The harness thus reduces the difficulties in adding or changing the assembly optical device, which may also reduce the costs of the addition or change.

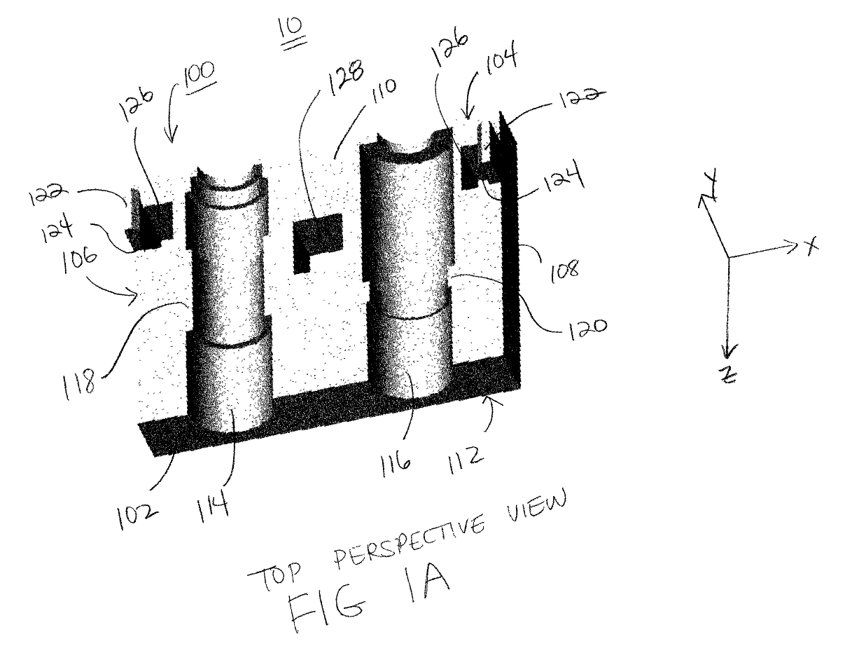

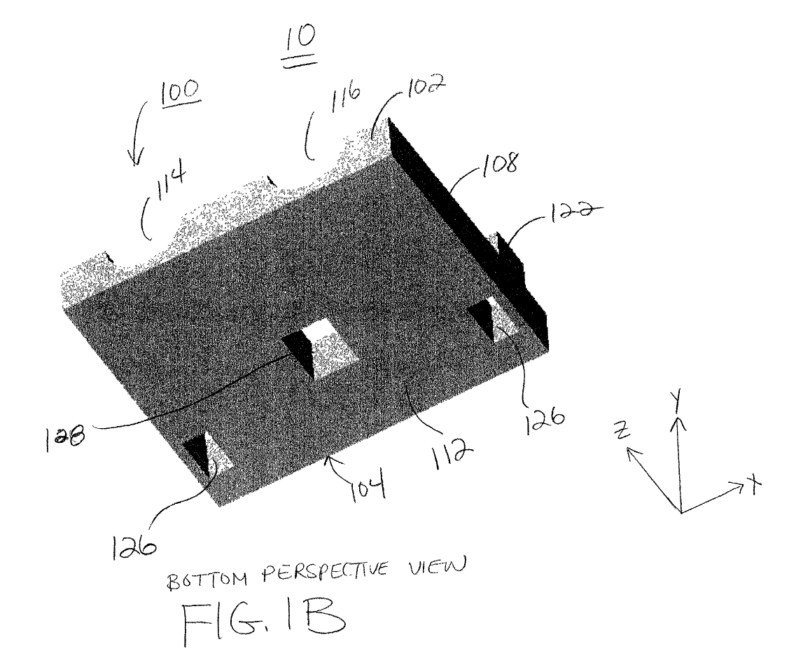

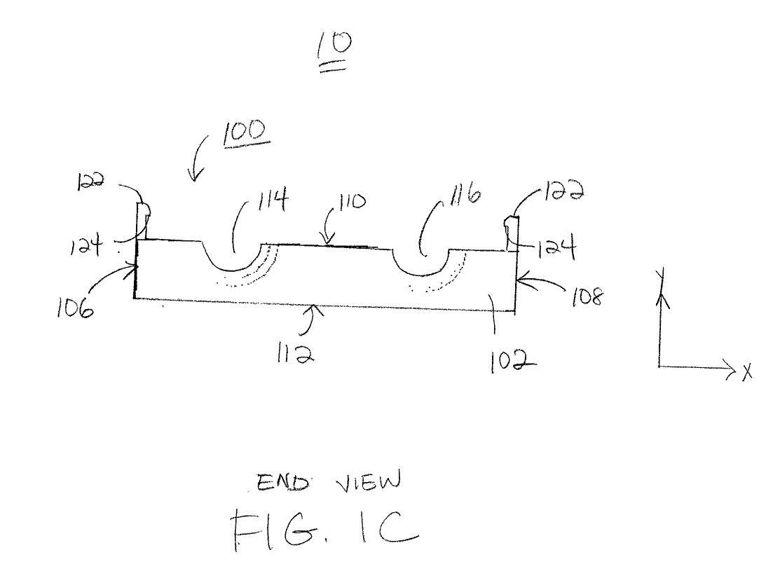

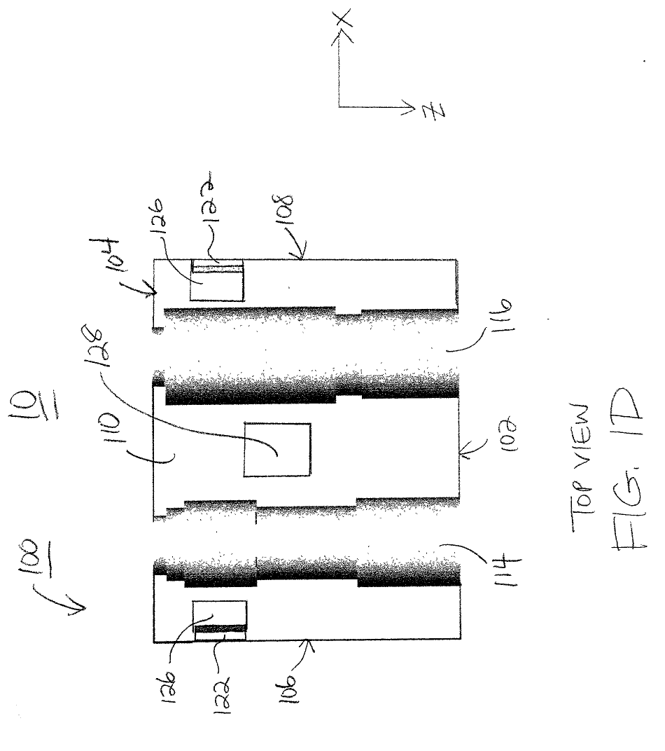

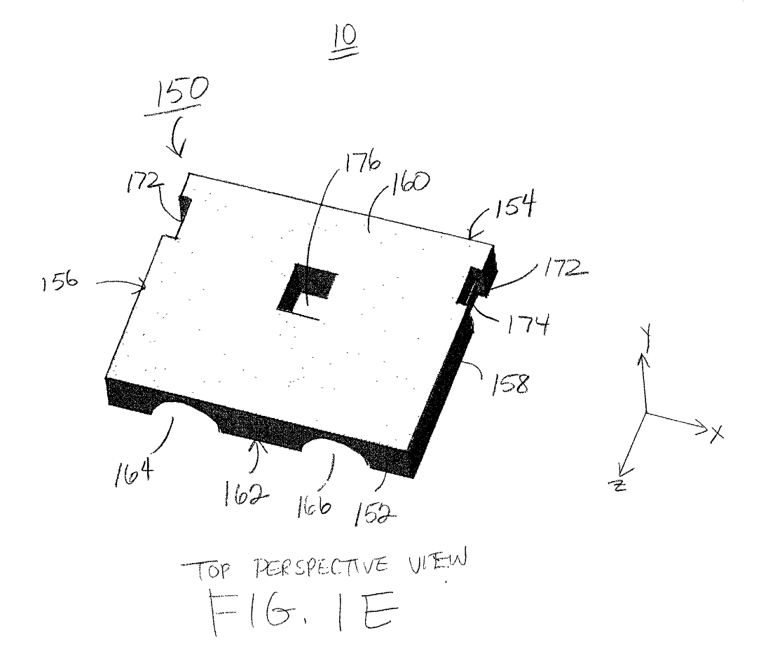

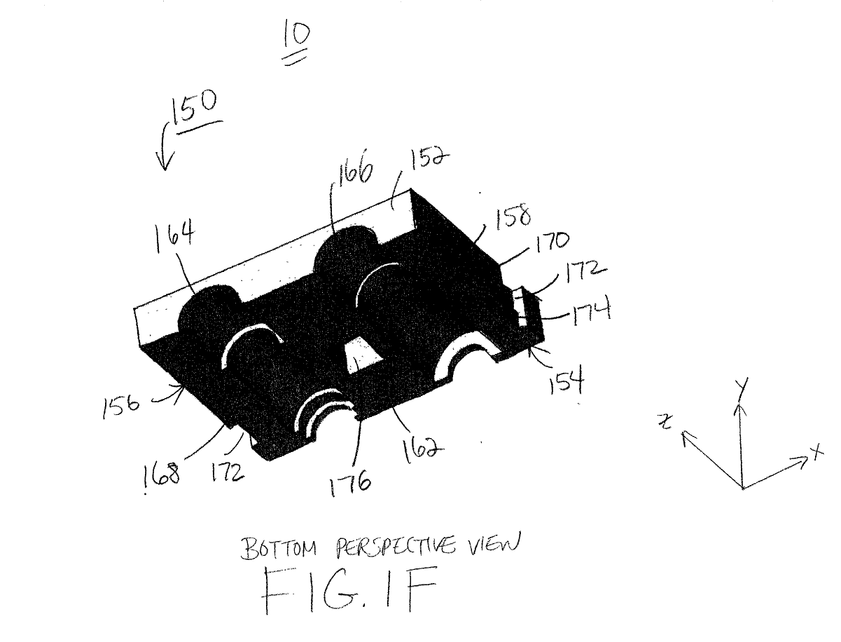

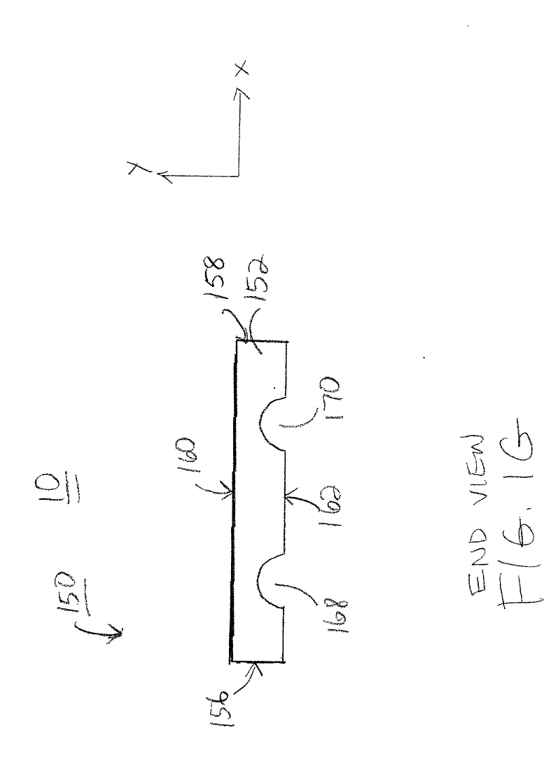

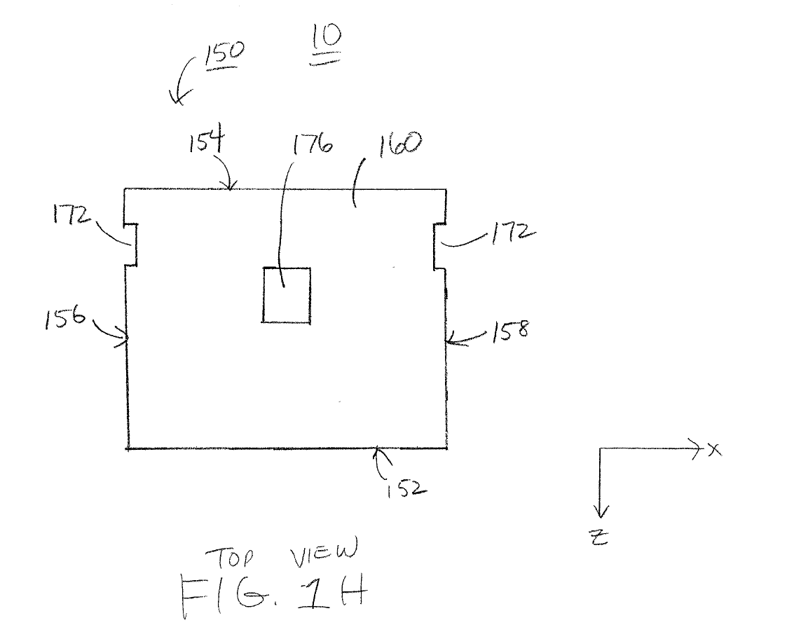

To more particularly describe the features of the present invention, please refer to FIGS. 1A through 44 in conjunction with the discussion below.

FIGS. 1A through 6 illustrate a first embodiment of a harness for retrofitting an optical assembly housing in accordance with the present invention. The first embodiment of the harness 10 comprises a top portion 100 and a bottom portion 150. The first embodiment of the harness 10 can be used to retrofit a first embodiment of an optical assembly housing 60.

FIGS. 1A-1D illustrate a top perspective view, bottom perspective view, end view, and top view, respectively, of the bottom portion 100 of the first embodiment of the harness 10 in accordance with the present invention. The bottom portion 100 of the harness 10 comprises a block of material with a first end face 102, a second end face 104, a first side face 106, a second side face 108, a top face 110, and a bottom face 112. At the top face 110 are a first feature 114 for a first optical subassembly (not shown) and a second feature 116 for a second optical subassembly (not shown). In the first embodiment, the features 114 and 116 are cavities in which the first and second subassemblies may reside. The cavities 114 and 116 traverse the top face 110 from the first end face 102 to the second end face 104. For example, a receiver optical subassembly (ROSA) can reside within the first cavity 114 while a transmitter optical subassembly (TOSA) can reside within the second cavity 116. The features of the cavities 114 and 116 can mirror the features of the bodies of the particular ROSA and TOSA to be used. For example, ridges 118 in the first cavity 114 and ridges 120 in the second cavity 116 may mirror the ridges of the bodies of the ROSA and TOSA.

The bottom portion 100 also comprises snaps 122 coupled to the first 106 and second 108 side faces and which extend in the y-direction. Each snap 122 comprises a lip 124 which engages a ridge on the top portion 150 of the harness 10, as described further with FIGS. 1E-1J. The snaps 122 assist in coupling the bottom 100 and top 150 portions of the harness 10.

Adjacent to the snaps 122 are openings 126 which traverse from the top face 110 to the bottom face 112. These openings 126 result from the molding of the bottom portion 100. In the first embodiment, the mold for the bottom portion 100 comprises two parts. The top part molds the features on the top face 110 and the snaps 122, while the bottom part molds the features on the bottom face 112 and the first 106 and second 108 side faces. If the top part is used to mold the lips 124 of the snaps 122, when the two parts of the mold are removed from each other, the lips 124 will remain coupled to the top part of the mold. This increases the complexity of removing the bottom portion 100 from the mold. To avoid this complexity, the lips 124 are formed by the bottom part of the mold instead. The top part of the mold creates the snaps 122 without the lips. The bottom part creates openings which extend from the bottom face 112 of the bottom portion 100 to a location below the end of the snaps 122, effectively creating the lips 124. This results in the openings 126. When the two parts of the mold are removed from each other, the lips 124 do not remain coupled to the top part of the mold.

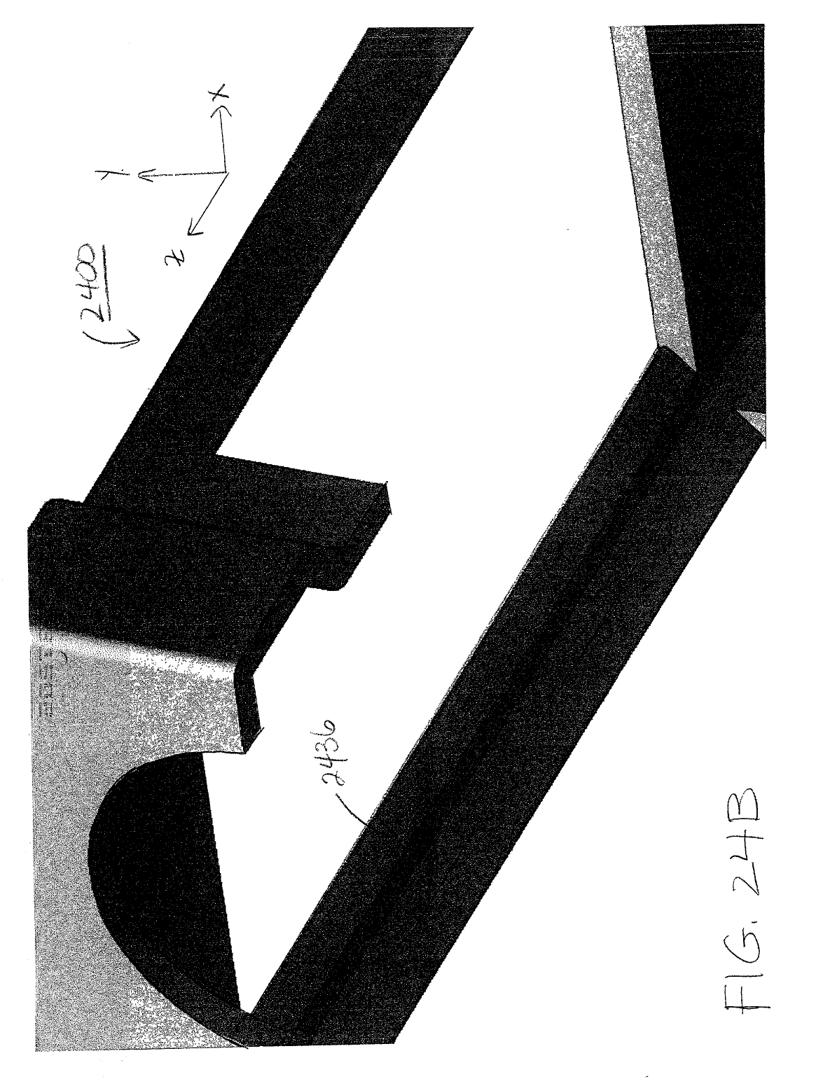

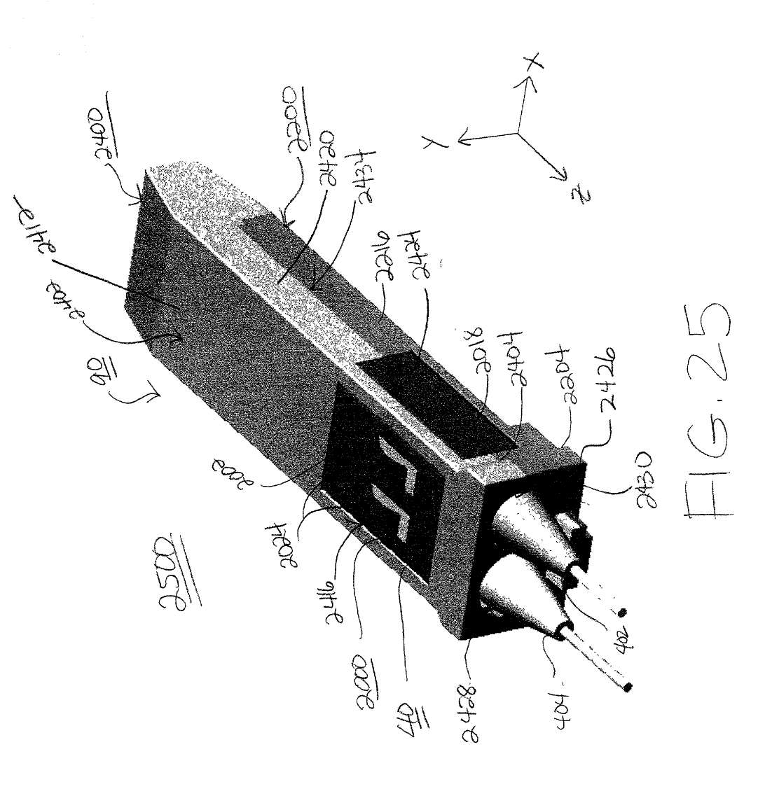

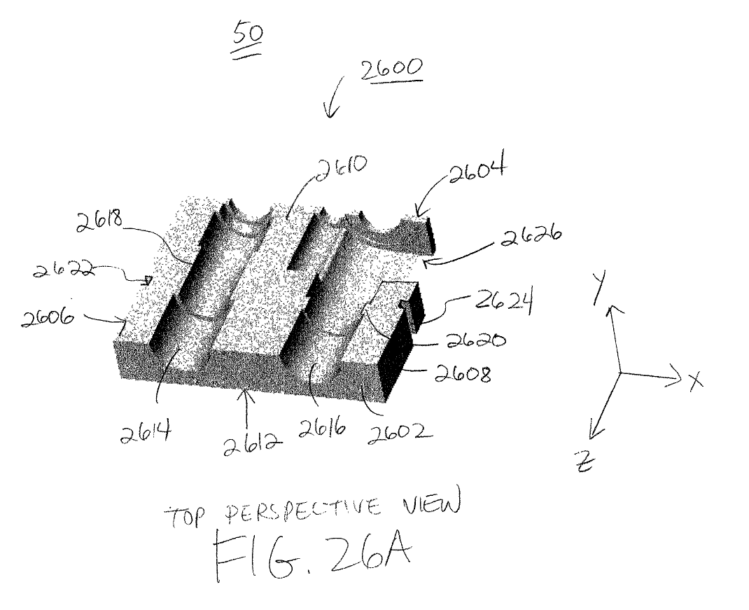

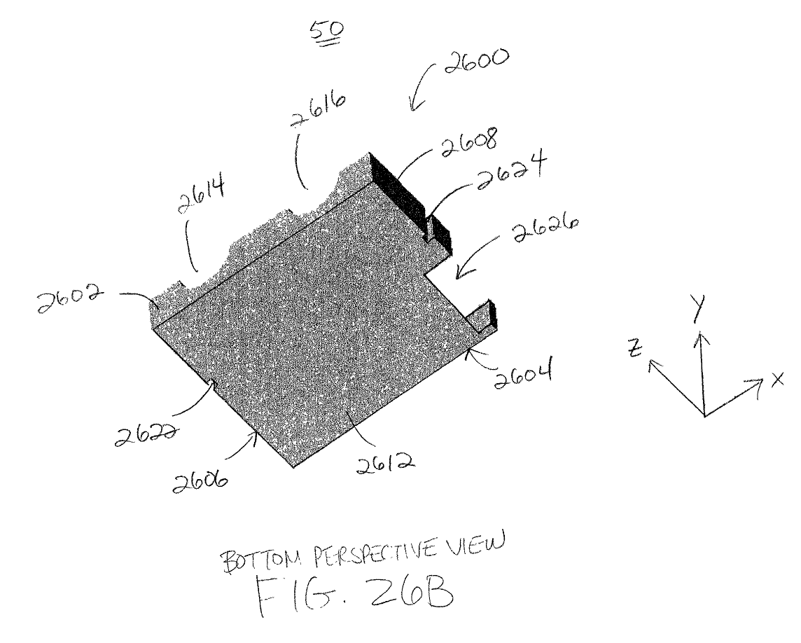

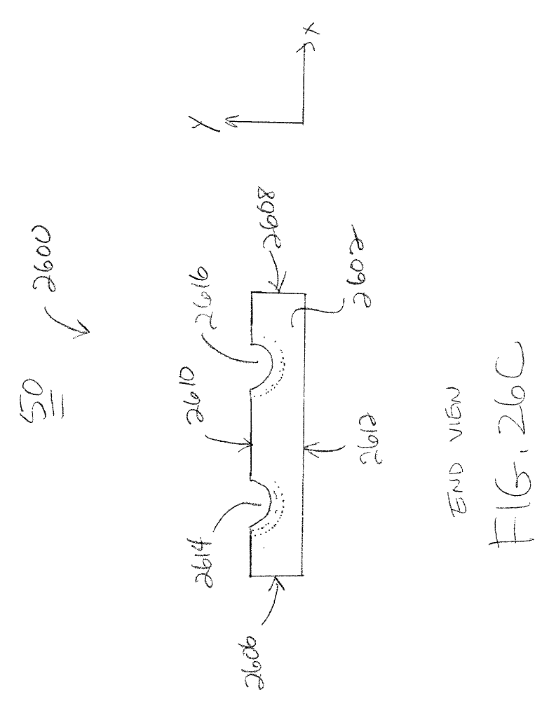

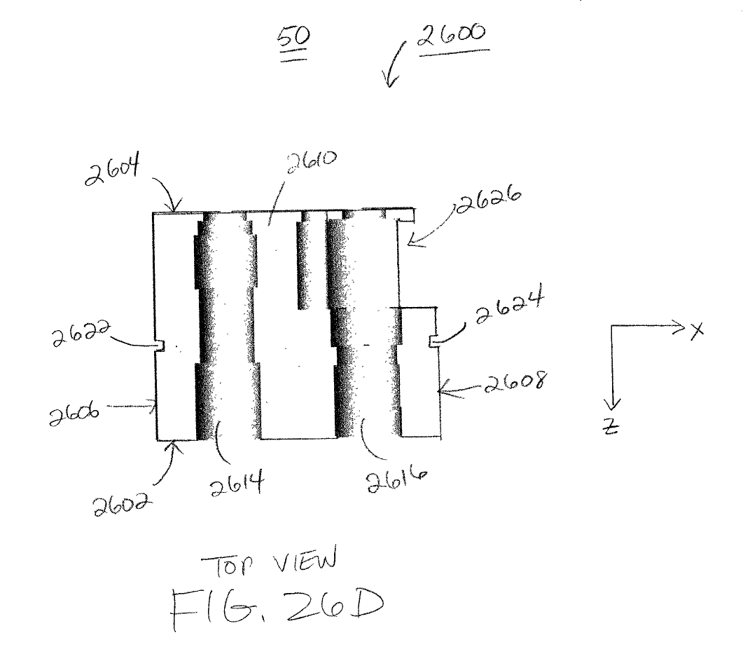

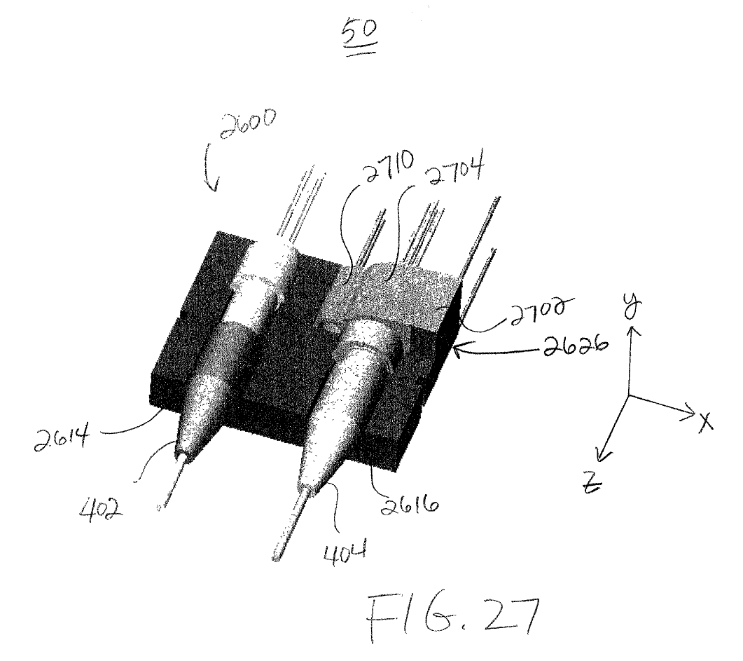

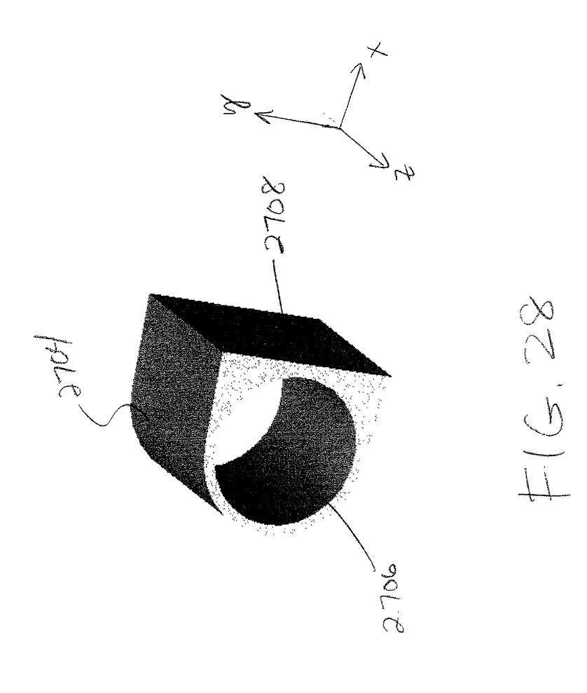

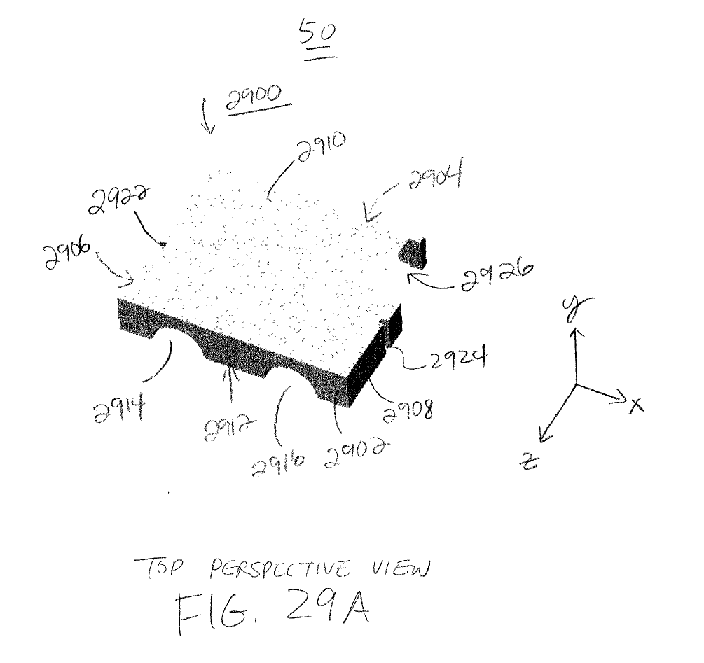

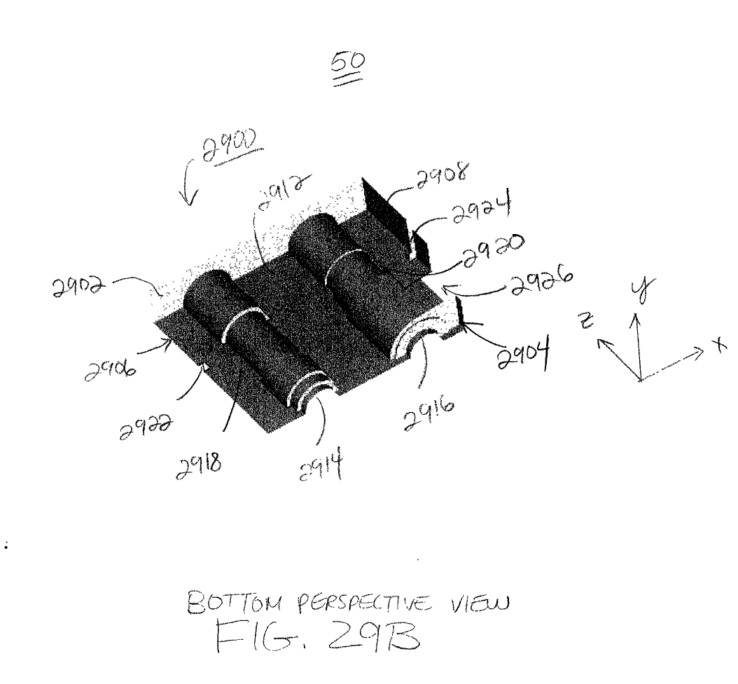

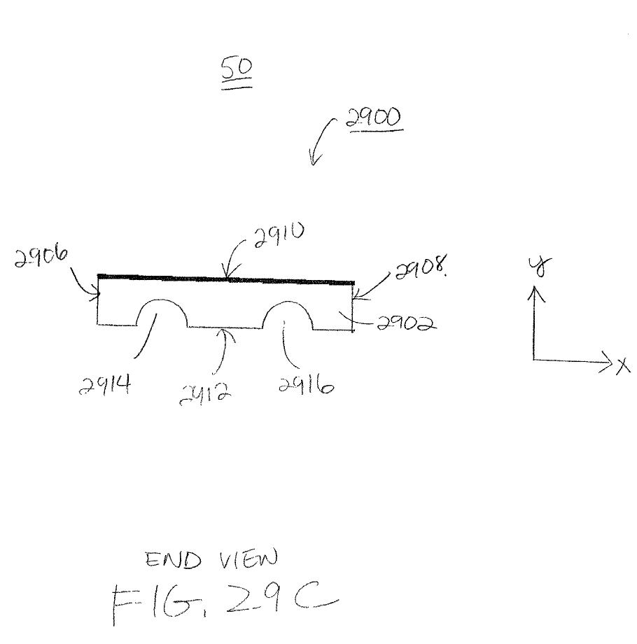

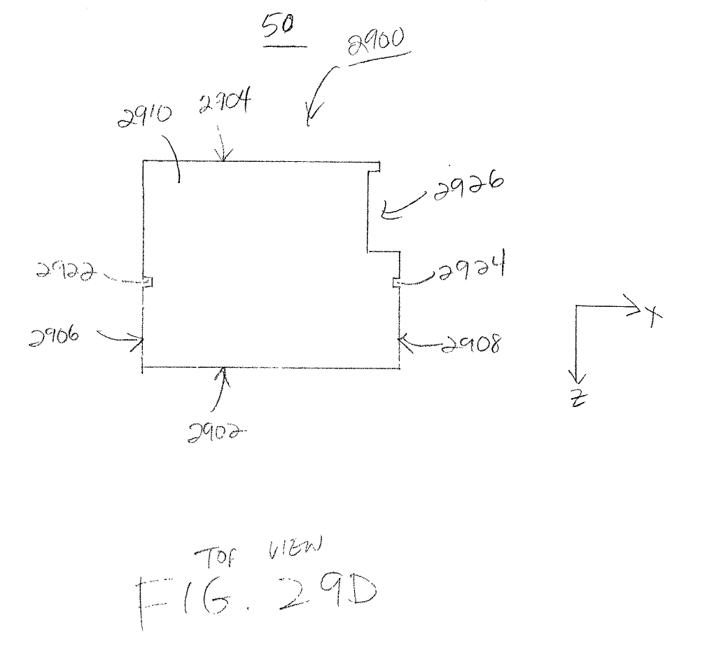

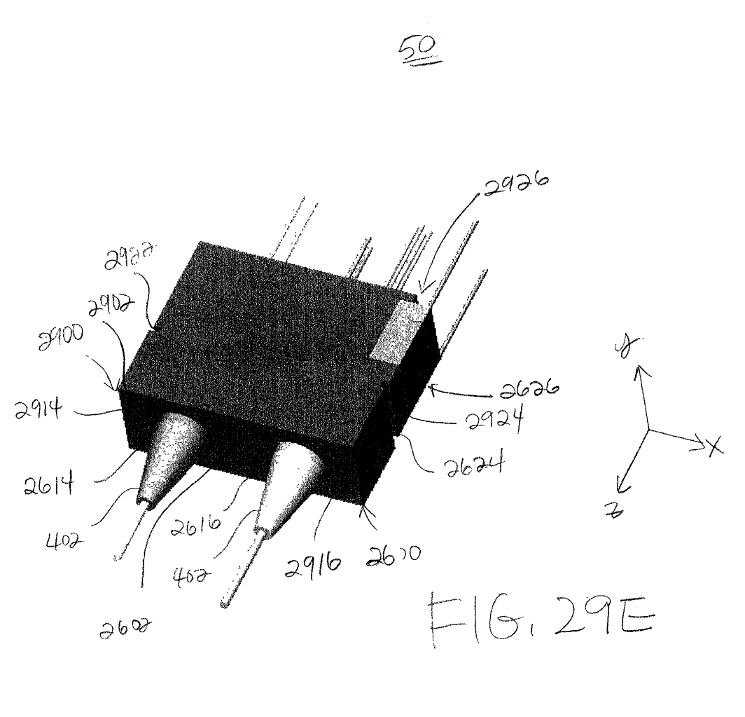

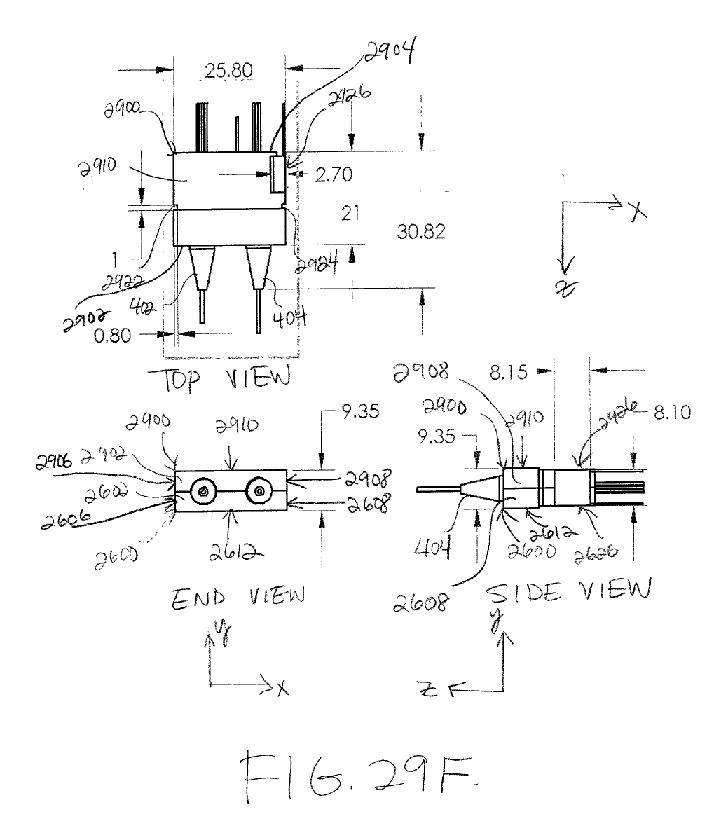

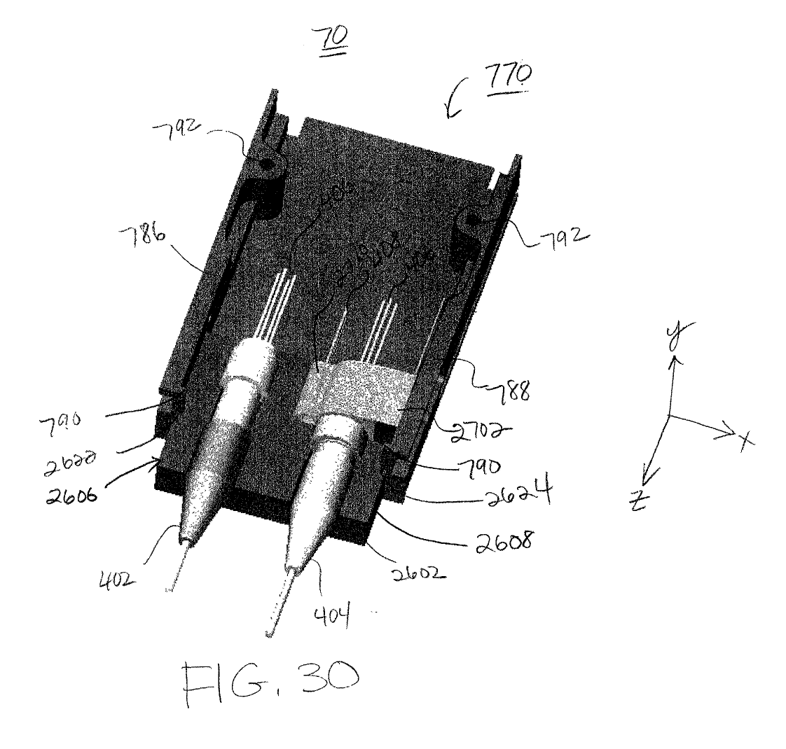

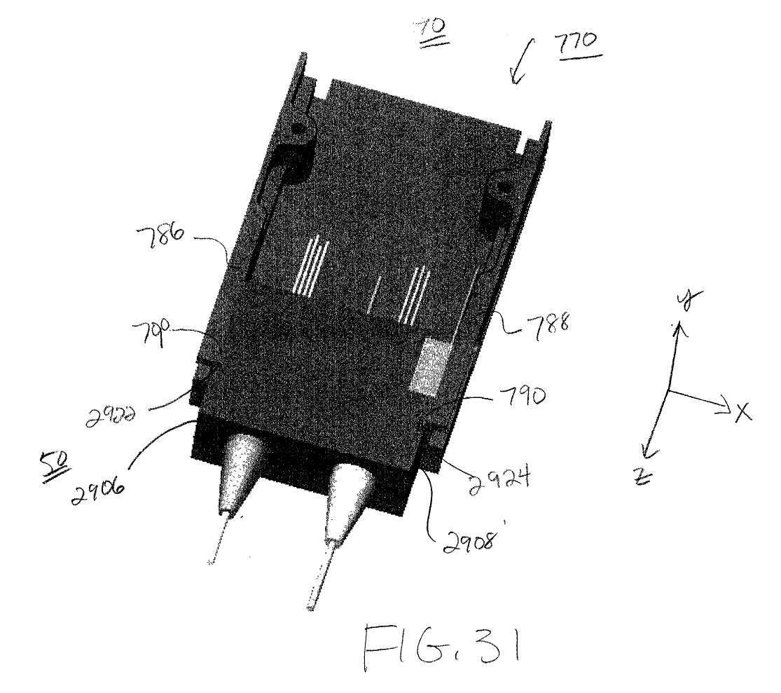

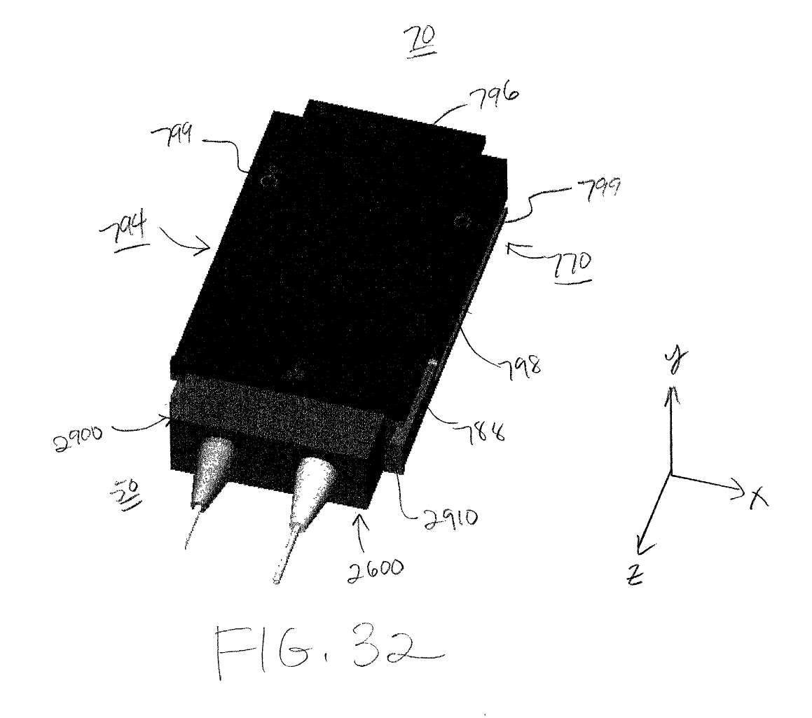

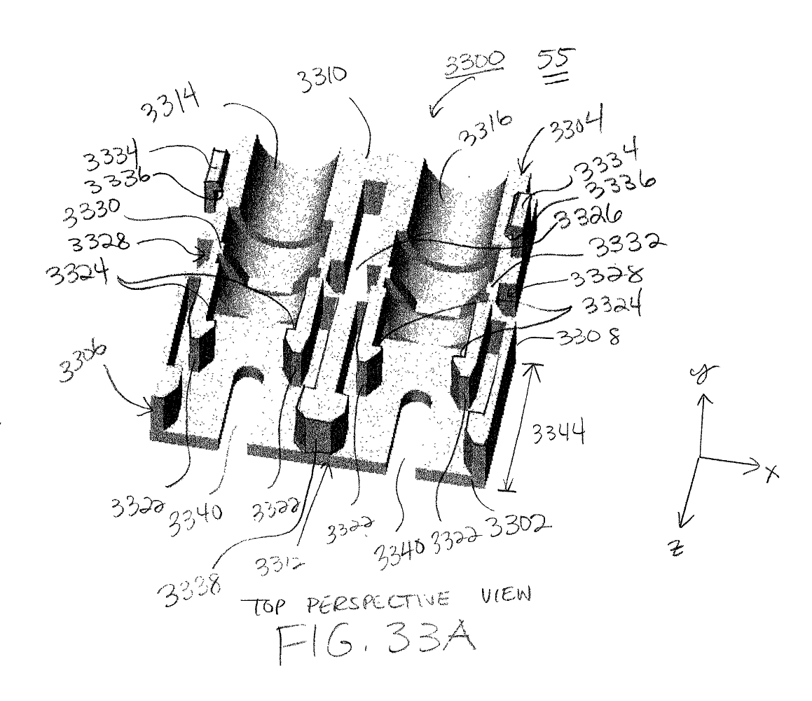

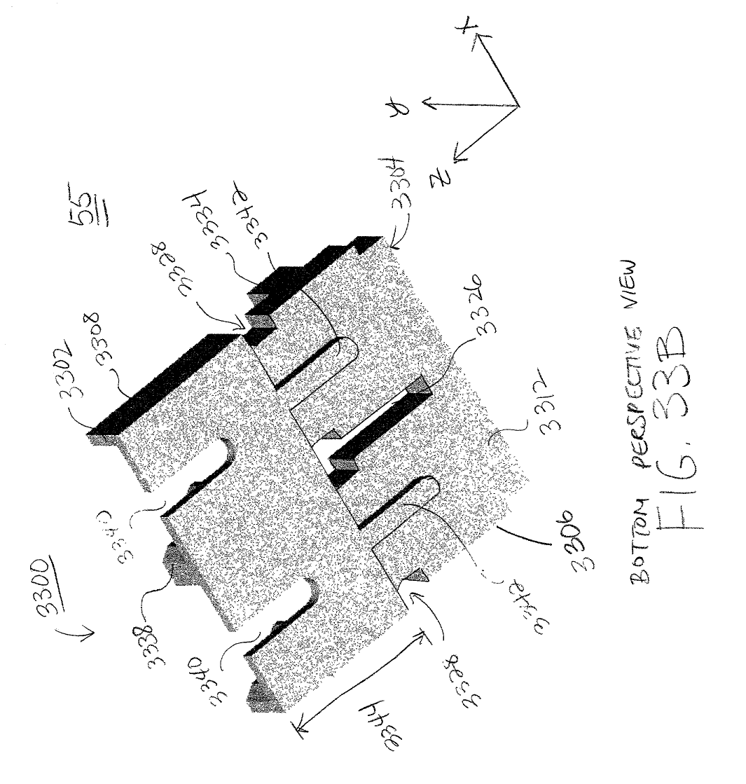

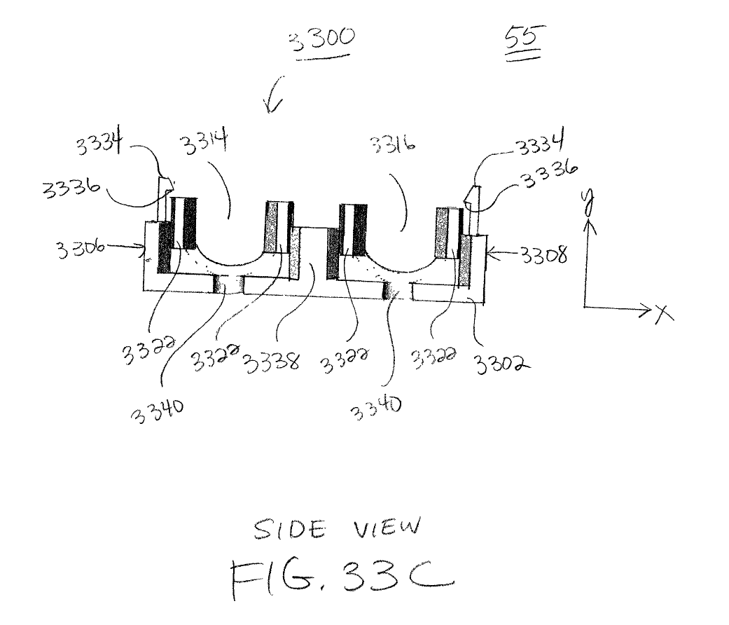

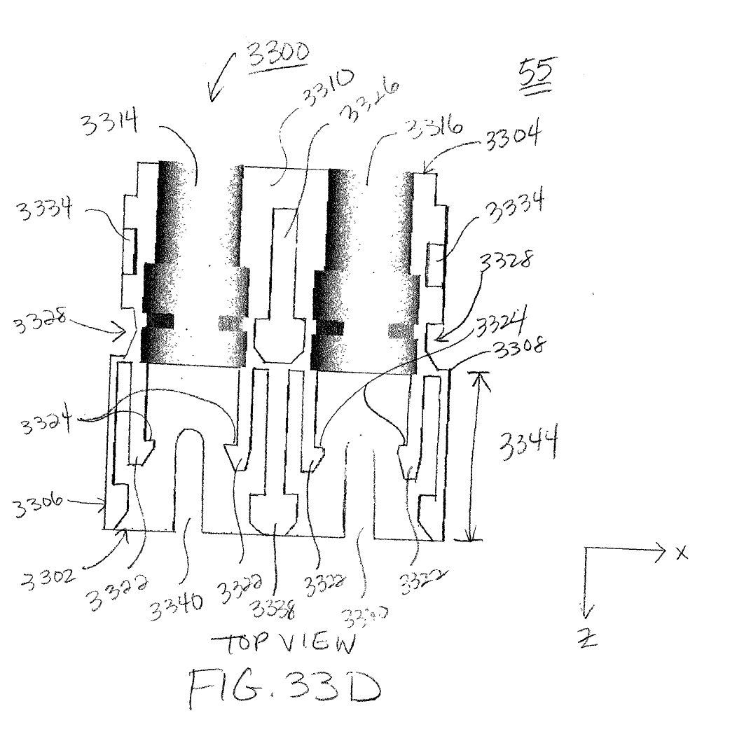

The first embodiment also comprises an opening 128 which traverses from the top face 110 to the bottom face 112. The function of the opening 124 will be described below in conjunction with FIG. 3.

FIGS. 1E-1H illustrate a top perspective view, bottom perspective view, end view, and top view, respectively, of the top portion 150 of the first embodiment of the harness 10 in accordance with the present invention. The top portion 150 of the harness 10 comprises a block of material with a first end face 152, a second end face 154, a first side face 156, a second side face 158, a top face 160, and a bottom face 162. At the bottom face 162 are a first feature 164 for the first optical subassembly (not shown), such as a ROSA, and a second feature 166 for the second optical subassembly (not shown), such as a TOSA. In the first embodiment, the features 164 and 166 are cavities in which the first and second subassemblies may reside. The cavities 164 and 166 traverse the bottom face 162 from the first end face 152 to the second end face 154. The features of the cavities 164 and 166 can mirror the features of the bodies of the particular ROSA and TOSA to be used. For example, ridges 168 in the first cavity 164 and ridges 170 in the second cavity 166 may mirror the ridges of the bodies of the ROSA and TOSA.

The top portion 150 also comprises indentions 172 which comprise ridges 174 at the first 156 and second 158 side faces. The snaps 122 of the bottom portion 100 may reside within the indentions 172 with the ridges 174 engaging the lips 124. The engaging of the ridges 174 and the lips 124 couples the bottom 100 and top 150 portions of the harness 10.

The first embodiment also comprises an opening 176 which traverses from the top face 160 to the bottom face 162. The function of the opening 176 will be described below in conjunction with FIG. 3.

FIG. 1I illustrates a top perspective view of a combination of the bottom portion 100 and top portion 150 of the first embodiment of the harness 10, with a ROSA and a TOSA, in accordance with the present invention. The bottom 100 and top 150 portions are coupled such that the top face 110 (hidden) of the bottom portion 100 abuts the bottom face 162 (hidden) of the top portion 150. The first end face 102 of the bottom portion 100 is proximate to the first end face 152 of the top portion 150. The snaps 122 of the bottom portion 100 reside within the indentions 172 of the top portion 150, with the lips 124 (hidden) of the snaps 122 engaging the ridges 174 (hidden). This couples the bottom portion 100 and the top portion 150 together. When coupled in this manner, the ROSA 402 resides within the first cavity 114 of the bottom portion 100 and the first cavity 154 of the top portion 150, and the TOSA 404 resides within the second cavity 116 of the bottom portion 100 and the second cavity 156 of the top portion 150. The location of the opening 128 (hidden) of the bottom portion 100 also corresponds to the location of the opening 176 of the top portion 150.

When engaged, the harness 10 constrains the ROSA and TOSA from translation along the x- and z- axes and from rotating about the x- and y-axes. The engagement also applies pressure in the y-direction to constrain the ROSA and TOSA from translating along the y-axis and rotating about the z-axis. The ROSA and TOSA are thus constrained within the harness 10 in the six possible degrees of freedom.

The top 150 and bottom 100 portions may be coupled without assistance from the housing 60. This allows the harness 10 to be a separate unit apart form the housing 60 and may be shipped as such. The harness 10 may be used to provide a consistent pin orientation on the ROSA or TOSA, which may provide simpler assembly of the device. To further aid assembly, the harness 10 may also comprise a feature for a distinctive pin to be used as a reference.

Although the top 150 and bottom 100 portions of the harness 10 are described as coupled using the snaps 122, other methods of coupling may be used without departing from the spirit and scope of the present invention. For example, a threaded fastener, epoxy, an interference method, or a living hinge may be used.

FIG. 1J illustrates a top view and an end view of the combination of the bottom portion 100 and top portion 150 of the first embodiment of the harness 10, with approximate dimensions, in accordance with the present invention. In the first embodiment, the length of the first end face 102 and the second end face 104 (hidden) of the bottom portion 100, and the first end face 152 and the second end face 154 of the top portion 150, are approximately 25.80 mm. The length of the first side face 106 and second side face 108 of the bottom portion 100, and the first side face 156 and second side face 158 of the top portion 150, are approximately 30.82 mm. The dimensions of the opening 128 (hidden) of the bottom portion 100 and the opening 176 of the top portion 150 are approximately 4.5 mm×3.50 mm, with the 4.5 mm side traversing along the z-axis. The height of the harness 10 from the top face 160 of the top portion 150 to the bottom face 112 of the bottom portion 100 is approximately 8.15 mm. The dimensions above are approximate. Other dimensions may be used without departing from the spirit and scope of the present invention.

In the first embodiment, the harness 10 is comprised of a molded plastic. The advantages of using molded plastic include flexibility and lightweight. The same mold may be used to manufacture a great number of harnesses, thus reducing the cost of manufacturing. To provide shielding from electromagnetic interference (EMI), a conductive material, such as a metal plated plastic, may be used. If the housing 60 is composed of metal, a harness composed of a liquid crystal polymer (LCP) or metal plating of the harness 10 can also provide electrical grounding. Other materials may be used as well without departing from the spirit and scope of the present invention.

Although the first embodiment of the harness 10 is described above with a bottom portion 100 as a single piece which contains the cavities 114 and 116 for the ROSA 402 and TOSA 404, the bottom portion 100 may comprise multiple pieces. For example, the bottom portion 100 can be two pieces, with a first piece comprising the cavity 114 for the ROSA 402 and a second piece comprising the cavity 116 for the TOSA 404. By providing the bottom portion 100 in this manner, the ROSA 402 and TOSA 404 may be replaced or upgraded independently. Similarly, the top portion 150 of the harness 10 may also be provided as a single piece or multiple pieces. Other ways of providing the harness 10 as multiple pieces may be used without departing from the spirit and scope of the present invention.

Although the first embodiment is described with the above manner of constraining the ROSA 402 and TOSA 404, other methods of constraint may be used without departing from the spirit and scope of the present invention. For example, epoxy may be used to constrain the ROSA 402 and/or TOSA 404 within the harness 10.

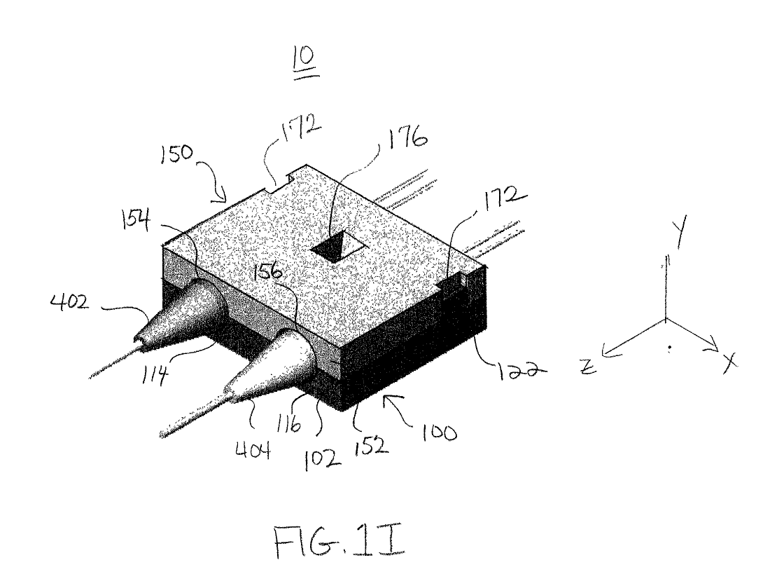

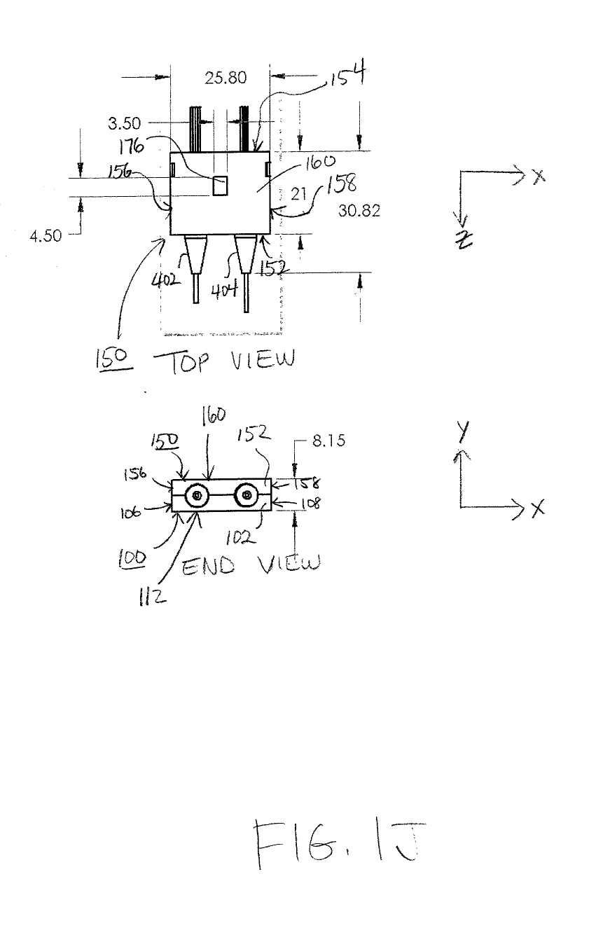

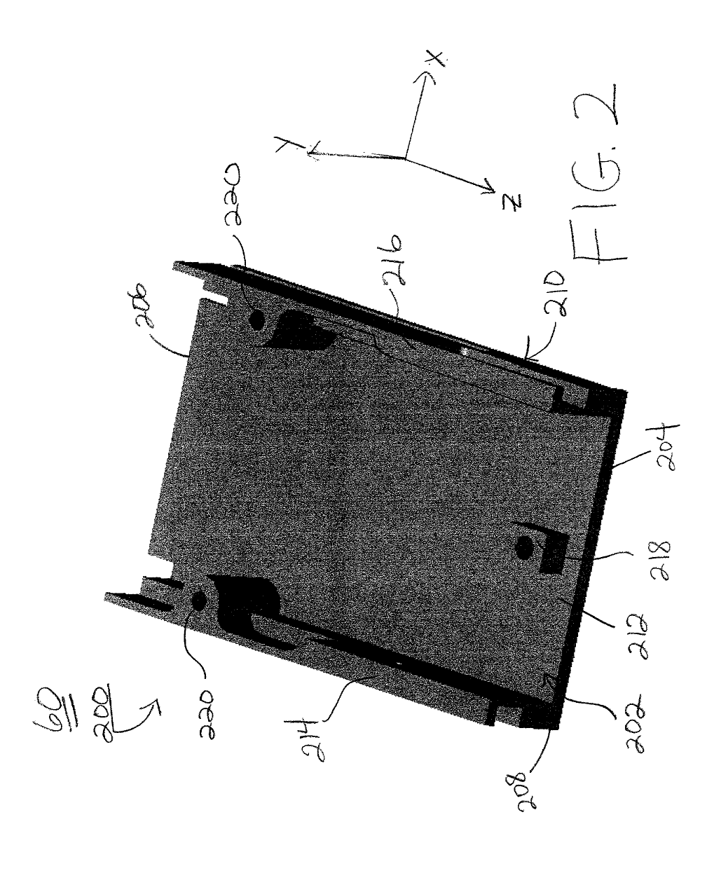

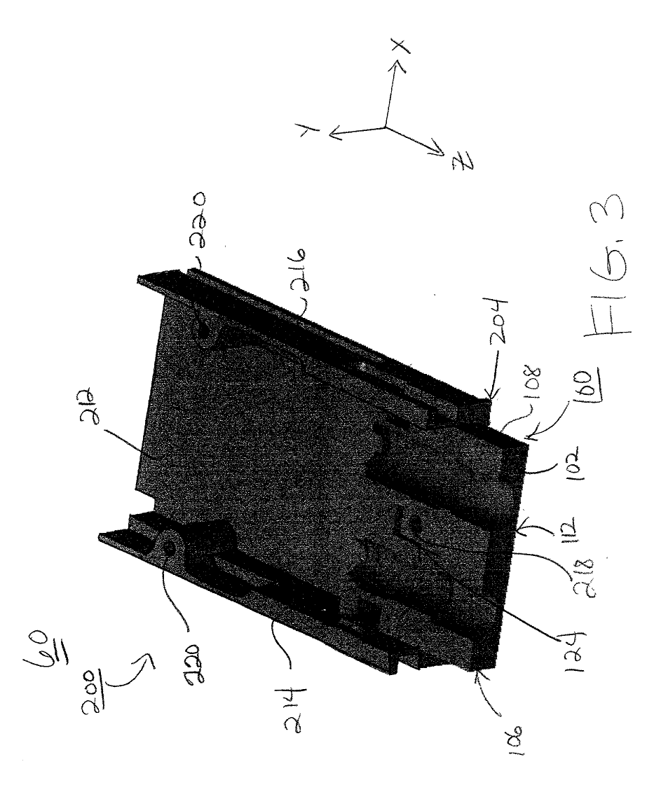

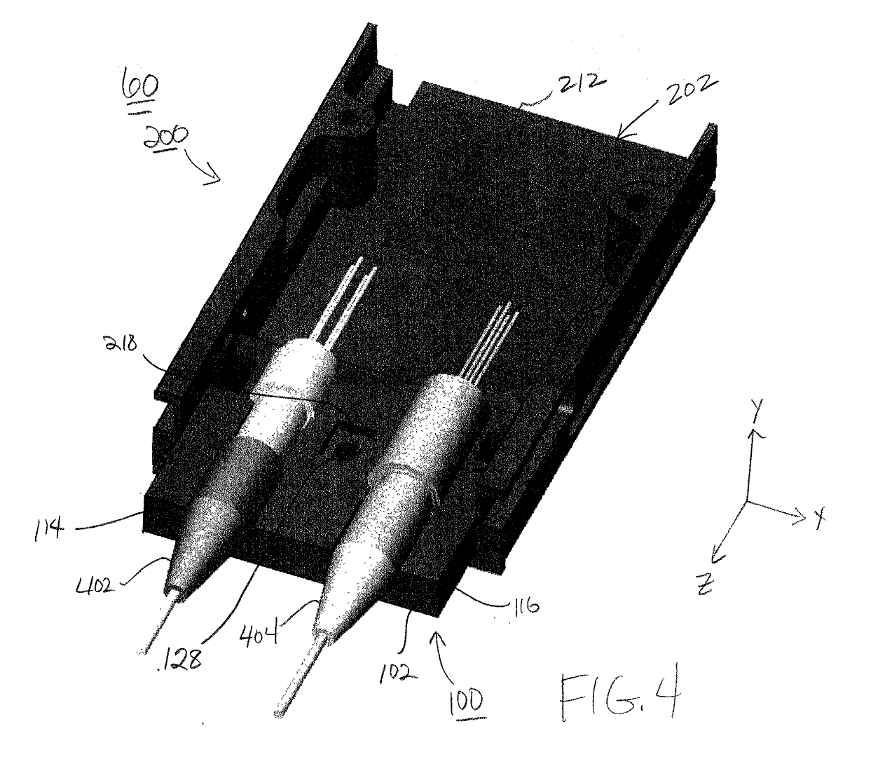

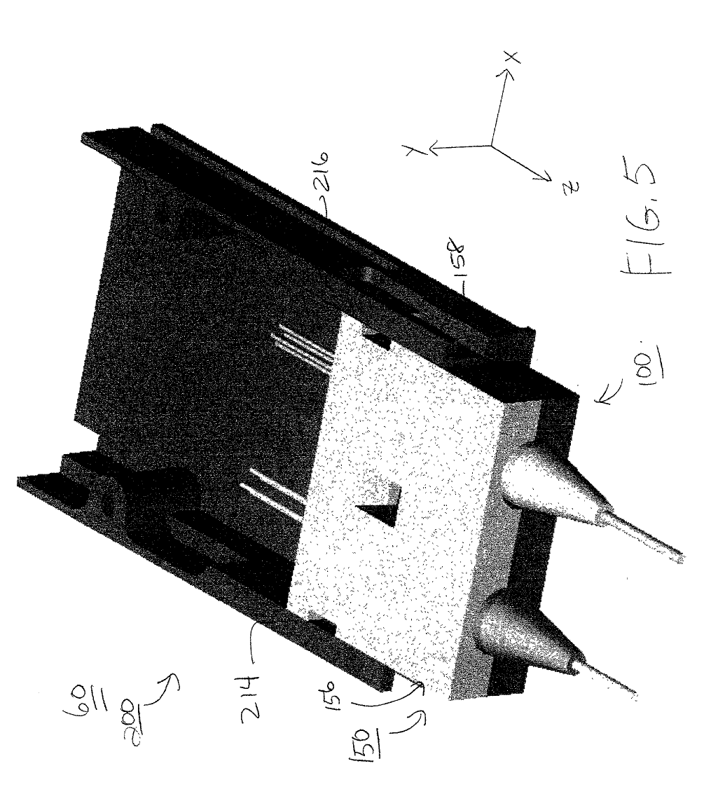

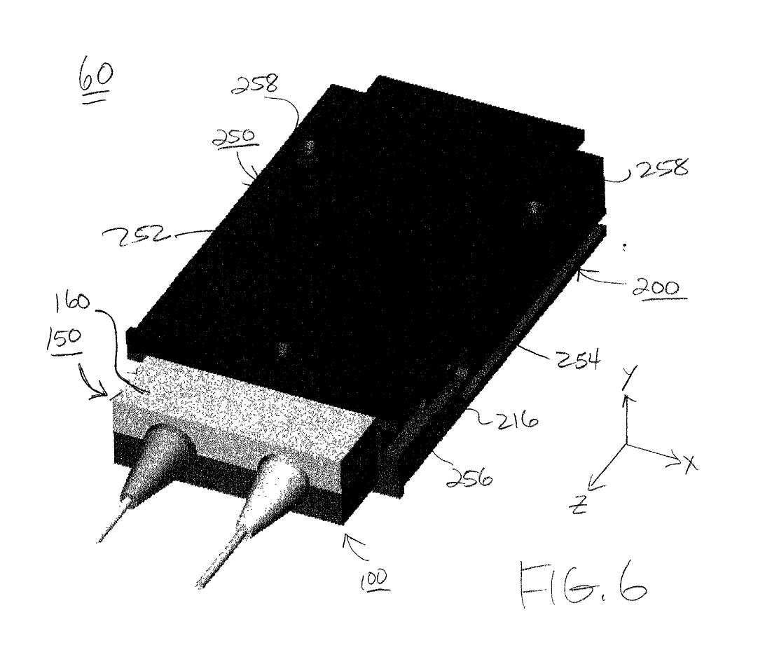

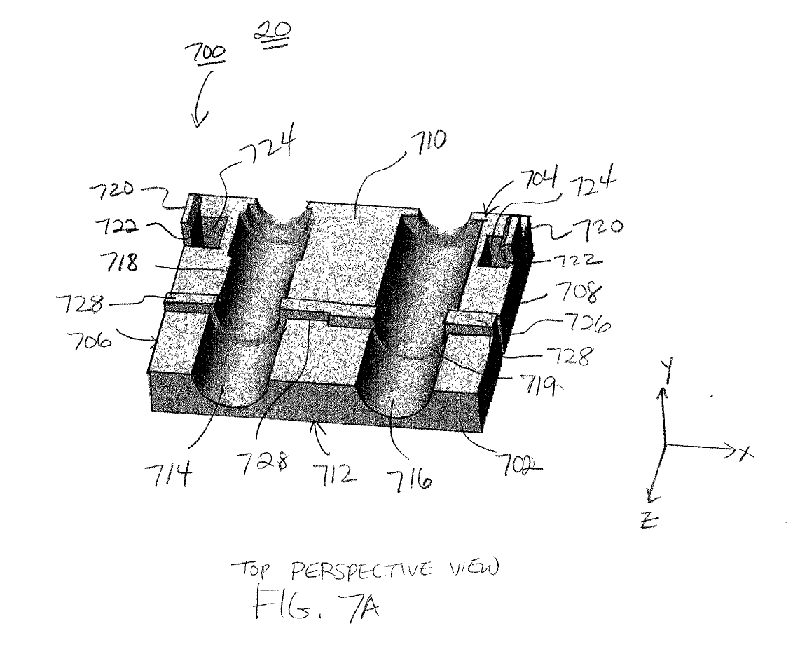

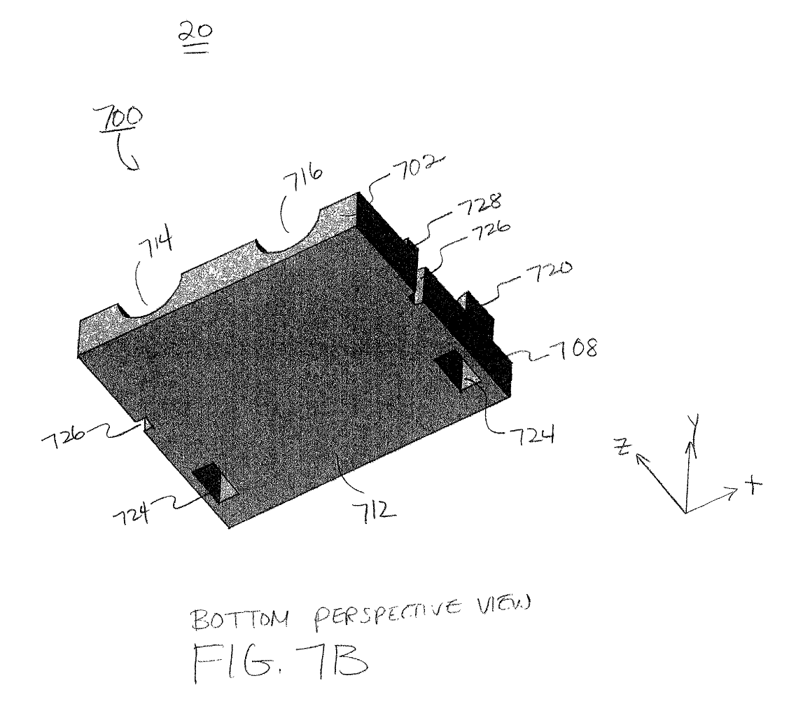

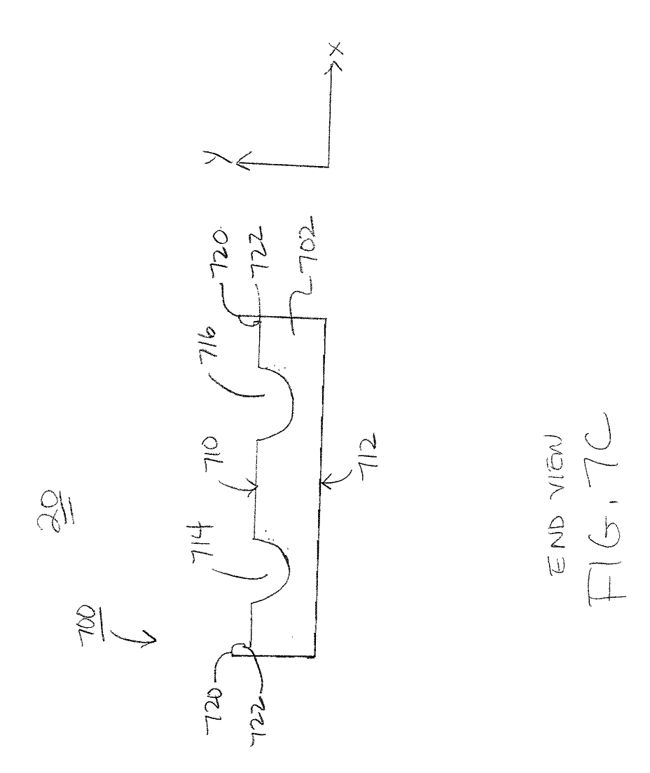

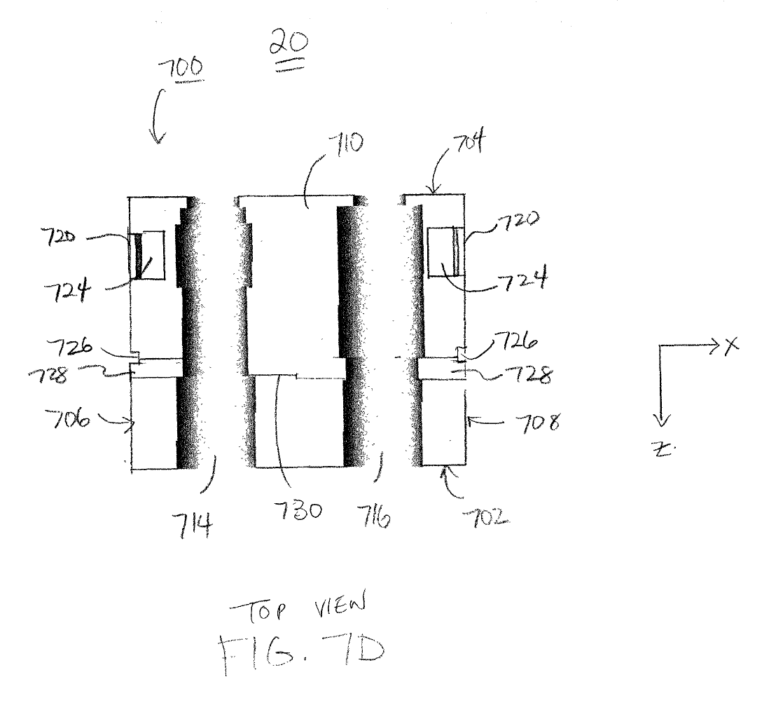

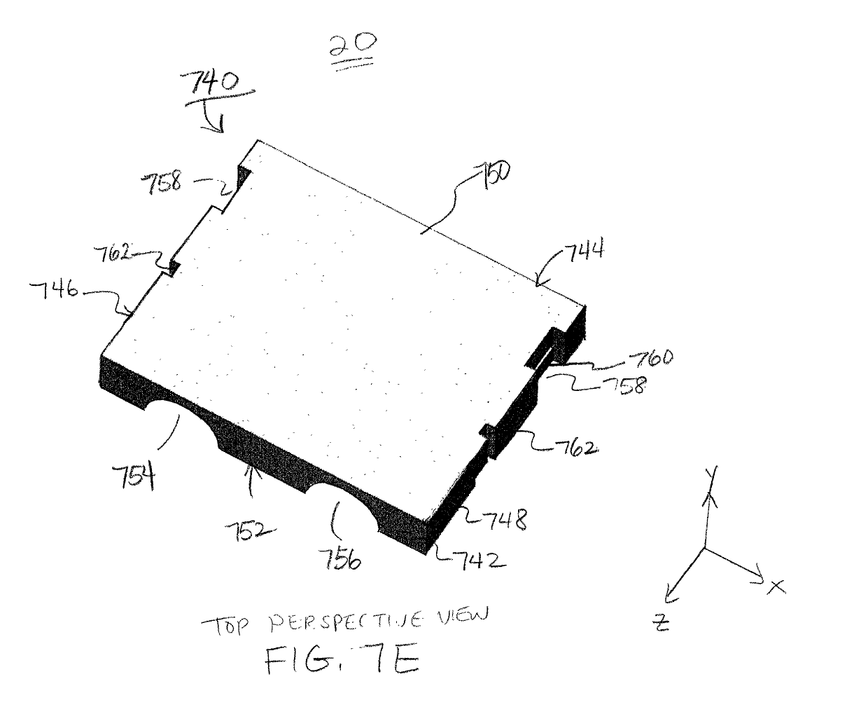

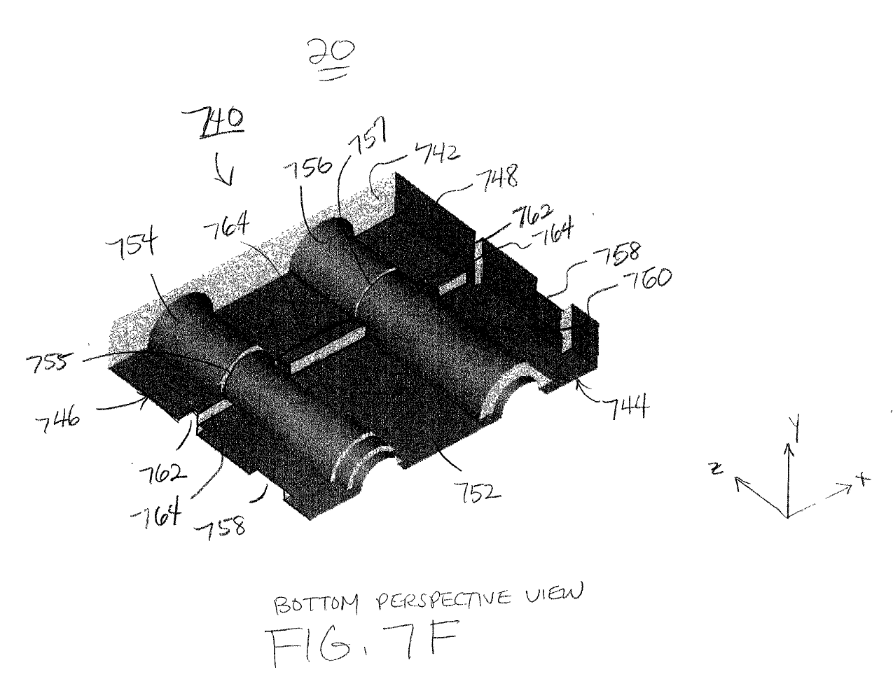

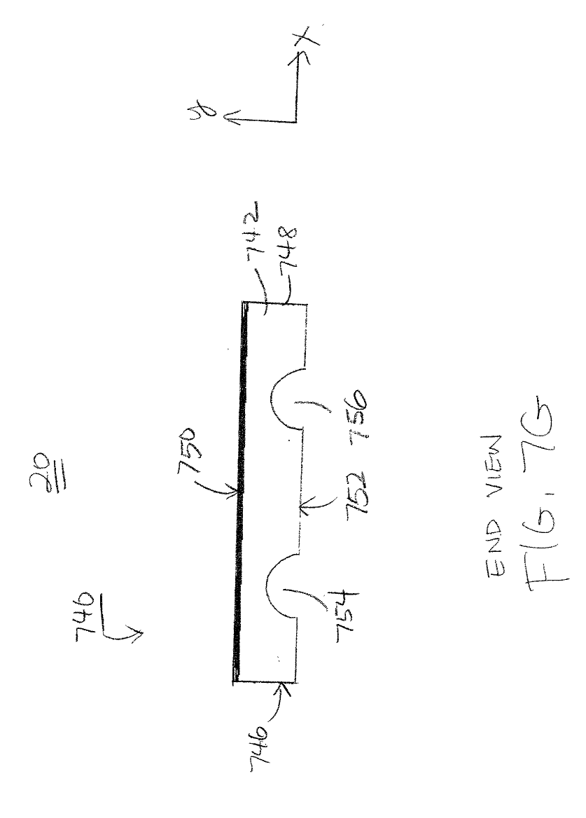

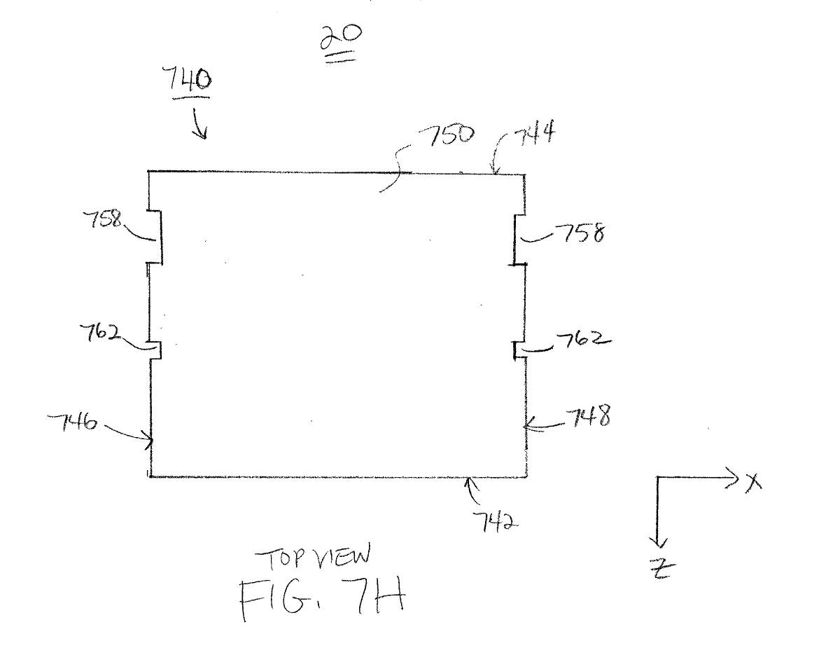

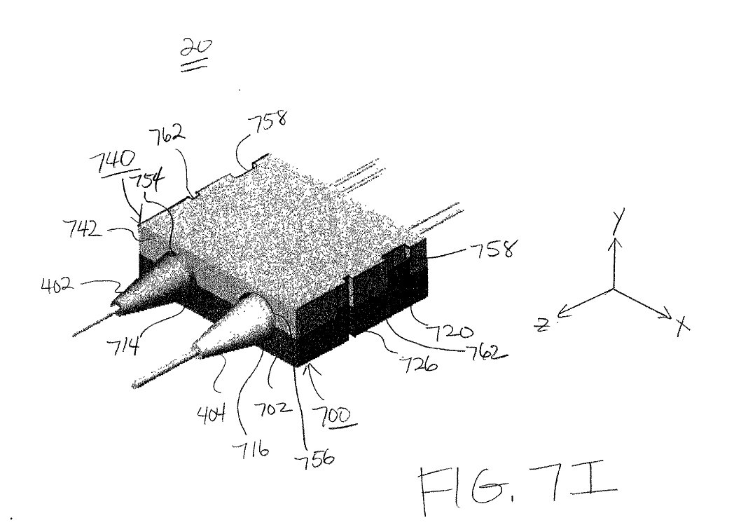

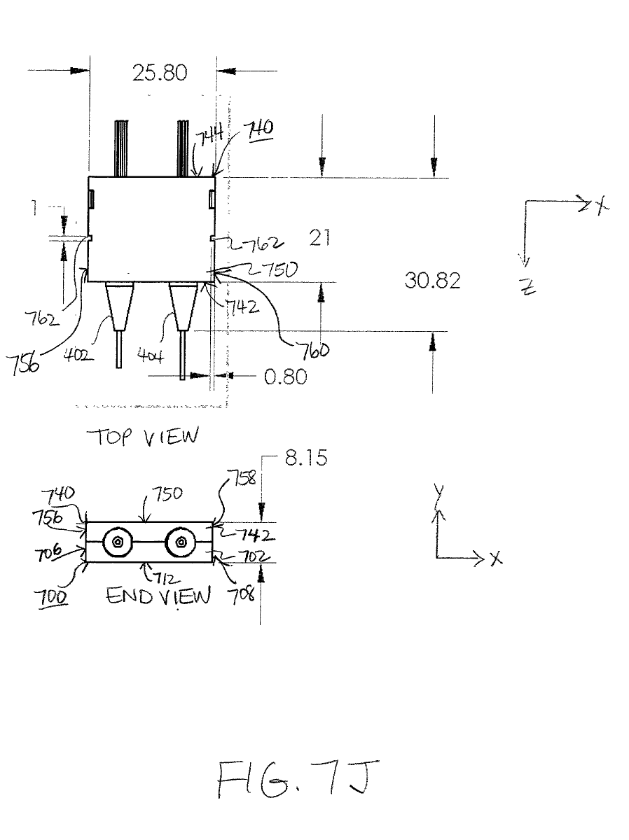

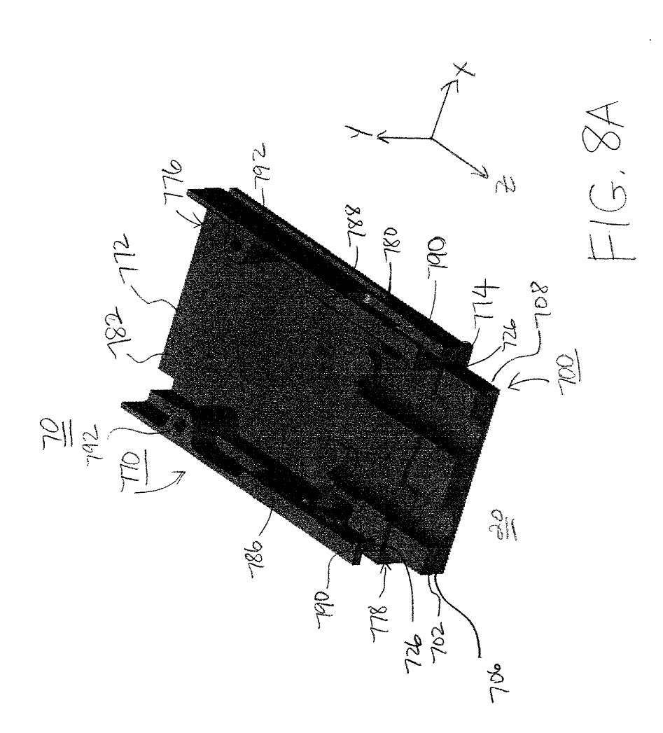

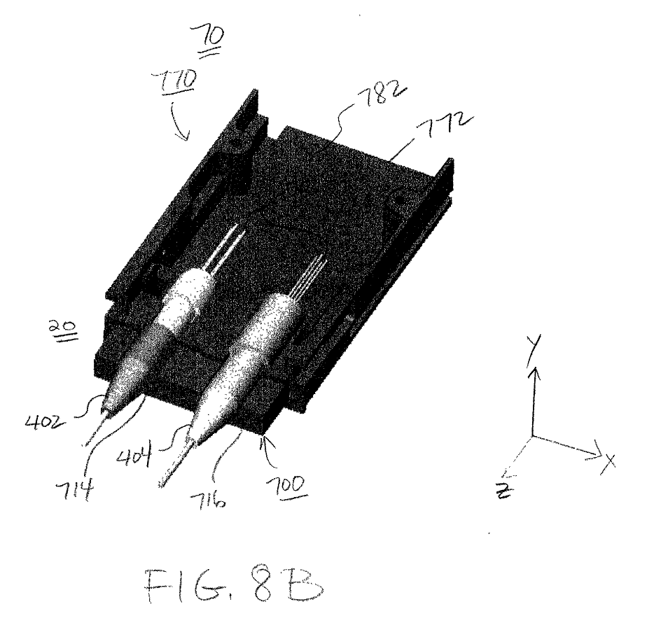

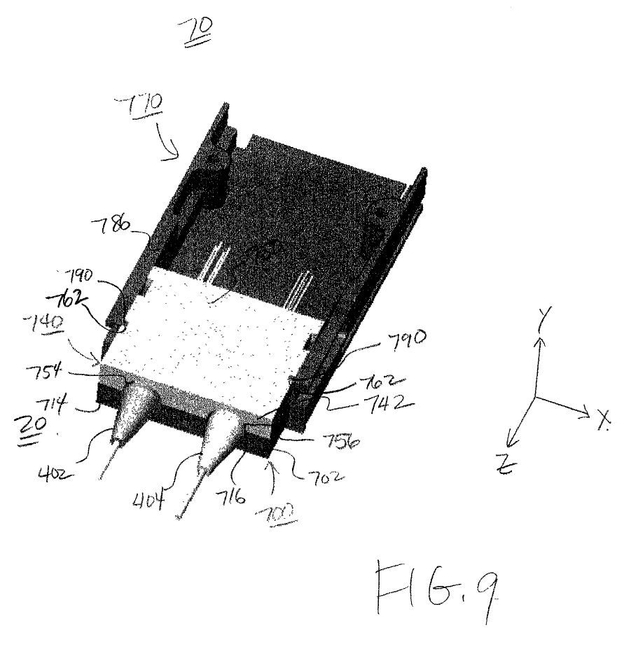

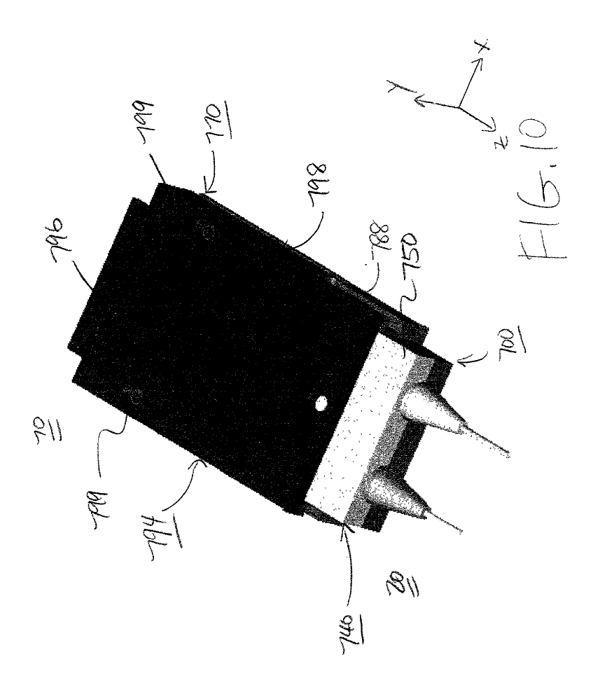

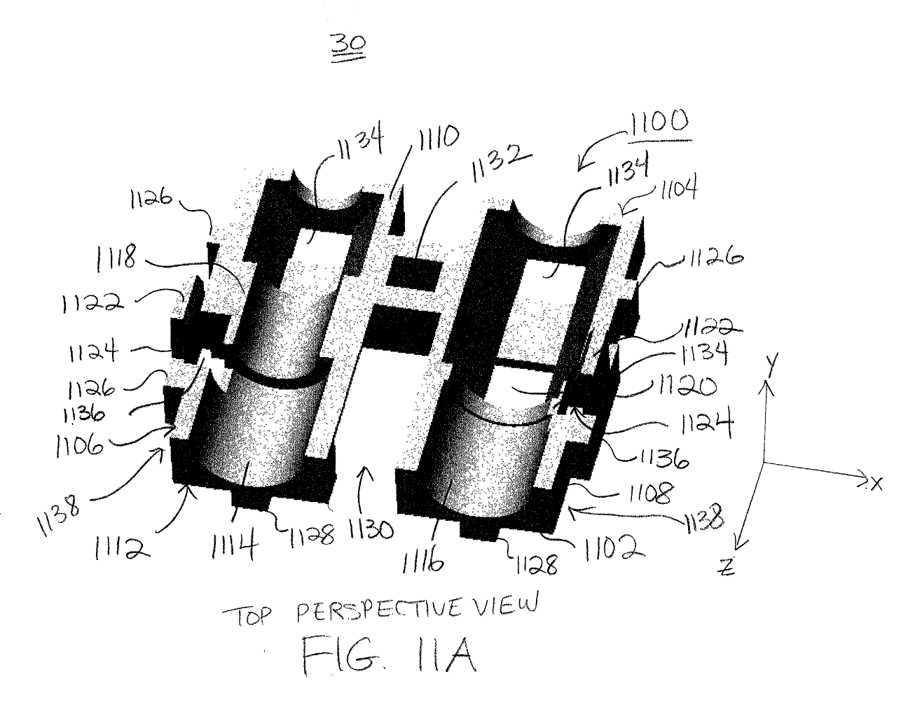

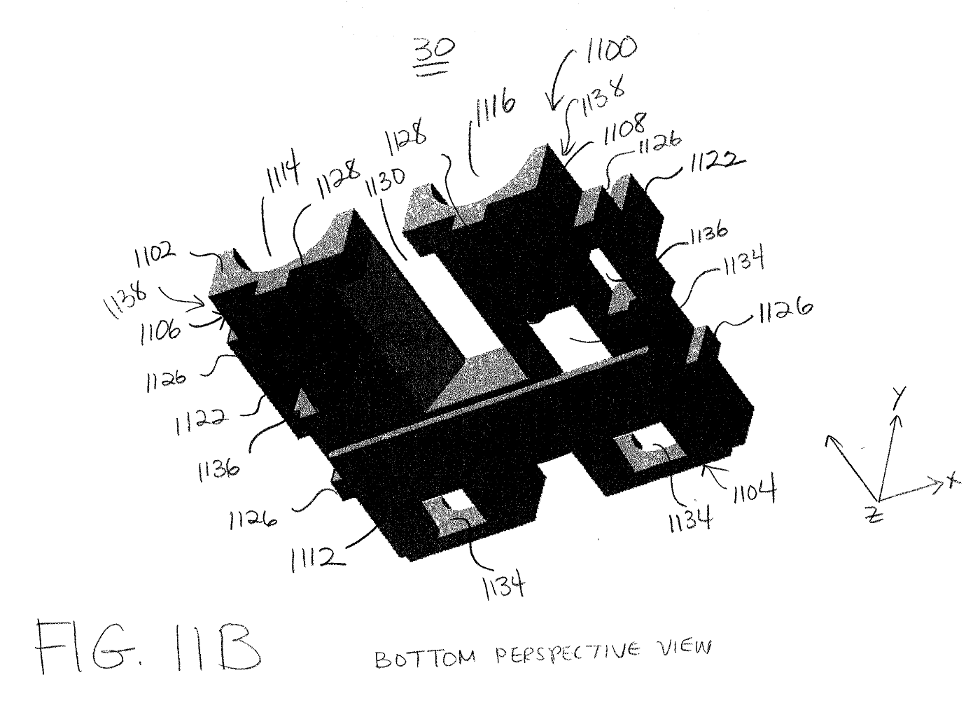

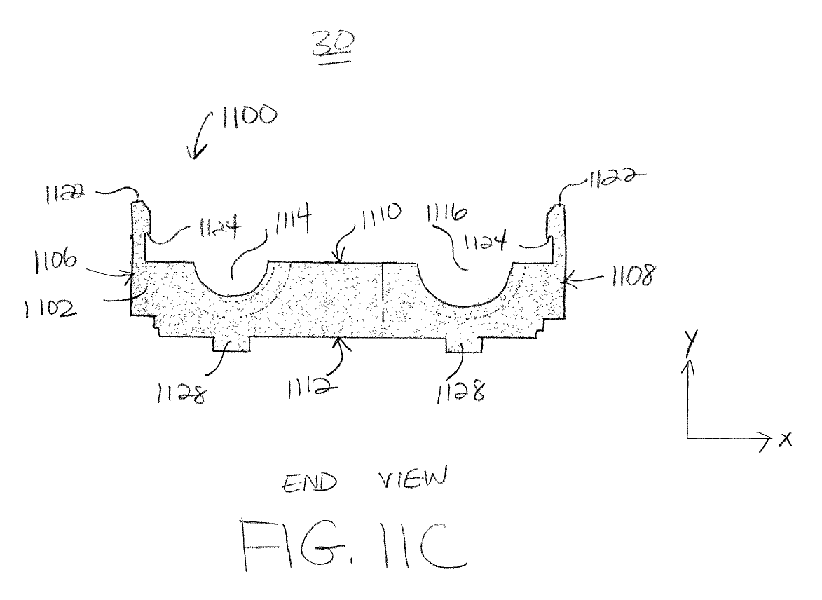

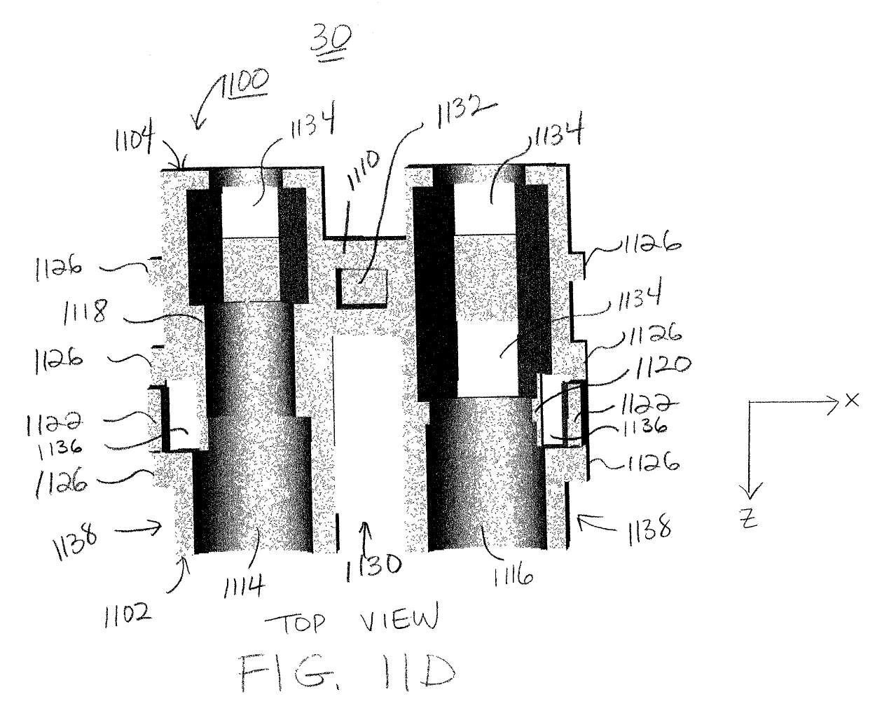

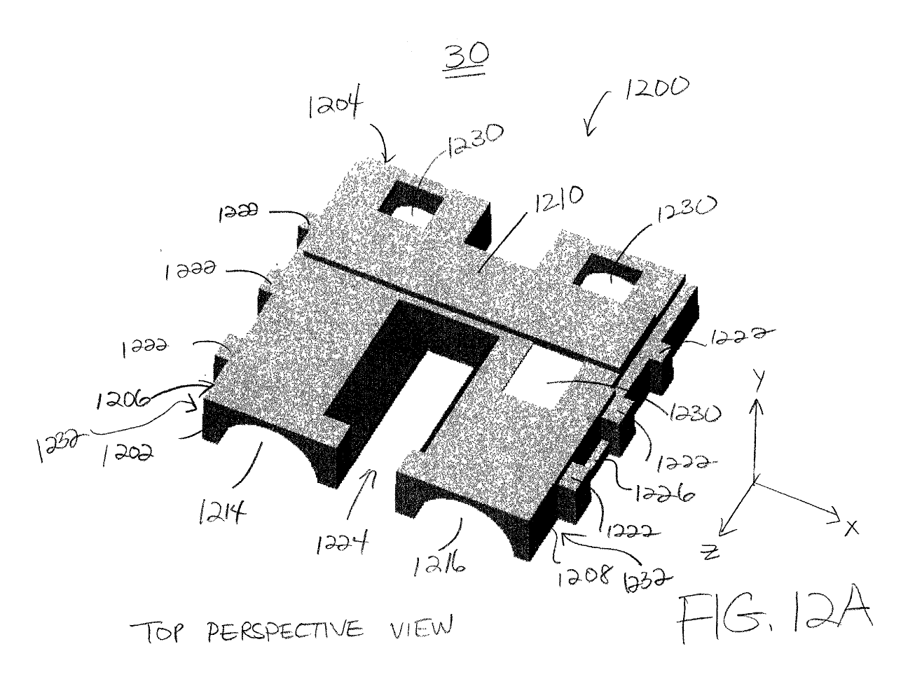

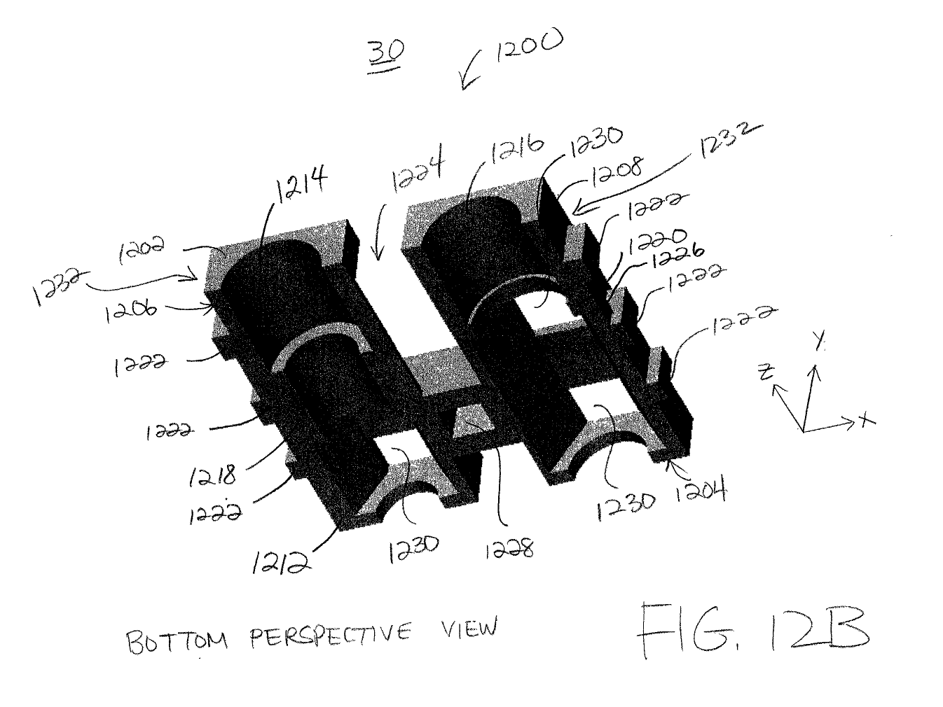

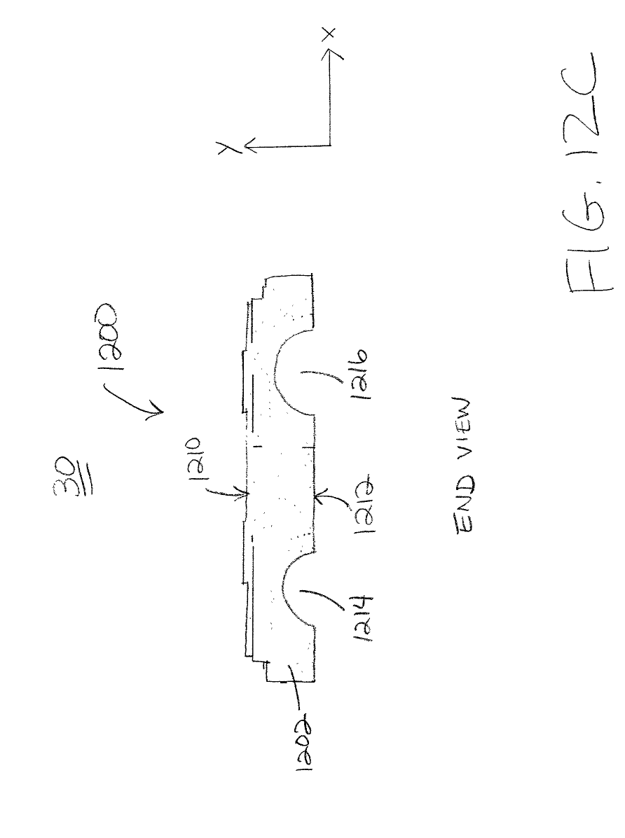

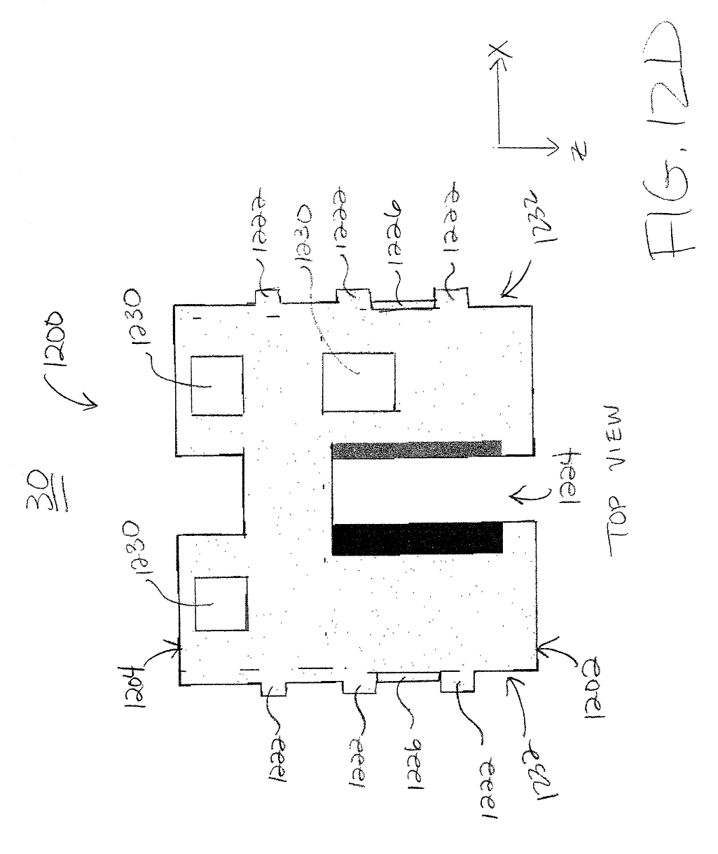

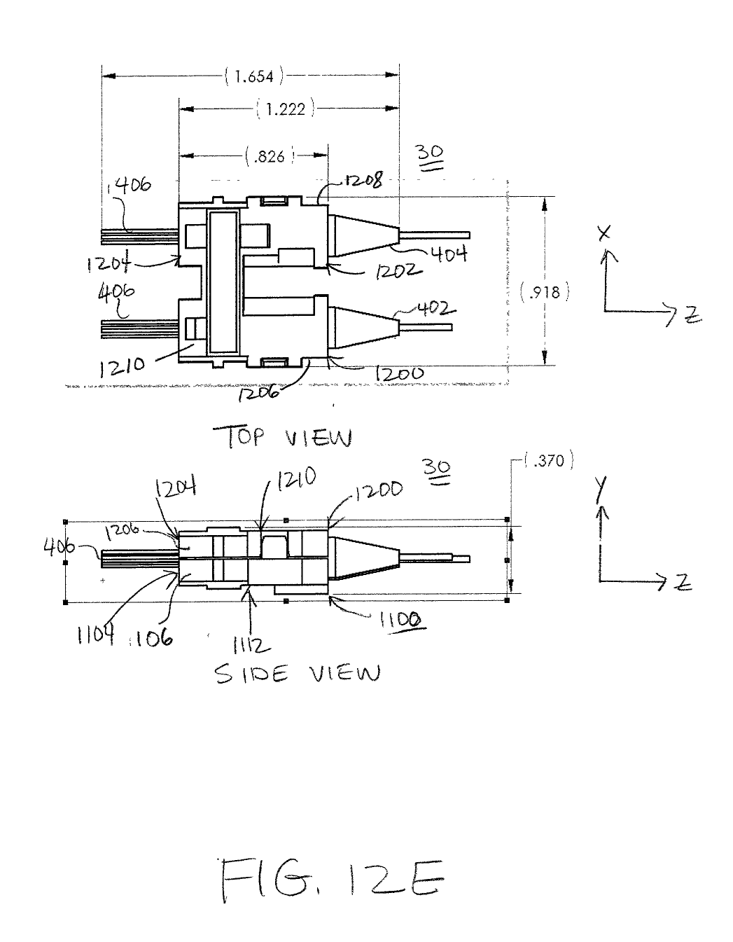

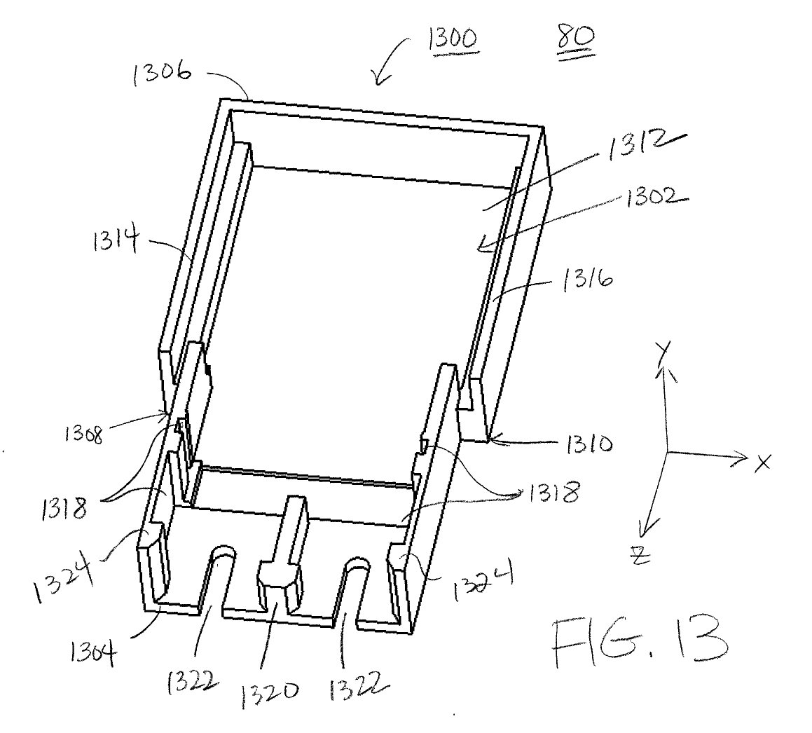

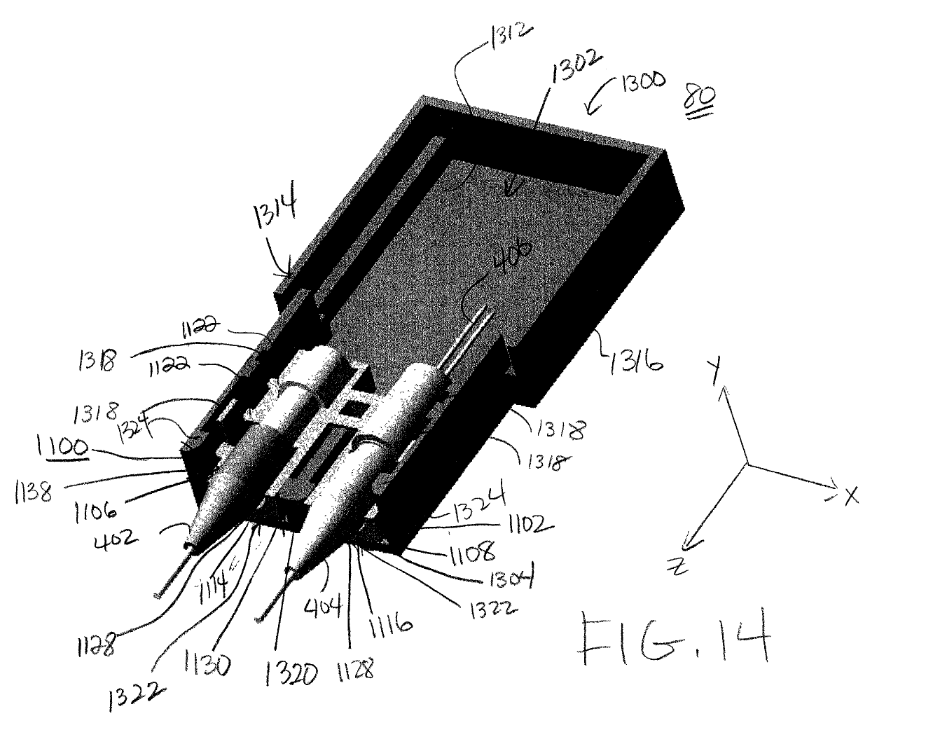

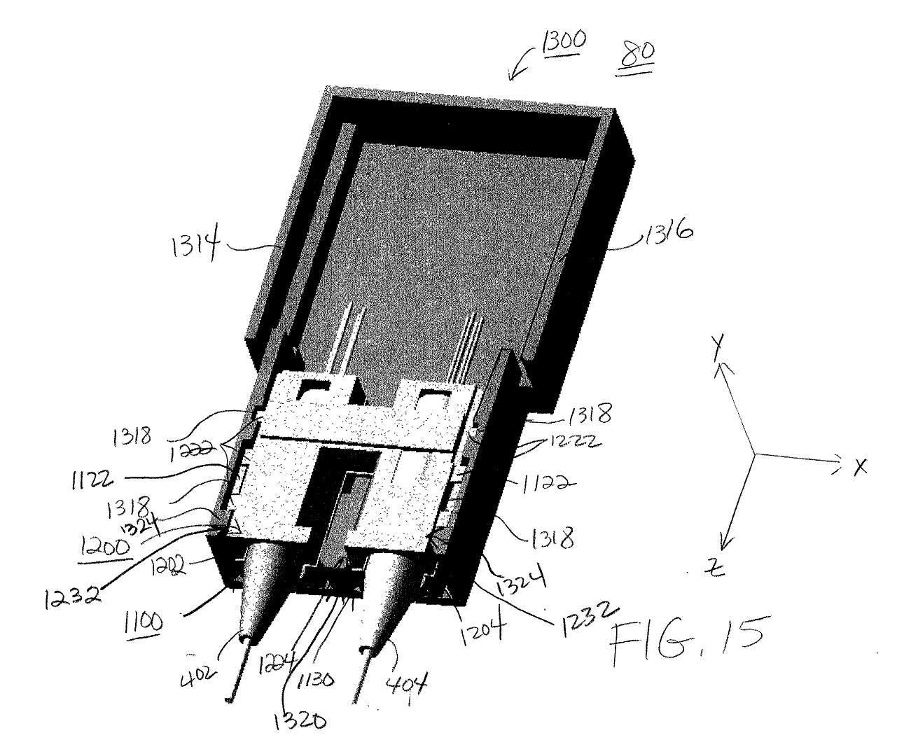

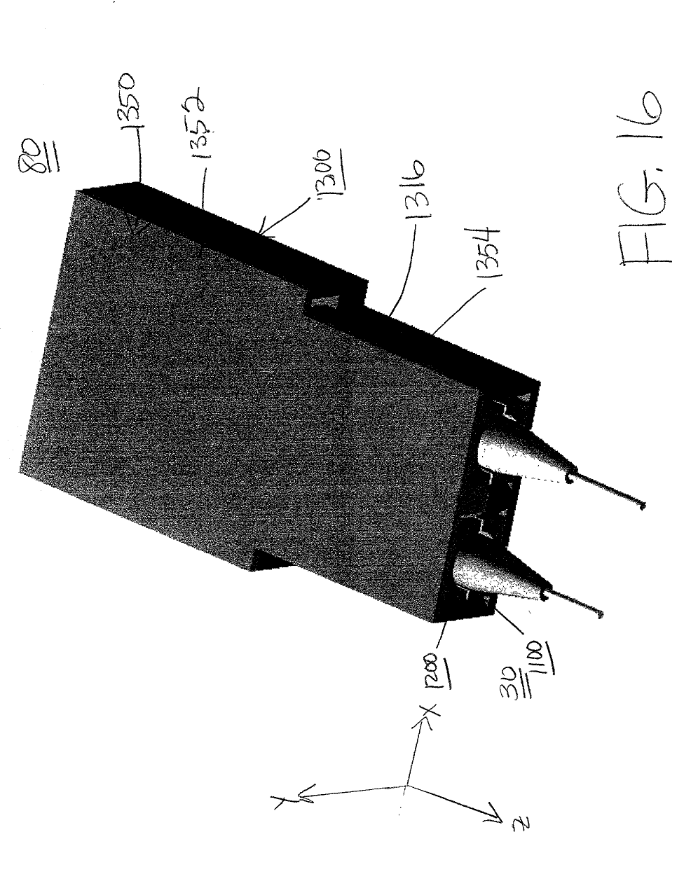

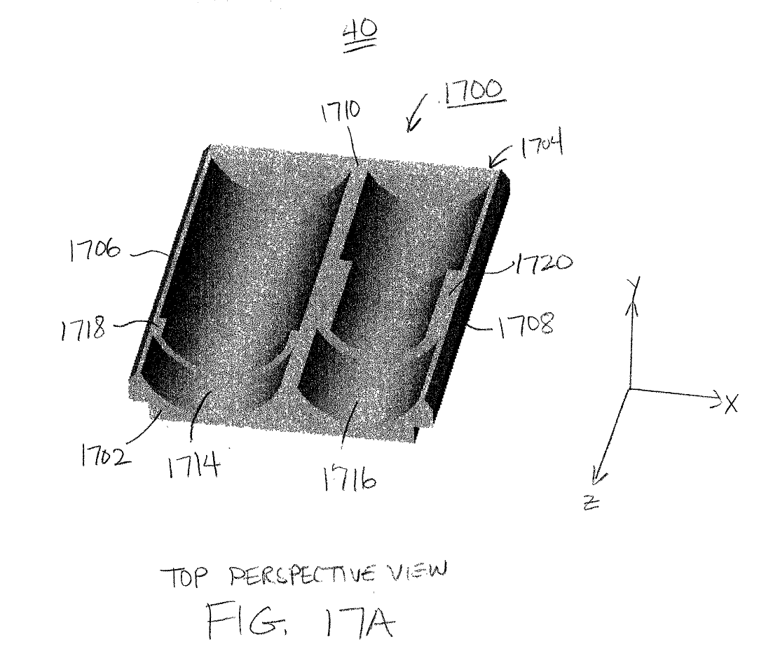

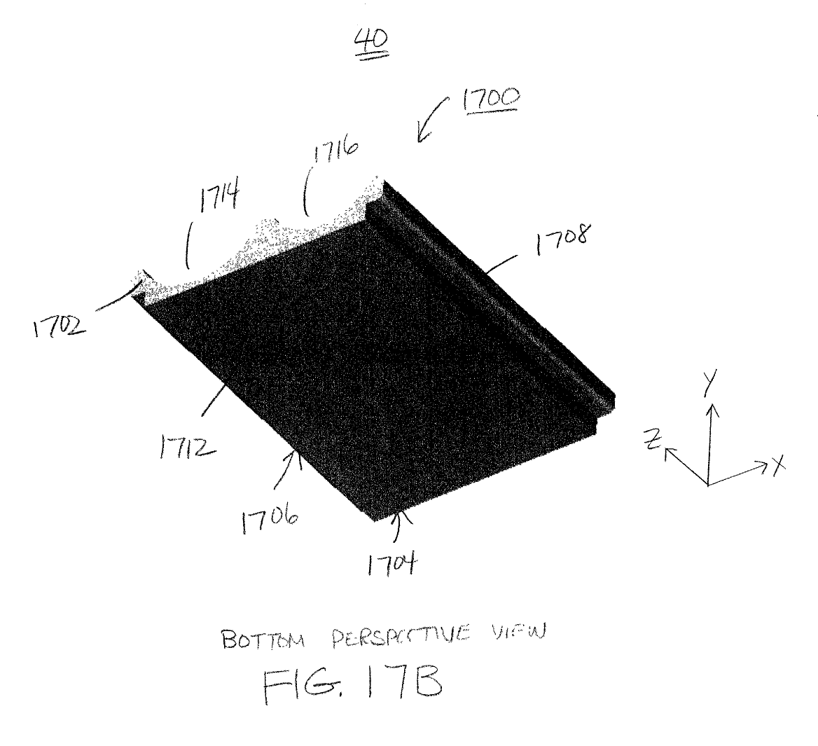

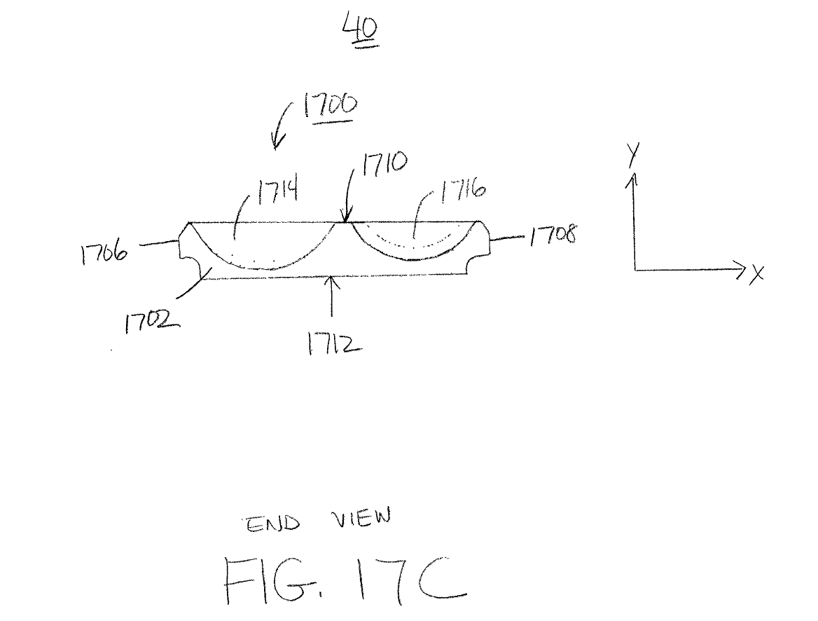

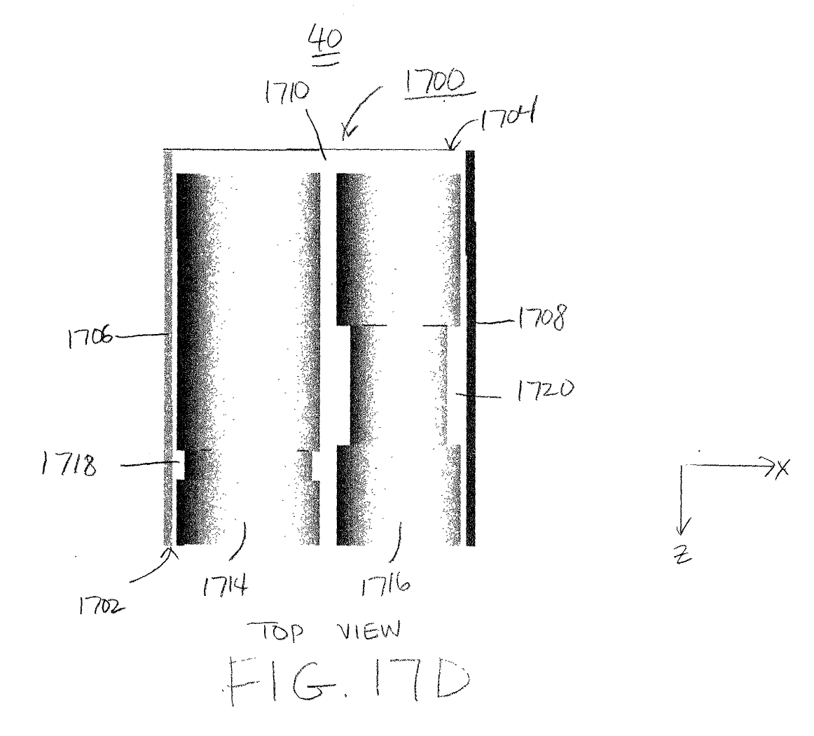

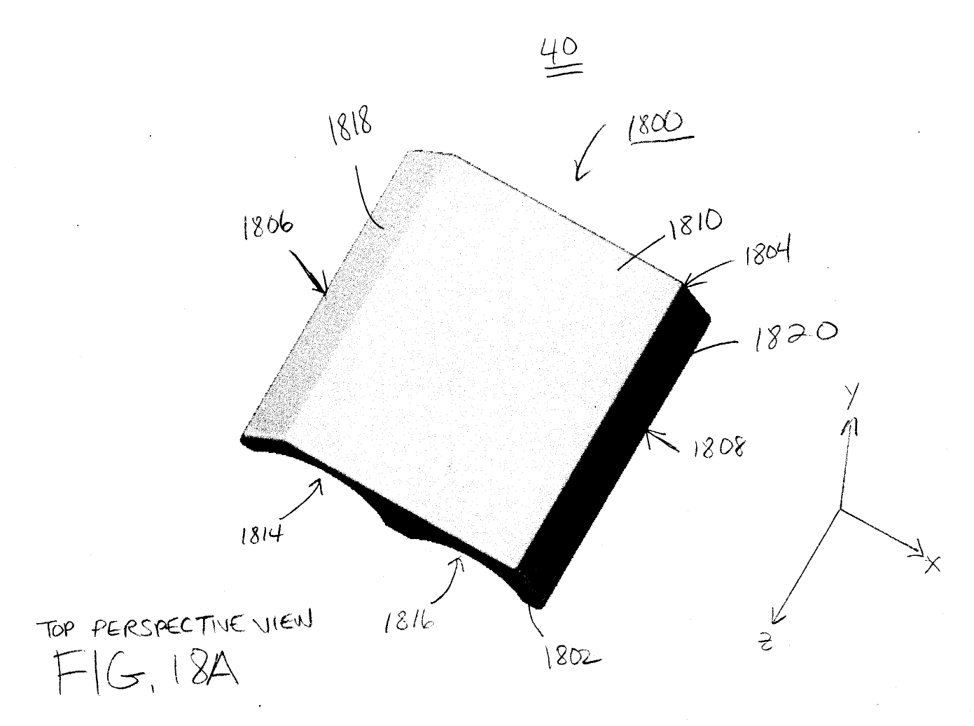

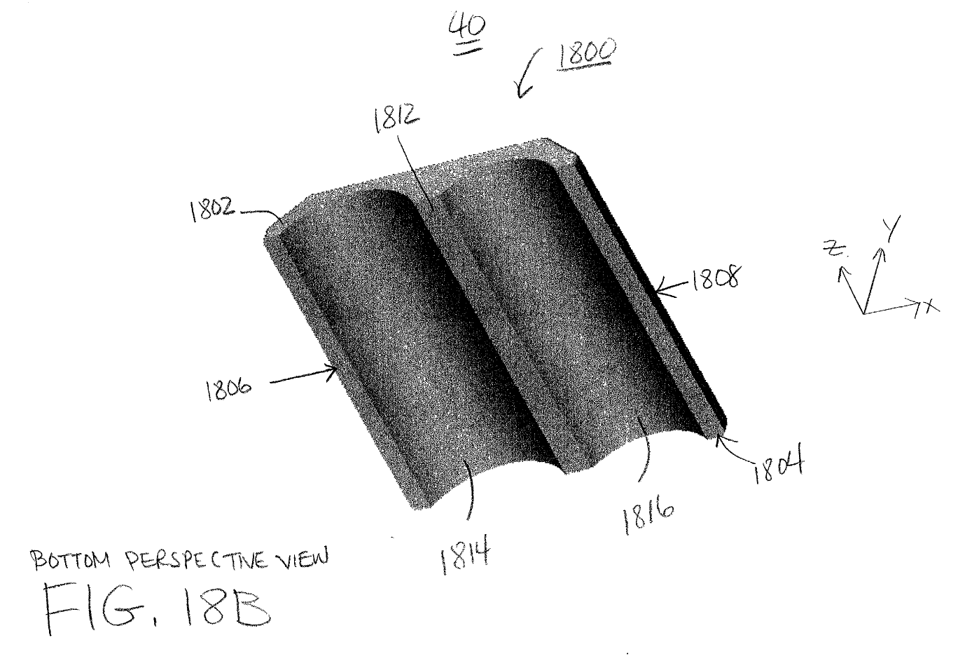

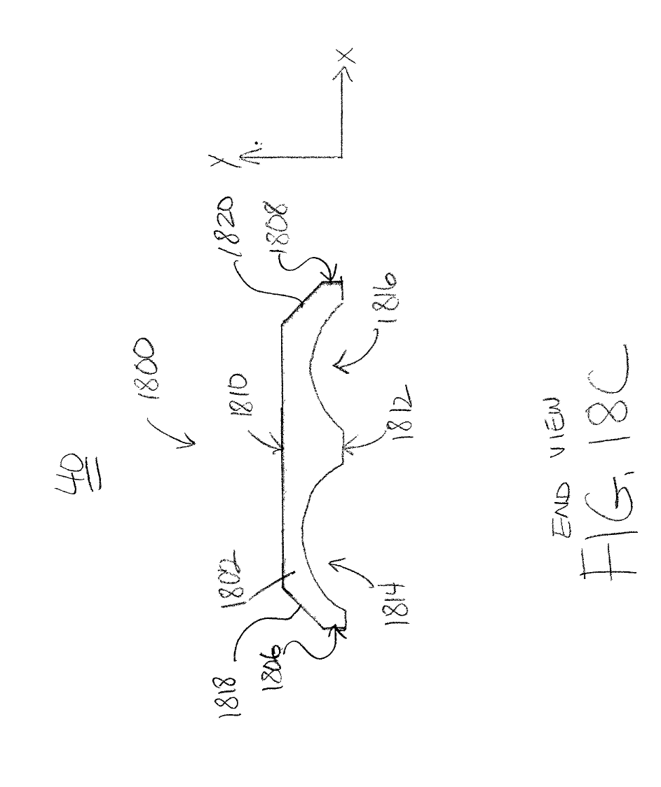

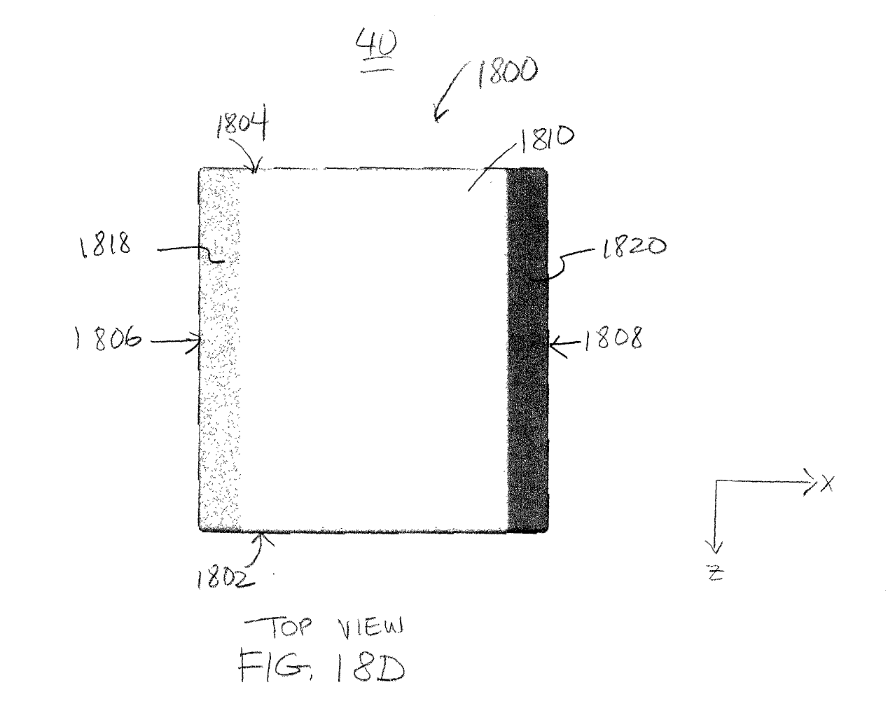

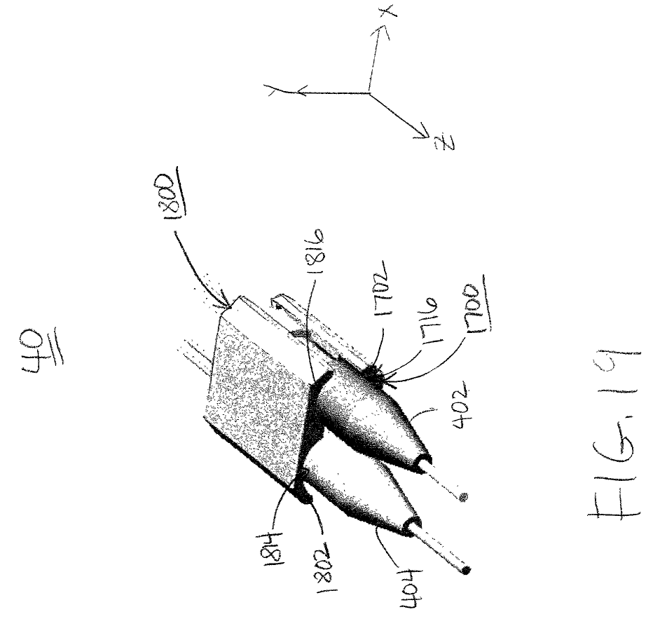

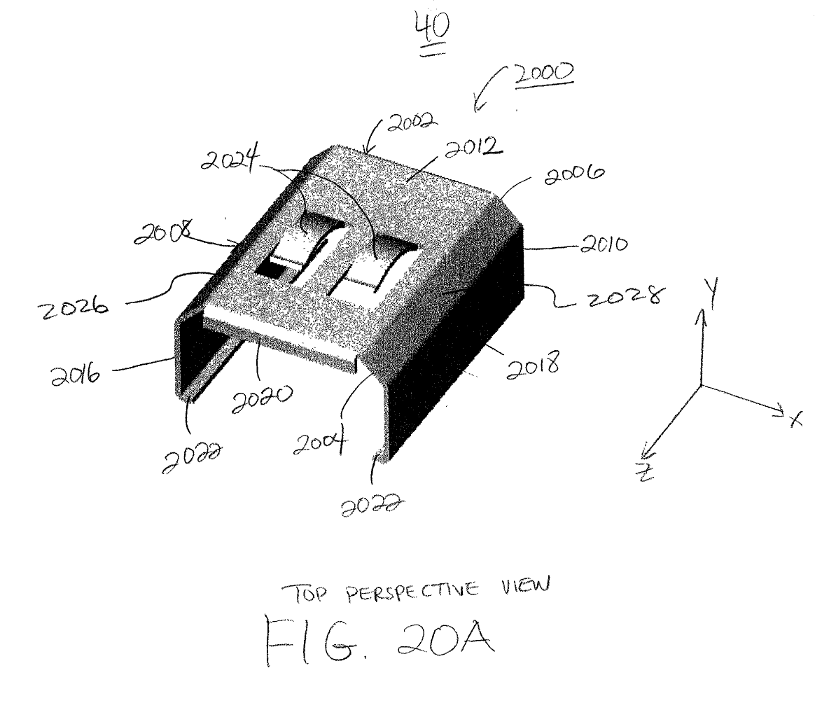

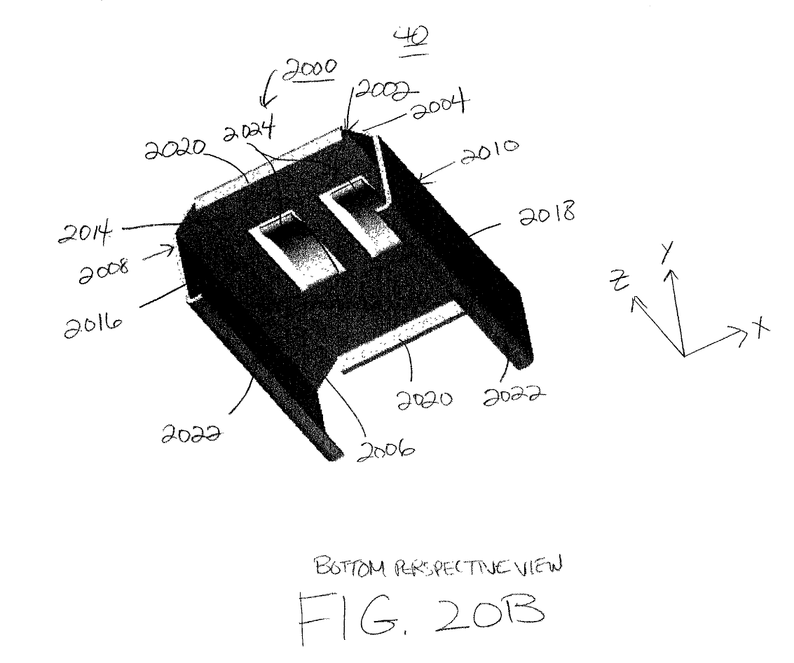

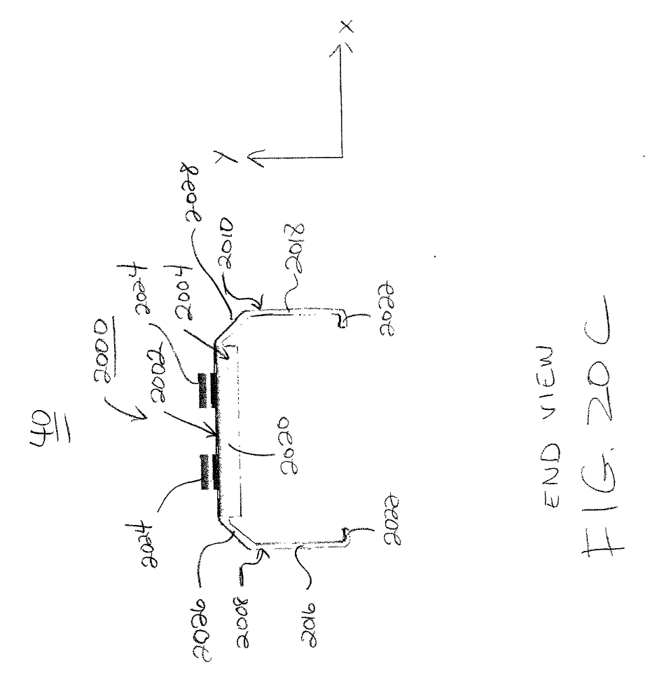

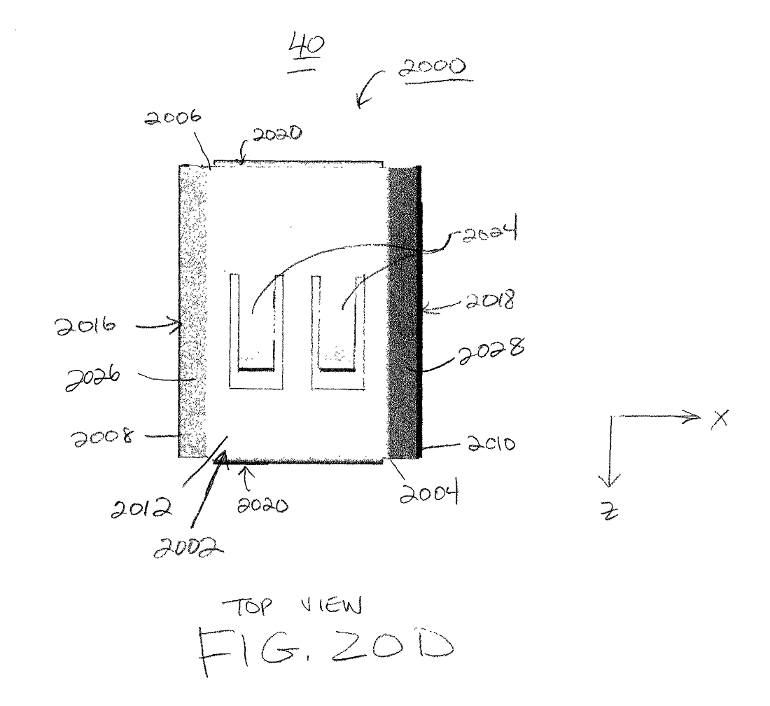

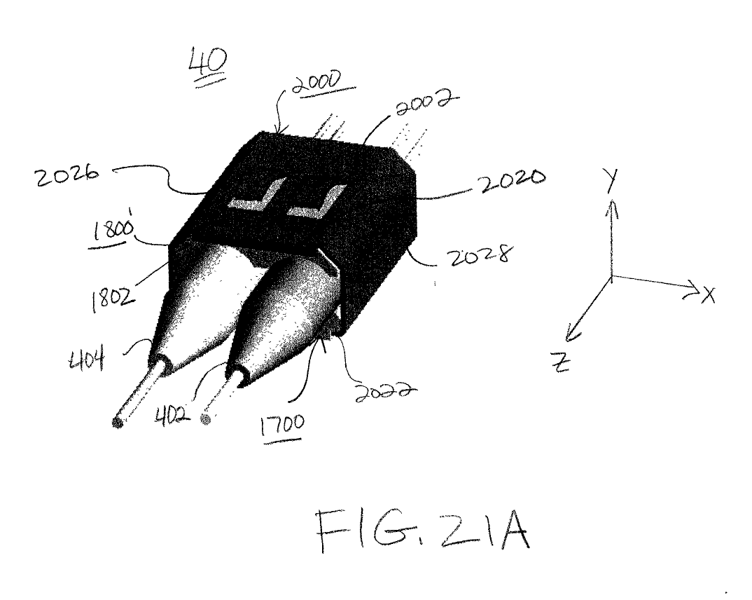

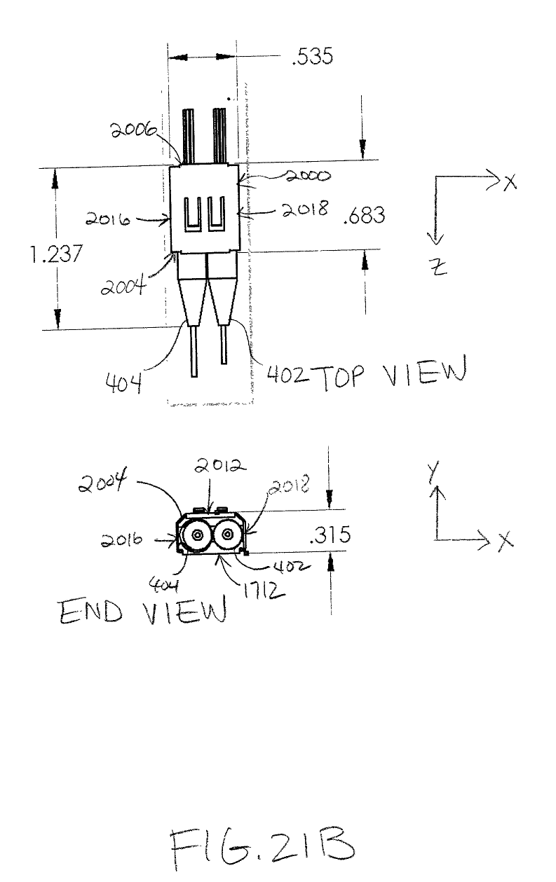

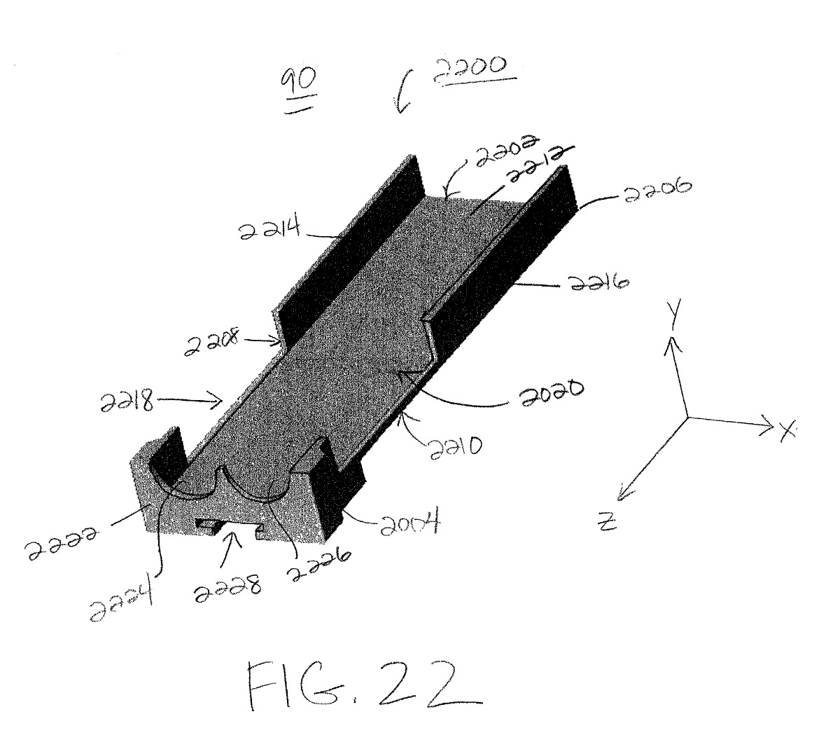

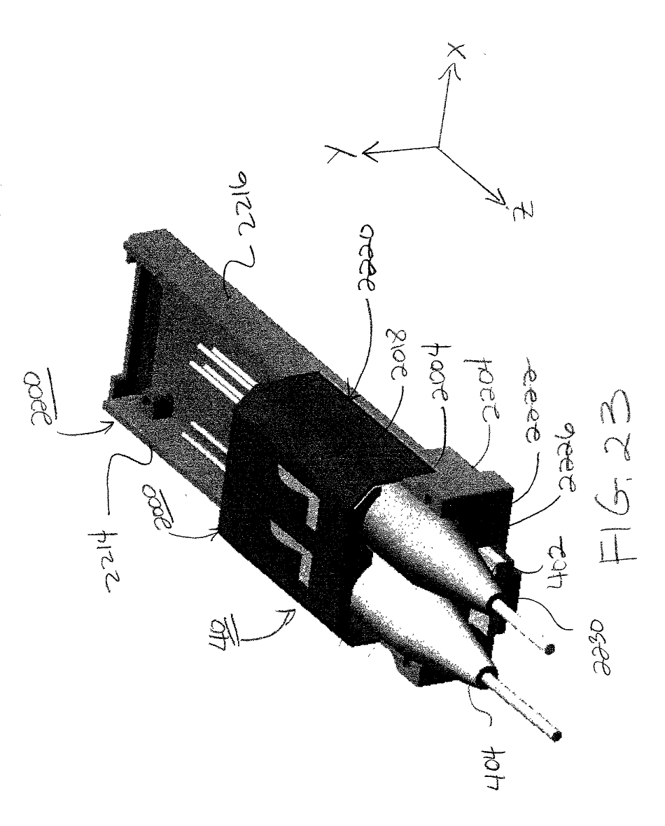

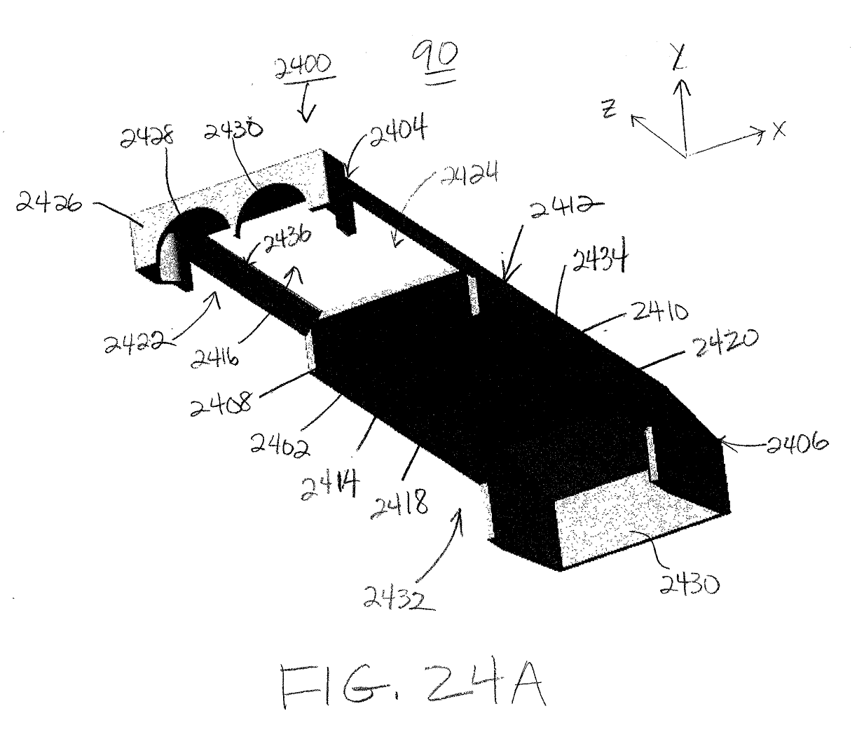

FIGS. 2 illustrates a top perspective view of the bottom portion 200 of the first embodiment of the optical assembly housing 60 which can be retrofitted by the first embodiment of the harness 10 in accordance with the present invention. The bottom portion 200 of the housing 60 comprises a bottom plate 202 with a first end 204, a second end 206, a first side 208, a second side 210, and a top face 212. Coupled to the bottom plate 202 and proximate to the first side 208 is a first side wall 214 which traverses from the first end 204 to the second end 206. Coupled to the bottom plate 202 and proximate to the second side 210 is a second side wall 216 which traverses from the first end 204 to the second end 206. The first 214 and second 216 side walls extend outward from the top face 212. Proximate to the first end 204 and coupled to the top face 212, the bottom plate 202 comprises a post 218 which extends outward from the top face 212. The function of the post 218 will be described below in conjunction with FIG. 3.

FIG. 3 illustrates a top perspective view of a combination of the bottom portion 100 of the first embodiment of the harness 10 and the bottom portion 200 of the first embodiment of the optical assembly housing 60 in accordance with the present invention. The bottom portion 100 of the harness 10 resides within the bottom portion 200 of the housing 60 as illustrated. The first side face 106 of the bottom portion 100 of the harness 10 abuts against the first side wall 214 of the bottom portion 200 of the housing 60. The second side face 108 of the bottom portion 100 of the harness 10 abuts against the second side wall 216 of the bottom portion 200 of the housing 60. The post 218 of the bottom plate 202 resides within the opening 124 of the bottom portion 100 of the harness 10. The first end face 102 of the harness 10 is facing outward from the first end 204 of the housing 60. The bottom face 112 (hidden) of the bottom portion 100 of the harness 10 abuts the top face 212 of the bottom plate 202. The bottom portion 100 of the harness 10 may reside within the bottom portion 200 of the housing 60, or it may reside partially within the bottom portion 200, as is illustrated in FIG. 3.

FIG. 4 illustrates a top perspective view of a combination of the bottom portion 100 of the first embodiment of the harness 10, the bottom portion 200 of the first embodiment of the housing 60, a ROSA, and a TOSA in accordance with the present invention. As illustrated in FIG. 4, a ROSA 402 and a TOSA 404 may be placed within the cavities 114 and 116 of the bottom portion 100 of the harness 10, respectively. The features of the cavities 114 and 116 are a mirror of the features of the bodies of the ROSA 402 and TOSA 404, respectively. The post 218 resides within the opening 128 of the bottom portion 100 of the harness. In the first embodiment, a circuit board (not shown) would reside on the remaining portion of the top face 212 of the bottom plate 202. Connectors 406, such as pins, from the ROSA 402 and the TOSA 404 can be coupled to the circuit board, either by solder or some other coupling means.

FIG. 5 illustrates a top perspective view of a combination of the top portion 150 and the bottom portion 100 of the first embodiment of the harness 10, the bottom portion 200 of the first embodiment of the housing 60, the ROSA 402, and the TOSA 404, in accordance with the present invention. As illustrated in FIG. 5, the top portion 150 of the harness 10 is placed over the bottom portion 100 of the harness 10, the ROSA 402, and the TOSA 404, as described above with FIG. 11. Preferably, the first 156 and second 158 side faces of the top portion 150 of the harness 10 abuts against the first 214 and second 216 side walls of the bottom portion 200 of the housing 60, respectively, however, they need not. The pressure in the y-direction from the coupling of the top 150 and bottom 100 portions of the harness 10 may be used to close any gaps between the harness 10 and the first 214 and second 216 side walls. This provides improved EMI shielding.

FIG. 6 illustrates a top perspective view of the first embodiment of the optical assembly housing 60 retrofitted with the first embodiment of the harness 10 in accordance with the present invention. The housing 60 comprises a top plate 250 with a top face 252 and a bottom face 254 (hidden). The top plate 250 is placed such that the bottom face 254 (hidden) abuts the first side wall 214 (hidden) and the second side wall 216 of the bottom portion 200 of the housing 60, and abuts the top face 160 of the top portion 150 of the harness 10. Preferably, the top plate 250 extends so that it abuts the entire length of the side walls 214 and 216. The top plate 250 also comprises a post 256 (hidden) which may reside within the opening 176 (hidden) in the top portion 150 and the opening 128 (hidden) in the bottom portion 100 of the harness 10 when the top plate 250 is placed in the above manner. Alternatively, the top plate 250 may comprise an opening at the same location as the post 256, with the post 218 (hidden) of the bottom portion 200 extending through both of the openings 128 and 176 of the harness 10. Alternatively, the bottom portion 200 may comprise an opening at the same location as the post 218 (hidden), with the post 256 on the top portion 250 extending through both of the openings 128 and 176 (hidden) of the harness 10.

In the first embodiment, the bottom portion 200 of the housing 60 comprises holes 220 (see FIG. 2) at the first side wall 214 and the second side wall 216. The top plate 250 comprises holes 258 (see FIG. 6) whose locations approximately match the locations of the holes 220 in the side walls 214 and 216. Screws, or some other attachment mechanism, may then be inserted through the holes 258 and attached to the bottom portion 200 at the holes 220. In this manner, the top plate 250 is attached to the bottom portion 200 of the housing 60. When the screw is attached, pressure in the y-direction is applied to the top portion 150 toward the bottom portion 100 of the harness 10.

The harness 10 residing within the bottom portion 200 of the housing 60 constrains the harness 10 from translation along the x- and z-axes and from rotating about the x-, y-, and z-axes. The pressure applied by the fastening of the top portion 250 of the housing 60 to the side walls 208 and 210 constrains the harness 10 from translating along the y-axis. The harness 10 is thus constrained in the possible six degrees of freedom while within the housing 60.

Although the first embodiment is described with the above manner of constraining the harness 10, other methods of constraint may be used without departing from the spirit and scope of the present invention. For example, epoxy may be used to constrain the harness 10 within the housing 60.

FIGS. 7A through 10 illustrate a second embodiment of a harness for retrofitting an optical assembly housing in accordance with the present invention.

The second embodiment of the harness 20 comprises a bottom portion 700 and a top portion 740. The second embodiment of the harness 20 can be used to retrofit a second embodiment of an optical assembly housing 70.

FIGS. 7A-7D illustrate a top perspective view, bottom perspective view, end view, and top view, respectively, of the bottom portion 700 of the second preferred embodiment of the harness 20 in accordance with the present invention. The bottom portion 700 of the harness 20 comprises a block of material with a first end face 702, a second end face 704, a first side face 706, a second side face 708, a top face 710, and a bottom face 712. Within the bottom portion 700 are a first cavity 714 for a first optical subassembly, such as a ROSA, and a second cavity 716 for a second optical subassembly, such as a TOSA. The features of the cavities 714 and 716 can mirror the features of the bodies of the particular ROSA and TOSA to be used. For example, ridges 718 in the first cavity 714 and ridges 719 in the second cavity 716 may mirror the ridges of the bodies of the ROSA and TOSA.

The bottom portion 700 comprises snaps 720 coupled to the first 706 and second 708 side faces. The snaps 720 each comprise lips 722. The snaps 720 and lips 722 perform the same functions as the snaps 122 and lips 124 of the first embodiment of the harness 10 (FIGS. 1A-1D). The bottom portion 700 also comprises openings 724 which traverse from the top face 710 to the bottom face 712. The openings 724 result in a similar way as the openings 126 of the first embodiment of the harness 10 (FIGS. 1A-1D).

The bottom portion 700 further comprises indentions 726 at the first 706 and second 708 side faces between the first 702 and second 704 end faces. Protrusions on the second embodiment of the optical assembly housing 70 may reside within the indentions 726, as further described below with FIGS. 8A-10. The bottom portion 700 also comprises tabs 728 on the top face 710. In the second embodiment, the tabs 728 extend from the first side face 706 to the second side face 708, with interruptions from the first 714 and second 716 cavities. The functions of the tabs 728 will be described below with FIGS. 7E-7H.

FIGS. 7E-7H illustrate a top perspective view, bottom perspective view, end view, and top view, respectively, of the top portion 740 of the second embodiment of the harness 20 in accordance with the present invention. The top portion 740 of the harness 20 comprises a block of material with a first end face 742, a second end face 744, a first side face 746, a second side face 748, a top face 750, and a bottom face 752. At the bottom face 752 are a first feature 754 for the first optical subassembly (not shown), such as a ROSA, and a second feature 756 for the second optical subassembly (not shown), such as a TOSA. In the second embodiment, the features 754 and 756 are cavities in which the first and second subassemblies may reside. The cavities 754 and 756 traverse the bottom face 752 from the first end face 742 to the second end face 744. The features of the cavities 754 and 756 can mirror the features of the bodies of the particular ROSA and TOSA to be used. For example, ridges 755 in the first cavity 754 and ridges 757 in the second cavity 756 may mirror the ridges of the bodies of the ROSA and TOSA.

The top portion 740 also comprises indentions 758 at the first 746 and second 748 side faces, which comprise ridges 760. The snaps 720 of the bottom portion 700 may reside within the indentions 758 with the ridges 760 engaging the lips 722. The engaging of the ridges 760 and the lips 722 couples the bottom 700 and top 740 portions of the harness 20. The top portion 740 further comprises indentions 762 at the first 748 and second 750 side faces. Protrusions on the second embodiment of the housing 70 may reside within the indentions 762, as further described below with FIGS. 8A-10. The top portion 740 also comprises indentions 764 on the bottom face 752. When engaged, the tabs 728 of the bottom portion 700 reside in the indentions 764, improving the EMI shielding characteristics of the harness 20.

FIG. 7I illustrates a top perspective view of a combination of the bottom portion 700 and top portion 740 of the second embodiment of the harness 20, with a ROSA and a TOSA, in accordance with the present invention. The bottom 700 and top 740 portions are coupled such that the top face 710 (hidden) of the bottom portion 700 abuts the bottom face 752 (hidden) of the top portion 740. The first end face 702 of the bottom portion 700 is proximate to the first end face 742 of the top portion 740. The snaps 720 of the bottom portion 700 reside within the indentions 758 of the top portion 740, with the lips 722 (hidden) of the snaps 720 engaging the ridges 760 (hidden). This couples the bottom portion 700 and the top portion 740 together. When coupled in this manner, the ROSA 402 resides within the first cavity 714 of the bottom portion 700 and the first cavity 754 of the top portion 740, and the TOSA 404 resides within the second cavity 716 of the bottom portion 700 and the second cavity 756 of the top portion 740. The location of the indentions 726 of the bottom portion 700 approximately matches the location of the indentions 762 of the top portion 740.

When engaged, the harness 20 constrains the ROSA and TOSA from translation along the x- and z- axes and from rotating about the x- and y-axes. The engagement also applies pressure in the y-direction to constrain the ROSA 402 and TOSA 404 from translating along the y-axis and rotating about the z-axis. The ROSA 402 and TOSA 404 are thus constrained within the harness 20 in the six possible degrees of freedom.

Although the second embodiment is described with the above manner of constraining the ROSA 402 and TOSA 404, other methods of constraint may be used without departing from the spirit and scope of the present invention. For example, epoxy may be used to constrain the ROSA 402 and/or TOSA 404 within the harness 20.

FIG. 7J illustrates a top view and an end view of the combination of the bottom portion 700 and top portion 740 of the second embodiment of the harness 20, with approximate dimensions, in accordance with the present invention. In the second embodiment, the length of the first end face 702 and the second end face 704 (hidden) of the bottom portion 700, and the first end face 742 and the second end face 744 of the top portion 740, are approximately 25.80 mm. The length of the first side face 706 and second side face 708 of the bottom portion 700, and the first side face 756 and second side face 758 of the top portion 740 are approximately 21 mm. The length of the harness 10 from the end of the ROSA 402 or TOSA 404 to the second end face 744 of the top portion 740 is approximately 30.82 mm. The dimensions of the indentions 726 (hidden) of the bottom portion 700, and the indentions 762 of the top portion 740, are approximately 0.80 mm×1 mm, with the 1 mm side traversing along the z-direction. The height of the harness 20 from the top face 750 of the top portion 740 to the bottom face 712 of the bottom portion 700 is approximately 8.15 mm. The dimensions above are approximate. Other dimensions may be used without departing from the spirit and scope of the present invention.

As with the first embodiment, the harness 20 is comprised of a molded plastic, with the advantages as discussed above. Other materials may be used as well without departing from the spirit and scope of the present invention.

Although the second embodiment of the harness 20 is described above with a bottom portion 700 as a single piece which contains the cavities 714 and 716 for the ROSA 402 and TOSA 404, the bottom portion 700 may comprise multiple pieces. For example, the bottom portion 700 can be two pieces, with a first piece comprising the cavity 714 for the ROSA 402 and a second piece comprising the cavity 716 for the TOSA 404. By providing the bottom portion 700 in this manner, the ROSA 402 and TOSA 404 may be replaced or upgraded independently. Similarly, the top portion 740 of the harness 20 may also be provided as a single piece or multiple pieces. Other ways of providing the harness 20 as multiple pieces may be used without departing from the spirit and scope of the present invention.

FIG. 8A illustrates a top perspective view of a combination of the bottom portion 700 of the second embodiment of the harness 20 and a he bottom portion 770 of the second embodiment of the housing 70, in accordance with the present invention. The bottom portion 770 of the housing 70 comprises a bottom plate 772 with a first end 774, a second end 776, a first side 778, a second side 780, and a top face 782. Coupled to the bottom plate 772 and proximate to the first side 778 is a first side wall 786 which traverses from the first end 774 to the second end 776. Coupled to the bottom plate 772 and proximate to the second side 780 is a second side wall 788 which traverses from the first end 774 to the second end 776. The bottom portion 770 of the second embodiment of the housing 70 is the same as the bottom portion 200 of the first embodiment of the housing 60 (FIG. 2), except the bottom portion 770 does not have the post 218. Instead, the bottom portion 770 comprises protrusions 790 coupled to the first 786 and second 788 side walls proximate to the first end 774 of the bottom plate 772. The protrusions 790 extend from the side walls 786 and 788 toward each other.

The bottom portion 700 of the harness 20 resides within the bottom portion 770 of the housing 70 so that the protrusions 790 reside within the indentions 726 of the bottom portion 700 of the harness 20. Preferably, the first side face 706 of the bottom portion 700 of the harness 20 abuts against the first side wall 786 of the bottom portion 770 of the housing 70. The second side face 708 of the bottom portion 700 of the harness 20 abuts against the second side wall 788 of the bottom portion 770 of the housing 70. The first end face 702 of the harness 20 is facing outward from the first end 774 of the housing 70. The portion of the bottom portion 700 of the harness 20 between the first end face 702 and the indentions 726 may protrude from the edge of the first end 774 of the housing 70.

FIG. 8B illustrates a top perspective view of the bottom portion 700 of the second embodiment of the harness 20, the bottom portion 770 of the second embodiment of the housing 70, a ROSA 402, and a TOSA 404, in accordance with the present invention. As illustrated in FIG. 8B, a ROSA 402 and a TOSA 404 may be placed within the cavities 714 and 716 of the bottom portion 700 of the harness 20. The features of the cavities 714 and 716 are a mirror of the features of the bodies of the ROSA 402 and TOSA 404, respectively. In the second embodiment, a circuit board (not shown) would reside within the remaining portion of the top face 782 of the bottom plate 772. Connectors 406, such as pins, from the ROSA 402 and the TOSA 404 can be coupled to the circuit board, either by solder or some other coupling means.

FIG. 9 illustrates a top perspective view of a combination of the top portion 740 and the bottom portion 700 of the second embodiment of the harness 20, the bottom portion 770 of the housing 70, the ROSA 402, and the TOSA 404, in accordance with the present invention. As illustrated in FIG. 9, the top portion 740 of the harness 20 is placed over the bottom portion 700 of the harness 20, the ROSA 402, and the TOSA 404, as described above with FIG. 71. The protrusions 790 reside within the indentions 762 in the top portion 740 and the indentions 726 (hidden) of the bottom portion 700.

FIG. 10 illustrates a top perspective view of the second embodiment of the optical assembly housing 70 retrofitted with the second embodiment of the harness 20 in accordance with the present invention. The housing 70 comprises a top plate 794 with a top face 796 and a bottom face 798 (hidden). The top plate 794 is placed such that the bottom face 798 abuts the first side wall 786 (hidden) and the second side wall 788 of the bottom portion 770 of the housing 70, and abuts a part of the top face 750 of the top portion 740 of the harness 20. Preferably, the top plate 794 extends so that it touches the entire length of the side walls 786 and 788. The top plate 794 is fastened to the bottom portion 770 of the housing 70 through some type of fastening mechanism, such as epoxy. When fastened, pressure in the y-direction is applied to the top portion 740 toward the bottom portion 700 of the harness 20.

While residing in the bottom portion 770 of the housing, the harness 20 is constrained from translating along the x- and z-axes and from rotating about the x-, y-, and z-axes. The pressure from the fastening of the top plate 794 to the bottom portion 770 constrains the harness 20 from translating along the y-axes. The harness 20 is thus constrained in the possible six degrees of freedom while within the housing 70.

In the second embodiment, the bottom portion 770 of the housing 70 may also comprise holes 792 (see FIG. 8A) at the first side wall 786 and the second side wall 788. Additional holes 799 may then be placed in the top plate 794 of the housing 70 (see FIG. 10), whose locations approximately match the locations of the holes 792 in the side walls 784 and 788. Screws, or some other attachment mechanism, may then be inserted through the holes 799 and attached to the bottom portion 770 at the holes 792. In this manner, the top plate 794 is securely attached to the bottom portion 770 of the housing 70. The screws may be used instead of or in addition to the fastening mechanism described above.

Although the second embodiment is described with the above manner of constraining the harness 20, other methods of constraint may be used without departing from the spirit and scope of the present invention. For example, epoxy may be used to constrain the harness 20 within the housing 70.

FIGS. 11A through 16 illustrate a third embodiment of a harness for retrofitting an optical assembly housing in accordance with the present invention. The third embodiment of the harness 30 may be used to retrofit a third embodiment of an optical assembly housing 80.

The third embodiment of the harness 30 comprises a top portion and a bottom portion. FIGS. 11A-11D illustrate a top perspective view, bottom perspective view, end view, and top view, respectively, of the bottom portion 1100 of the third embodiment of the harness 30 in accordance with the present invention. The bottom portion 1100 of the harness 30 comprises a block of material with a first end face 1102, a second end face 1104, a first side face 1106, a second side face 1108, a top face 1110, and a bottom face 112. At the top face 1108 are a first feature 1114 for a first optical subassembly, such as a ROSA, and a second feature 1116 for a second optical subassembly, such as a TOSA. In the third embodiment, the features 1114 and 1116 comprise cavities in which the subassemblies may reside. The cavities 1114 and 1116 traverse the top face 1110 from the first end face 1102 to the second end face 1104. The features of the cavities 1114 and 1116 can mirror the features of the bodies of the particular ROSA and TOSA to be used. For example, ridges 1118 in the first cavity 1114 and ridges 1120 in the second cavity 1116 may mirror the features of the bodies of the ROSA 402 and TOSA 404.

The bottom portion 1100 further comprises snaps 1122 with lips 1124 coupled to the first 1106 and second 1108 side faces. The snaps 1122 couple the bottom portion 1100 to the top portion 1200, as described further below with FIGS. 12A-12D. The bottom portion 1100 also comprises protrusions 1126 coupled to the first 1106 and second 1108 side faces, and protrusions 1128 coupled to the bottom face 1112, with a protrusion 1128 coupled under each cavity 1114 and 1116. The bottom portion 1100 further comprises an opening 1130 proximate to the first end face 1102, residing between the first 1114 and second 1116 cavities, an traversing from the top face 1110 to the bottom face 1112. The bottom portion 1100 further comprises indentions 1138 at the first 1106 and second 1108 side walls and proximate to the first end face 1102. The functions of the protrusions 1126 and 1128, and the openings 1130 and 1138 are explained below with FIG. 14.

An opening 1132 may be added between the two cavities 1114 and 1116 in order to maintain approximate uniform wall thickness of the harness 30. Openings 1134 may also be added to the cavities 1114 and 1116 to facilitate heat dissipation from the subassemblies. The openings 1132 and 1134 also increase the ease of manufacturing the harness 30 and may also decrease the costs. The openings 1132 and 1134 may be placed elsewhere in the bottom portion 1100. Additional openings may also be added without departing from the spirit and scope of the present invention.

The bottom portion 1100 further comprises openings 1136 proximate to the snaps 1122 which traverse from the top face 1110 to the bottom face 1112. The openings 1136 result from a similar way as the openings 126 of the first embodiment of the harness 10.

FIGS. 12A-12D illustrate a top perspective view, bottom perspective view, end view, and top view, respectively, of the top portion 1200 of the third embodiment of the harness 30 in accordance with the present invention. The top portion 1200 of the harness 30 comprises a block of material with a first end face 1202, a second end face 1204, a first side face 1206, a second side face 1208, a top face 1210, and a bottom face 1212. At the bottom face 1212 are a first feature 1214 and a second feature 1216. In the third embodiment, the features 1214 and 1216 comprise cavities for a ROSA and a TOSA, respectively. The cavities 1214 and 1216 traverse the bottom face 1212 from the first end face 1202 to the second end face 1204. As with the bottom portion 1100, the features of the cavities 1214 and 1216 can mirror the features of the bodies of the ROSA and TOSA to be used. For example, ridges 1218 in the first cavity 1214 and ridges 1220 in the second cavity 1216 may mirror the ridges of the bodies of the ROSA and TOSA.

The top portion 1200 also comprises protrusions 1222 coupled to the first 1206 and second 1208 side faces, and an opening 1224 between the cavities 1214 and 1216 which traverses form the top face 1210 to the bottom face 1212. The top portion 1200 further comprises indentions 1232 at the first 1206 and second 1208 side walls and proximate to the first end face 1202. The functions of the protrusions 1222 and the openings 1224 and 1232 are explained below with FIG. 14.

The top portion 1200 further comprises a ridge 1226 coupled to the first 1206 and second 1208 side faces. The bottom portion 1100 and the top portion 1200 may be coupled with a ROSA 402 residing within the first cavities 1114 and 1214 of the bottom 1100 and top portion 1200, respectively, and with a TOSA residing within the second cavities 1116 and 1216 of the bottom 1100 and top 1200 portions, respectively. The lips 1124 of the snaps 1122 of the bottom portion 1100 (FIG. 11) engage the ridges 1226 of the top portion 1200, thus fastening the top 1200 and bottom 1100 portions of the harness 30. When engaged in this manner, the harness 30 constrains the ROSA and TOSA from translation along the x- and z- axes and from rotating about the x- and y-axes. The engagement also applies pressure in the y-direction to constrain the ROSA and TOSA from translating along the y-axis and rotating about the z-axis. The ROSA and TOSA are thus constrained within the harness 30 in the six possible degrees of freedom.

Although the third embodiment is described with the above manner of constraining the ROSA and TOSA, other methods of constraint may be used without departing from the spirit and scope of the present invention. For example, epoxy may be used to constrain the ROSA and/or TOSA within the harness 30.

The top portion 1200 further comprises an opening 1228 which may be added between the two cavities 1214 and 1216 in order to maintain approximate uniform wall thickness of the harness 30. Openings 1230 may also be added to the cavities 1214 and 1216 to facilitate heat dissipation from the subassemblies. The openings 1228 and 1230 may be placed elsewhere in the top portion 1200. Additional openings may also be added without departing from the spirit and scope of the present invention.

As with the first and second embodiment, the third embodiment of the harness 30 is comprised of a molded plastic, with the advantages as discussed above. Other materials may be used as well without departing from the spirit and scope of the present invention.

As with the first and second embodiments, the bottom portion 1100 of the third embodiment of the harness 30 may comprise multiple pieces. For example, the bottom portion 1100 can be two pieces, with a first piece comprising the cavity 1114 for the ROSA and a second piece comprising the cavity 1116 for the TOSA. By providing the bottom portion 1100 in this manner, the ROSA and TOSA may be replaced or upgraded independently. Similarly, the top portion 1200 of the harness 30 may also be provided as a single piece or multiple pieces. Other ways of providing the harness 30 as multiple pieces may be used without departing from the spirit and scope of the present invention.

FIG. 12E illustrates a top view and an end view of the combination of the bottom portion 1100 and top portion 1200 of the third embodiment of the harness 30, with approximate dimensions, in accordance with the present invention. In the third embodiment, the length of the first end face 1102 (hidden) and second end face 1104 (hidden) of the bottom portion 1100, and the first end face 1202 and second end face 1204 of the top portion 1200 are approximately 0.918 mm. The length of the first side face 1106 and second side face 1108 (hidden) of the bottom portion 1100, and the first side face 1206 and second side face 1208 of the top portion 1200 are approximately 0.826 mm. The length of the harness 30 from the second end faces 1104 and 1204 to the end of the ROSA 402 or TOSA 404 is approximately 1.222 mm. The length from the end of the connectors 406 of the ROSA 402 or TOSA 404 to the opposite end of the ROSA 402 or TOSA 404 is approximately 1.654 mm. The height of the harness 30 from the top face 1210 of the to portion 1200 to the bottom face 1112 of the bottom portion 1100 is approximately 0.370 mm. The dimensions above are approximate. Other dimensions may be used without departing from the spirit and scope of the present invention.

FIG. 13 illustrates a top perspective view of the bottom portion 1300 of the third embodiment of an optical assembly housing 80 which can be retrofitted by the third embodiment of the harness 30 in accordance with the present invention. The bottom portion 1300 of the housing 80 comprises a bottom plate 1302 with a first end 1304, a second end 1306, a first side 1308, a second side 1310, and a top face 1312. Coupled to the bottom plate 1302 and proximate to the first side 1308 is a first side wall 1314 which traverses from the first end 1302 to the second end 1304. Coupled to the bottom plate 1302 and proximate to the second side 1310 is a second side wall 1316 which traverses from the first end 1302 to the second end 1304. The first 1314 and second 1316 side walls extend outward from the top face 1312. Proximate to the first d end 1304, the first 1314 and second 1316 side walls comprise indentions 1318. Proximate to the first end 1304 and coupled to the top face 1312, the bottom plate 1302 comprises a post 1320 and indentions 1322. Proximate to the first end 1304, coupled to the top face 1312, and coupled to the first 1314 and second 1316 side walls are protrusions 1324. The functions of the post 1320, indentions 1318 and 1322, and protrusions 1324 will be described below in conjunction with FIG. 14.

FIG. 14 illustrates a top perspective view of a combination of the bottom portion 1100 of the third embodiment of the harness 30, the bottom portion 1300 of the third embodiment of the optical assembly housing 80, a ROSA 402, and a TOSA 404 in accordance with the present invention.

The bottom portion 1100 of the harness 30 resides within the bottom portion 1300 of the housing 80 so that the first 1106 and second 1108 side walls of the bottom portion 1100 of the harness 30 abut against the first 1314 and second 1316 side walls of the bottom portion 1300 of the housing 80, respectively, such that the ridges 1126 of the bottom portion 1100 of the harness 30 reside within the indentions 1318 of the bottom portion 1300 of the housing 80. Similarly, the protrusions 1128 of the bottom portion 1100 of the harness 30 reside within the indentions 1322 of the bottom portion 1300 of the housing 80. The first end face 1102 of the bottom portion 1100 of the harness 30 is facing outward from the first end 1304 of the bottom plate 1302. The post 1320 of the bottom portion 1300 of the housing 80 resides within the opening 1130 of the bottom portion 1100 of the harness 30. The protrusions 1324 of the bottom portion 1300 of the housing 80 reside within the indentions 1138 of the bottom portion 1100 of the harness 30.

The ROSA 402 and TOSA 404 may be placed within the cavities 1114 and 1116 of the bottom portion 1100 of the harness 30. The features of the cavities 1114 and 1116 are a mirror of the features of the bodies of the ROSA 402 and TOSA 404, respectively.

In the third embodiment, a circuit board (not shown) would reside within the remaining portion of the top face 1312 of the bottom plate 1302. Connectors 406, such as pins, from the ROSA 402 and the TOSA 404 can be coupled to the circuit board, either by solder or some other coupling means.

FIG. 15 illustrates a top perspective view of a combination of the top 1200 and bottom 1100 portions of the third embodiment of the harness 30, the bottom portion 1300 of the third embodiment of the housing 80, the ROSA 402, and the TOSA 404, in accordance with the present invention. As illustrated in FIG. 15, the top portion 1200 of the harness 30 is placed over the bottom portion 1100 of the harness 30, the ROSA 402, and the TOSA 404, as described above with FIGS. 11A-12D. The lips 1124 (hidden) of the snaps 1122 of the bottom portion 1100 engage the ridges 1226 (hidden) of the top portion 1200, coupling the top 1200 and bottom 1100 portions. Preferably, the first 1202 and second 1204 side faces abut the first 1314 and second 1316 side walls of the bottom portion 1300 of the housing 80, respectfully. The ridges 1222 of the top portion 1200 of the harness 30 reside within the indentions 1318 of the bottom portion 1300 of the housing 80. When the top 1200 and bottom 1100 portions of the harness 30 are placed as described above, the location of the opening 1224 of the top portion 1200 approximately matches the location of the opening 1130 of the bottom portion 1100 of the harness 30. The post 1320 resides within the openings 1130 and 1224. The protrusions 1324 of the bottom portion 1300 of the housing 80 reside within the indentions 1232 of the top portion 1200 of the harness 30.

FIG. 16 illustrates a top perspective view of the third embodiment of the optical assembly housing 80 retrofitted with the third embodiment of the harness 30 in accordance with the present invention. The housing 80 comprises a top plate 1350 with a top face 1352 and a bottom face 1354 (hidden). The top plate 1350 is placed such that the bottom face 1354 (hidden) abuts the first side wall 1314 (hidden) and the second side wall 1316 of the bottom portion 1300 of the housing 80, and abuts the top face 1210 (hidden) of the top portion 1200 of the harness 30. Preferably, the top plate 1350 extends so that it abuts the entire length of the first 1314 and second 1316 side walls. The top plate 1350 is fastened to the housing 80 through some type of fastening mechanism, such as epoxy. When fastened, pressure is applied in the y-direction to the top portion 1200 toward the bottom portion 1100 of the harness 30.

When residing within the bottom portion 1300 of the housing 80, the harness 30 is constrained from translating along the x- and z-axes and from rotating about the x-, y-, and z-axes. The pressure from the fastening of the top plate 1350 to the bottom portion 1300 constrains the harness 30 from translating along the y-axis. The harness 30 is thus constrained in the possible six degrees of freedom when residing within the housing 80.

Although the third embodiment is described with the above manner of constraining the harness 30, other methods of constraint may be used without departing from the spirit and scope of the present invention. For example, epoxy may be used to constrain the harness 30 within the housing 80.

FIGS. 17A-25 illustrate a fourth embodiment of a harness for retrofitting an optical assembly housing in accordance with the present invention. The fourth embodiment of the harness 40 may be used to retrofit a fourth embodiment of the optical assembly housing 90.

The fourth embodiment of the harness 40 comprises a top portion, a bottom portion, and a clip. FIGS. 17A-17D illustrate a top perspective view, bottom perspective view, end view, and top view, respectively, of the bottom portion 1700 of the fourth embodiment of the harness 40 in accordance with the present invention. The bottom portion 1700 of the harness 40 comprises a block of material with a first end face 1702, a second end face 1704, a first side face 1706, a second side face 1708, a top face 1710, and a bottom face 1712. At the top face 1710 are a first feature 1714 for a first optical subassembly, such as a TOSA 404, and a second feature 1716 for a second optical subassembly, such as a ROSA. In the fourth embodiment, the features 1714 and 1716 comprise cavities. The cavities 1714 and 1716 traverse the top face 1710 from the first end face 1702 to the second end face 1704. As with the first, second, and third embodiments, the features of the cavities 1714 and 1716 can mirror the features of the bodies of the particular ROSA and TOSA to be used. For example, ridges 1718 in the first cavity 1714 and ridges 1720 in the second cavity 1716 may mirror the ridges of the bodies of the TOSA and ROSA.

FIGS. 18A-18D illustrates a top perspective view, bottom perspective view, end view, and top view, respectively, of the top portion 1800 of the fourth embodiment of the harness 40 in accordance with the present invention. The top portion 1800 of the harness 40 comprises a block of material with a first end face 1802, a second end face 1804, a first side face 1806, a second side face 1808, a top face, 1810, and a bottom face 1812. At the bottom face 1812 are a first feature 1814, such as a cavity, for a TOSA, and a second feature 1816, such as a cavity, for a ROSA. Coupled between the top face 1810 and the first side face 1806 is a first slanted surface 1818. Coupled between the top face 1810 and the second side face 1806 is a second slanted surface 1820. The functions of the slanted surface 1818 and 1820 will be described below with FIG. 21A.

FIG. 19 illustrates a top perspective view of a combination of the bottom portion 1700 and top portion 1800 of the harness 40 in accordance with the present invention. The TOSA 404 resides within the first cavity 1714 (hidden) of the bottom portion 1700, and the ROSA 404 resides within the second cavity 1716 of the bottom portion 1700. The top portion 1800 is placed on top of the bottom portion 1700, the ROSA 402, and the TOSA 404, such that the TOSA 404 resides within the first cavity 1816 of the top portion 1800, the ROSA 402 resides within the second cavity 1814 of the top portion 1800 of the harness 40, and the bottom face 1812 (hidden) of the top portion 1800 is proximate to the top face 1710 (hidden) of the bottom portion 1700 of the harness 40. The top portion 1800 is placed so that its first end face 1802 is proximate to the first end face 1702 of the bottom portion 1700.

FIGS. 20A-20D illustrate a top perspective view, bottom perspective view, end view, and top view, respectively, of the clip 2000 of the fourth embodiment of the harness 40 in accordance with the present invention. The clip 2000 preferably comprises a single sheet of material, such as metal. The sheet is bent to form a top plate 2002 with a first end 2004, a second end 2006, a first side 2008, a second side 2010, a top face 2012, and a bottom face 2014. Coupled to the top plate 2002 at the first side 2008 is a first side wall 2016 which traverses from the first end 2004 to the second end 2006. Coupled to the top plate 2002 at the second side 2010 is a second side wall 2018 which traverses from the first end 2004 to the second end 2006. Coupled between the top face 2012 and the first side wall 2016 is a first slanted surface 2026. Coupled between the top face 2012 and the second side wall 2018 is second slanted surface 2028. The functions of the slanted surfaces 2026 and 2028 will be described below with FIGS. 24A-24B.

At the first 2004 and second 2006 ends, the top plate 2002 is bent to form protrusions 2020 which traverses from the first side 2008 to the second side 2010. At the end of the first 2016 and second 2018 side walls distal to the top plate 2002, the first 2016 and second 2018 side walls are bent to form protrusions 2022 which traverse from the first end 2004 to the second end 20 2006. The first side wall 2016, the second side wall 2018, and the protrusion 2020 extend from the top plate 2002 in the same direction. The protrusions 2022 at the first 2016 and second 2018 side walls extend toward each other. The functions of the protrusions 2020 and 2022 are described below with FIG. 21A.

Preferably, the clip 2000 further comprises springs 2024 which protrude outward from the top wall 2006 in the opposite direction than the first 2016 and second 2018 side walls. The springs 2024, when touching another metal surface, may provide an electrical ground.

The bottom 1700 and top 1800 portions of the fourth embodiment of the harness 40 are comprised of a molded plastic, with the advantages as discussed above. Preferably, the clip 2000 of the fourth embodiment of the harness 40 is comprised of sheet of metal. The metal may have spring characteristics to assist in fitting the clip 2000 around the bottom 1700 and top 1800 portions, as described above. The springs 2024 can abut against another electrically conductive material to provide electrical grounding. Other materials may be used for the bottom portion 1700, top portion 1800, or clip 2000 as well without departing from the spirit and scope of the present invention.

The bottom portion 1700 of the fourth embodiment of the harness 40 may comprise multiple pieces. For example, the bottom portion 1700 can be two pieces, with a first piece comprising the cavity 1714 for the TOSA 404 and a second piece comprising the cavity 1716 for the ROSA 402. By providing the bottom portion 1700 in this manner, the ROSA 402 and TOSA 404 may be replaced or upgraded independently. Similarly, the top portion 1800 and the clip 2000 of the harness 40 may also be provided as a single piece or multiple pieces. Other ways of providing the harness 40 as multiple pieces may be used without departing from the spirit and scope of the present invention.

FIG. 21A illustrates a top perspective view of a combination of the bottom portion 1700, top portion 1800, and clip 2000 of the fourth embodiment of the harness 40 in accordance with the present invention. The clip 2000 is placed around the bottom 1700 and top portions 1800 of the harness 40 as illustrated in FIG. 19. The bottom face 2014 (hidden) of the top plate 2002 of the clip 2000 abuts the top face 1810 (hidden) of the top portion 1800 of the harness 40. The first slanted surface 1818 of the top portion 1800 abuts against the first slanted surface 2026 of the clip 2000. The second slanted surface 1820 of the top portion 1800 abuts against the second slanted surface 2028 of the clip 2000. The protrusions 2022 of the clip 2000 abut against the bottom face 1712 (hidden) of the bottom portion 1700 of the harness 40. The protrusions 2020 abut the first end face 1802 and the second end face 1804 (hidden) of the top portion 1800 of the harness 40. The abutment of the protrusions 2020 and 2022 causes the top plate 2002 of the clip 2000 to compress such that the ROSA 402 and TOSA 404 are constrained within the harness 40 from translating along the x-, y-, and z-axes and from rotating about the x-, y-, and z-axes. The ROSA 402 and TOSA 404 are then constrained within the harness 40 in the six possible degrees of freedom.

Although the fourth embodiment is described with the above manner of constraining the ROSA 402 and TOSA 404, other methods of constraint may be used without departing from the spirit and scope of the present invention. For example, epoxy may be used to constrain the ROSA 402 and/or TOSA 404 within the harness 40.

FIG. 21B illustrates a top view and an end view of the combination of the bottom portion 1700, top portion 1800, and clip 2000 of the fourth embodiment of the harness 40, with approximate dimensions, in accordance with the present invention. In the fourth embodiment, the width of the harness 40 between the first side wall 2016 and the second side wall 2018 of the clip 2000 is approximately 0.535 mm. The length of the harness 40 between the first end 2004 and second end 2006 of the clip 2000 is approximately 0.683 mm. The length of the harness 40 from the second end 2006 to the end of the ROSA 402 or TOSA 404 is approximately 1.237 mm. The height of the harness 40 between the top face 2012 of the clip 2000 and the bottom face 1712 of the bottom portion 1700 is approximately 0.315 mm. The dimensions above are approximate. Other dimensions may be used without departing from the spirit and scope of the present invention.

FIG. 22 illustrates a top perspective view of the bottom portion 2200 of the fourth embodiment of the housing 90 which can be retrofitted by the fourth embodiment of the harness 40 in accordance with the present invention. The bottom portion 2200 of the housing 90 comprises a bottom plate 2202 with a first end 2204, a second end 2206, a first side 2208, a second side 2210, and a top face 2212. Coupled to the bottom plate 2202 at the first side 2208 is a first side wall 2214 which traverses from the first end 2204 to the second end 2206. Coupled to the bottom plate 2202 at the second side 2210 is a second side wall 2216 which traverses from the first end 2204 to the second end 2206. The first side wall 2214 comprises a first opening 2218, and the second side wall 2216 comprises a second opening 2220. The functions of the openings 2218 and 2220 will be discussed below with FIG. 23. Coupled to the bottom plate 2202 and proximate to the first end 2204 is a front plate 2222 which traverses from the first side 2208 to the second side 2210. The front plate 2222 comprises a first opening 2224 and a second opening 2226. The functions of the front plate 2222 and its openings 2224 and 2226 will be described below with FIG. 23. Preferably, the front plate 2222 further comprises a third opening 2228 for an actuator 2230 (see FIG. 23) for disengaging the optical assembly housing 90 from a larger system. The actuator 2230 is well known in the art and will not be further discussed here.

FIG. 23 illustrates a top perspective view of a combination of the harness 40 and bottom portion 2200 of the optical assembly housing 90 in accordance with the present invention. The harness 40, as illustrated in FIG. 21A, is placed within the bottom portion 2200 of the housing 90 such that the first side wall 2016 (hidden) of the clip 2000 resides within the opening 2218 (hidden) of the first side wall 2214 of the bottom portion 2200. The clip 2000 fits within the openings 2218 and 2220 such that the first end 2004 of the clip 2000 is proximate to the first end 2204 of the bottom portion 2200, and the second end 2006 of the clip 2000 is proximate to the second end 2206 of the bottom portion 2200. The locations of the openings 2224 (hidden) and 2226 of the front wall 2222 of the bottom portion 2200 is such that the TOSA 404 and ROSA 402, respectively, may reside within without placing undue stress upon the subassemblies 402 and 404.

FIG. 24A illustrates a bottom perspective view of the top portion 2400 of the fourth embodiment of the housing 90 which can be retrofitted by the fourth embodiment of the harness 40 in accordance with the present invention. The top portion 2400 comprises a plate 2402 with a first end 2404, a second end 2406, a first side 2408, a second side 2410, a top face 2412, and a bottom face 2414. The plate 2402 comprises an opening 2416 proximate to the first end 2404. The function of the opening 2416 will be described below with FIG. 25.

Coupled to the plate 2402 proximate to the first side 2408 is a first side wall 2418 which traverses from the first end 2404 to the second end 2406. The first side wall 2418 comprises a first opening 2422 proximate to the first end 2404 and a second opening 2432 proximate to the second end 2406. Coupled to the plate 2402 proximate to the second side 2410 is a second side wall 2420 which traverses from the first end 2404 to the second end 2406. The second side wall 2418 comprises a first opening 2424 proximate to the first end 2404 and a second opening 2434 proximate to the second end 2406. The functions of the openings 2422, 2424, 2432, and 2434 will be described below with FIG. 25.

Coupled to the plate 2402 proximate to the first end 2404 is a front plate 2426 which traverses from the first side 2408 to the second side 2410. The front plate 2426 comprises a first opening 2428 proximate to the first side 2408 and a second opening 2430 proximate to the second side 2410. The functions of the openings 2428 and 2430 will be described below with FIG. 25.

Coupled to the plate 2402 proximate to the second end 2406 is a back plate 2430 which traverses from the first side 2408 to the second side 2410.

Proximate to the opening 2424, the to plate 2402 comprises slanted surfaces 2436. FIG. 24B illustrates a bottom perspective close-up view of the slanted surfaces 2436 of the top portion 2400 of the fourth embodiment of the optical assembly housing 90 in accordance with the present invention. The slanted surfaces 2436 traverse the opening 2424 in the z-direction. These slanted surfaces 2436 may abut against the slanted surfaces 2026 and 2028 of the clip 2000. The functioning of the slanted surfaces 2436 will be described below with FIG. 25.

FIG. 25 illustrates a top perspective view of the fourth embodiment of the optical assembly housing 90 retrofitted with the fourth embodiment of the harness 40 in accordance with the present invention. The optical assembly 2500 comprises the combination of the harness 40, the bottom portion 2200 of the housing 90, as illustrated in FIG. 23, and the top portion 2400 of the housing 90, illustrated in FIGS. 24A-24B. The top portion 2400 is placed on the assembly illustrated in FIG. 23, such that the first end 2404 of the top portion 2400 is proximate to the first end 2204 of the bottom portion 2200.

When placed in this manner, the first side wall 2016 (hidden) of the clip 2000 resides within the first opening 2422 (hidden) in the first side wall 2418 of the top portion 2400, the second side wall 2018 (hidden) of the clip 2000 resides within the first opening 2424 in the second side wall 2420 of the top portion 2400 of the housing 90, and the top plate 2002 of the clip 2000 resides within the opening 2416 in the plate 2402 of the top portion 2400. The slanted surfaces 2026 and 2028 (hidden) of the clip 2000 abut against the slanted surfaces 2436 (hidden) of the top portion 2400. The springs 2424 of the clip 2000 protrude out of the opening 2416 away from the assembly 2500. When placed in this manner, the first side wall 2214 (hidden) of the bottom portion 2200 resides within the second opening 2432 (hidden) of the first side wall 2418 (hidden) of the top portion 2400, and the second side wall 2216 of the bottom portion 2200 resides within the second opening 2434 of the second side wall 2420 of the top portion 2400.

The locations of the openings 2428 and 2430 of the front plate 2426 of the top portion 2400 are such that the TOSA 404 and ROSA 402 reside within the openings 2428 and 2430, respectively, without placing undue strain on the subassemblies 402 and 404. The top portion 2400 is then coupled to the bottom portion 2200 of the housing 90 through some type of attachment means, such as epoxy.

When residing within the bottom portion 2200 of the housing 90, the harness 40 is constrained from translating along the z-axis and from rotating about the y-axis. The pressure from the fastening of the top portion 2400 to the bottom portion 2200 constrains the harness 40 from translating along the x- and y-axes and from rotating about the x- and z-axes. The harness 40 is thus constrained in the possible six degrees of freedom when residing within the housing 90.

Although the fourth embodiment is described with the above manner of constraining the harness 40, other methods of constraint may be used without departing from the spirit and scope of the present invention. For example, epoxy may be used to constrain the harness 40 within the housing 90.

FIGS. 26A through 32 illustrate a fifth embodiment of a harness for retrofitting an optical assembly housing in accordance with the present invention. The fifth embodiment of the harness 50 may be used to retrofit the second embodiment of the optical assembly housing 70, illustrated in FIGS. 8A-10.

The fifth embodiment of the harness 50 comprises a bottom portion and a top portion. FIGS. 26A-26D illustrate a top perspective view, bottom perspective view, end view, and top view, respectively, of the bottom portion 2600 of the fifth embodiment of the harness 50 in accordance with the present invention. The bottom portion 2600 comprises a block of material with a first end face 2602, a second end face 2604, a first side face 2606, a second side face 2608, a top face 2610, and a bottom face 2612. At the top face 2610 are a first feature 2614 for a first optical subassembly, such as a ROSA, and a second feature 2616 for a second optical subassembly, such as a TOSA. In the fifth embodiment, the features 2614 and 2616 are cavities within which the subassemblies may reside. The cavities 2614 and 2616 traverse from the first end face 2602 to the second end face 2604. The features of the cavities 2614 and 2616 can mirror the features of the bodies of the particular ROSA and TOSA to be used. For example, ridges 2618 in the first cavity 2614 and ridges 2620 in the second cavity 2616 may mirror the ridges of the bodies of the ROSA and TOSA. The first 2606 and second 2608 side faces comprise indentions 2622 and 2624, respectively, the functions of which will be described with FIG. 30. In the fifth embodiment, the second side face 2408 also comprises an opening 2626 proximate to the second end face 2604. The opening 2626 accommodates a thermal electric cooler (TEC) and thermister for the TOSA. TECs and thermisters are well known in the art and will not be further described here.

FIG. 27 illustrates a top perspective view of a combination of the bottom portion 2600 of the fifth embodiment of the harness 50, a ROSA 402, a TOSA 404, and a TEC 2702, in accordance with the present invention. The ROSA 402 resides within the first cavity 2614, and the TOSA 404 resides within the second cavity 2616. A TEC 2702 is placed within the opening 2626. The shape and size of the opening 2626 may vary depending upon the shape and size of the TEC 2702. The TOSA 404 can be surrounded by a thermally conductive material 2704 (TCM) which connects the TOSA 404 to the TEC 2702. The TEC 2702 conducts heat away from the TOSA 404, thus cooling it. A thermister 2710 may also reside proximate to the TEC 2702 to monitor the temperature of the TEC 2702. When residing within an optical assembly housing, the heat is transferred to the housing which radiates it out to the atmosphere. The TEC 2704 may also be used to heat the TOSA 404 so that a stable temperature for the TOSA 404 is provided. This increases the thermal stability of the device.

FIG. 28 illustrates in more detail a top perspective view of the TCM 2704 for the fifth embodiment of the harness 50 in accordance with the present invention. The TCM 2704 comprises a cavity 2706 in which the TOSA 404 may reside. Preferably, the cavity 2706 is of a shape which allows the TCM 2704 to traverse the circumference of a portion of the body of the TOSA 404. The TCM 2704 also comprises an outside surface 2708 which is abutted against the housing. Other shapes of the TCM 2704 are possible without departing from the spirit and scope of the present invention.

Although the TEC 2704, TCM 2620, and thermister 2710 are described in the illustrated orientation, other orientations within or proximate to the harness 50 is possible without departing from the spirit and scope of the present invention.

FIGS. 29A-29D illustrate a top perspective view, bottom perspective view, end view, and top view, respectively, of the top portion 2900 of the fifth embodiment of the harness 50 in accordance with the present invention. The top portion 2900 comprise a block of material with a first end face 2902, a second end face 2904, a first side face 2906, a second side face 2908, a top face 2910, and a bottom face 2912. At the bottom face 2912 are a first feature 2914 and a second feature 2916. In the fifth embodiment, the features 2914 and 2916 are cavities within which subassemblies may reside. As with the cavities 2614 and 2616 in the bottom portion 2600, the features of the cavities 2914 and 2916 mirror features of the bodies of the ROSA and TOSA to be used. For example, ridges 2918 in the first cavity 2914 and ridges 2920 in the second cavity 2916 can mirror the ridges the ROSA and 404, respectively. The first 2906 and second 2908 side faces comprise indentions 2922 and 2944, respectively, the functions of which will be described with FIG. 30. The second side face 2908 also comprises an opening 2926 to accommodate the TEC 2702, TCM 2704, and thermister 2710.

FIG. 29E illustrates a top perspective view of a combination of the bottom 2600 and top 2900 portions of the harness 50 with the ROSA 402 and TOSA 404, in accordance with the present invention. The bottom 2600 and top 2900 portions are coupled such that the top face 2610 (hidden) of the bottom portion 2600 abuts the bottom face 2912 (hidden) of the top portion 2900. The first end face 2602 of the bottom portion 2600 is proximate to the first end face 2902 of the top portion 2900. When coupled in this manner, the ROSA 402 resides within the first cavity 2614 of the bottom portion 2600 and the first cavity 2914 of the top portion 2900, and the TOSA 404 resides within the second cavity 2616 of the bottom portion 2600 and the second cavity 2916 of the top portion 2900. The location of the indentions 2622 (hidden) and 2624 of the bottom portion 2600 approximately matches the locations of the indentions 2922 and 2924 of the top portion 2900, respectively. The location of the indentions 2626 of the bottom portion 2600 approximately matches the location of the indentions 2926 of the top portion 2900. The bottom 2600 and top 2900 portions are then coupled using a coupling mechanism, such as epoxy. Other coupling mechanisms may be used.

When coupled in this manner, the ROSA 402 and TOSA 404 are constrained by the harness 50 from translating in the x-, y-, and z-axes and from rotating about the x-, y-, and z-axes. The ROSA 402 and TOSA 404 are thus constrained within the harness 50 in the six possible degrees of freedom.

Although the fifth embodiment is described with the above manner of constraining the ROSA 402 and TOSA 404, other methods of constraint may be used without departing from the spirit and scope of the present invention. For example, epoxy may be used to constrain the ROSA 402 and/or TOSA 404 within the harness 50.

As with the previous embodiments, the harness 50 is comprised of a molded plastic, with the advantages as discussed above. Other materials may be used as well without departing from the spirit and scope of the present invention.

Although the fifth embodiment of the harness 50 is described above with a bottom portion 2600 as a single piece which contains the cavities 2614 and 2616 for the ROSA 402 and TOSA 404, the bottom portion 2600 may comprise multiple pieces. For example, the bottom portion 2600 can be two pieces, with a first piece comprising the cavity 2614 for the ROSA 402 and a second piece comprising the cavity 2616 for the TOSA 404. By providing the bottom portion 2600 in this manner, the ROSA 402 and TOSA 404 may be replaced or upgraded independently. Similarly, the top portion 2900 of the harness 50 may also be provided as a single piece or multiple pieces. Other ways of providing the harness 50 as multiple pieces may be used without departing from the spirit and scope of the present invention.

FIG. 29F illustrates a top view and an end view of the combination of the bottom portion 2600 and top portion 2900 of the fifth embodiment of the harness 50, with approximate dimensions, in accordance with the present invention. In the fifth embodiment, the width of the first end face 2602 and the second end face 2604 (hidden) of the bottom portion 2600, and the first end face 2902 and the second end face 2904 of the top portion 2900 are approximately 25.80 mm. The length of the first side face 2606 (hidden) and second side face 2608 of the bottom portion 2600, and the first side face 2906 and second side face 2908 of the top portion 2900 are approximately 21 mm. The length of the harness 50 from the second end face 2904 to the end of the ROSA 402 or TOSA 404 is approximately 30.82 mm. The dimensions of the opening 2626 of the bottom portion 2600 and the opening 2926 of the top portion 2900 is approximately 2.70 mm in the x-direction, 8.10 mm in the y-direction, and 8.15 mm in the z-direction. The height of the harness 50 from the top face 2910 of the top portion 2900 to the bottom face 2612 of the bottom portion 2600 is approximately 9.35 mm. The dimensions above are approximate. Other dimensions may be used without departing from the spirit and scope of the present invention.

FIG. 30 illustrates a top perspective view of a combination of the bottom portion 2600 of the fifth embodiment of the harness 50, the bottom portion 770 of the second embodiment of the housing 70, the ROSA 402, the TOSA 404, and the TEC 2702 in accordance with the present invention. The first side face 2606 of the bottom portion 2600 of the harness 50 abuts the first side wall 786 of the bottom portion 770 of the housing 70. The second side face 2608 of the bottom portion 2600 of the harness 50 abuts the second side wall 788 of the bottom portion 770 of the housing 70. The protrusions 790 of the bottom portion 770 of the housing 70 reside within the indentions 2622 and 2624 in the bottom portion 2600 of the harness 50. The TEC 2702 is abutted against the second side wall 788 of the bottom portion 770 of the housing 70. In this manner, the TEC 2702 transfers heat away from the TOSA 404 to the housing 70, which then dissipates the heat into the atmosphere.

A circuit board (not shown) would reside within the remaining portion of the housing 70. Connectors 406, such as pins, from the ROSA 402 and the TOSA 404 and connectors 408 for the thermister 2710 can be coupled to the circuit board, either by solder or some other coupling means.

FIG. 31 illustrates a top perspective view of a combination of the top 2900 and bottom 2600 portions of the fifth embodiment of the harness 50, the bottom portion 770 of the second embodiment of the housing 70, the ROSA 402, and the TOSA 404 in accordance with the present invention. The top portion 2900 of the harness 50 is placed over the bottom portion 2600 of the harness 50, the ROSA 402, and the TOSA 404, as described above with FIG. 29E. The first side face 2906 of the top portion 2900 of the harness 50 abuts the first side wall 786 of the bottom portion 770 of the housing 70. The second side face 2908 of the top portion 2900 of the harness 50 abuts the second side wall 788 of the bottom portion 770 of the housing 70. The protrusions 790 of the bottom portion 770 of the housing 70 reside within the indentions 2922 and 2924 in the top portion 2900.

FIG. 32 illustrates a top perspective view of the second embodiment of the optical assembly housing retrofitted by the fifth embodiment of the harness 50 in accordance with the present invention. The housing 70 comprises the top plate 794 with a top face 796 and a bottom face 798 (hidden). The top plate 794 is placed such that the bottom face 798 abuts the first side wall 786 (hidden) and the second side wall 788 of the bottom portion 770 of the housing 70, and abuts the top face 2910 of the top portion 2900 of the harness 50. Preferably, the top plate 794 extends so that it touches the entire length of the side walls 786 and 788. The top plate 794 is fastened to the housing 70 and/or harness 50 through some type of fastening mechanism, such as epoxy. When fastened, pressure is applied to the top portion 2900 toward the bottom portion 2600 of the harness 50.

The bottom portion 770 of the housing 70 may also comprise holes 792 (see FIG. 30) at the first side wall 786 and the second side wall 788. Additional holes 799 may then be placed in the top plate 794 of the housing 70 (see FIG. 32), whose locations approximately match the locations of the holes 792 in the side walls 786 and 788. Screws, or some other attachment mechanism, may then be inserted through the holes 799 and attached to the bottom portion 770 at the holes 792. In this manner, the top plate 794 is securely attached to the bottom portion 770 of the housing 70. The screws may be used instead of or in addition to the fastening mechanism described above.

When residing within the bottom portion 2600 of the housing 70, the harness 50 is constrained from translating along the x- and z-axes and from rotating about the x-, y-, and z-axes. The pressure from the fastening of the top portion 794 to the bottom portion 770 constrains the harness 50 from translating along the y-axis. The harness 50 is thus constrained in the possible six degrees of freedom when residing within the housing 70.

Although the fifth embodiment is described with the above manner of constraining the harness 50, other methods of constraint may be used without departing from the spirit and scope of the present invention. For example, epoxy may be used to constrain the harness 40 within the housing 70.

FIGS. 33A-40 illustrate a sixth embodiment of a harness for retrofitting an optical assembly housing in accordance with the present invention. The sixth embodiment of the harness 55 comprises a bottom potion 3300 and a top portion 3400. The harness 55 can be used to retrofit the third embodiment of the optical assembly housing 80, illustrated in FIGS. 13-16. The harness 55 can retrofit the housing 80 for a TOSA with a longer body and for a connector, such as a SC, ST, SMA, FSD, FC, ID4 DIN, and/or Biconic connector types. The shape and size of the connectors are standardized in the industry and will not be further described here.

FIGS. 33A-33D illustrate a top perspective view, bottom perspective view, end view, and top view, respectively, of a bottom portion 3300 of the sixth embodiment of a harness 55 for retrofitting an optical assembly housing in accordance with the present invention. The bottom portion 3300 of the harness 55 comprises a block of material with a first end 3302, a second end 3304, a first side 3306, a second side 3308, a top side 3310, and a bottom side 3312. At the top side 3310 is a first feature 3314 for a ROSA and a second feature 3316 for a TOSA. In the sixth embodiment, the features 3314 and 3316 are cavities within which the subassemblies may reside. The features of the cavities 3314 and 3316 may mirror the features of the bodies of the particular ROSA and TOSA to be used. For example, ridges 3330 in the first cavity 3314 and ridges 3332 in the second cavity 3316, may mirror the ridges of the bodies of the ROSA and TOSA.

For example, the TOSA can be a laser with an isolator and a connector nozzle. As is known in the art, lasers of this type may have a longer length than other TOSAs. Thus, the bottom portion 3300 of the harness 55 comprises an extension 3344, making the bottom portion 3300 longer in length than the bottom portions of the previously described embodiments. With the longer length, the longer TOSA may reside within the second cavity 3316 without placing undue stress upon the TOSA.

At the first end 3302, the bottom portion 3300 of the harness 55 comprises clips 3322 with lips 3324 to couple the harness 55 to the connector (not shown). Each clip 3322 comprises a lip 3324. Prior to insertion of the connector, the clips 3322 are in their neutral position. As the connector is inserted into the first end 3302 of the harness 55, the clips 3322 flex away from each other. When the connector is fully inserted, the clips 3322 flex back into their neutral position, and the lips 3324 engage features on the connector to couple the connector to the harness 55.

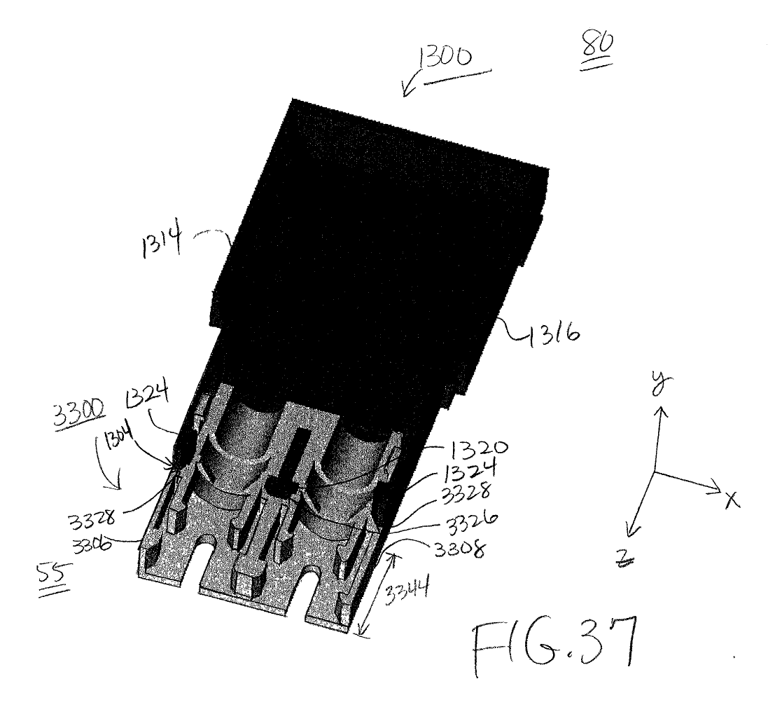

The bottom portion 3300 of the harness 55 also comprises an opening 3326 which traverses from the top face 3310 to the bottom face 3312, indentions 3328 at the first 3306 and second 3308 side faces, and posts 3342 coupled to the bottom face 3312. The functions of the opening 3326, indentions 3328, and posts 3342 will be further described below with FIG. 37.

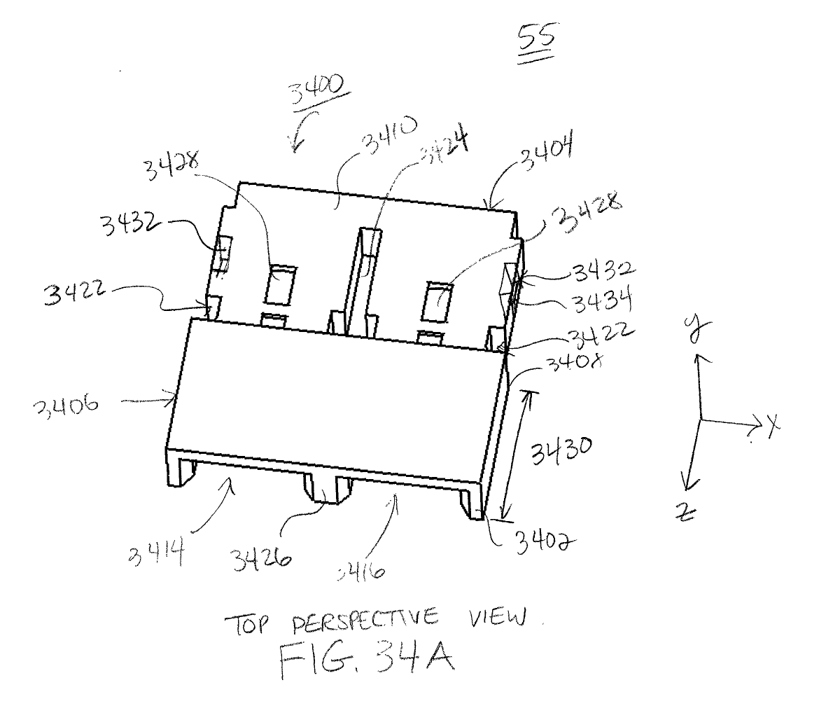

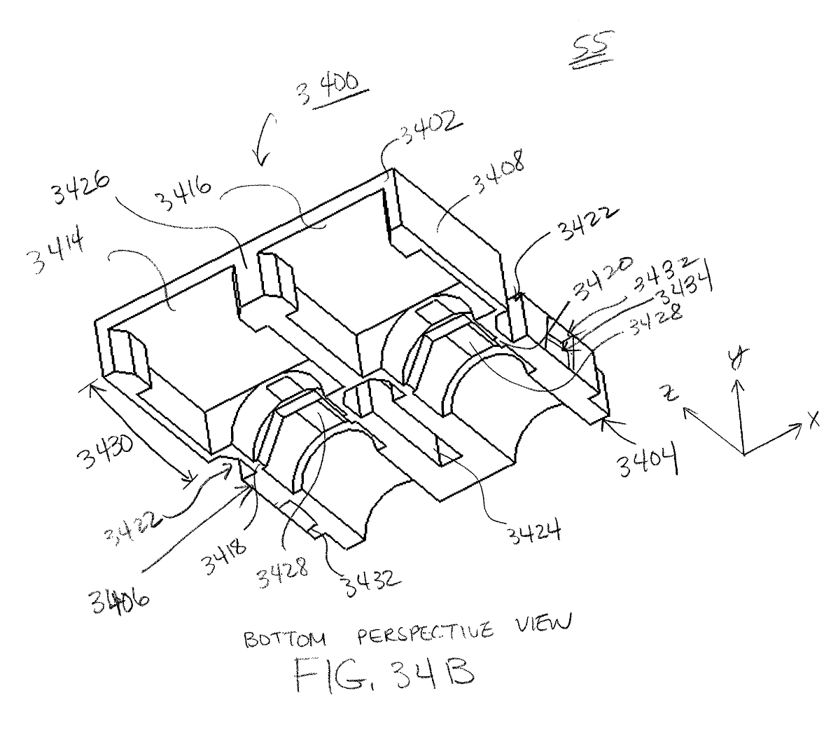

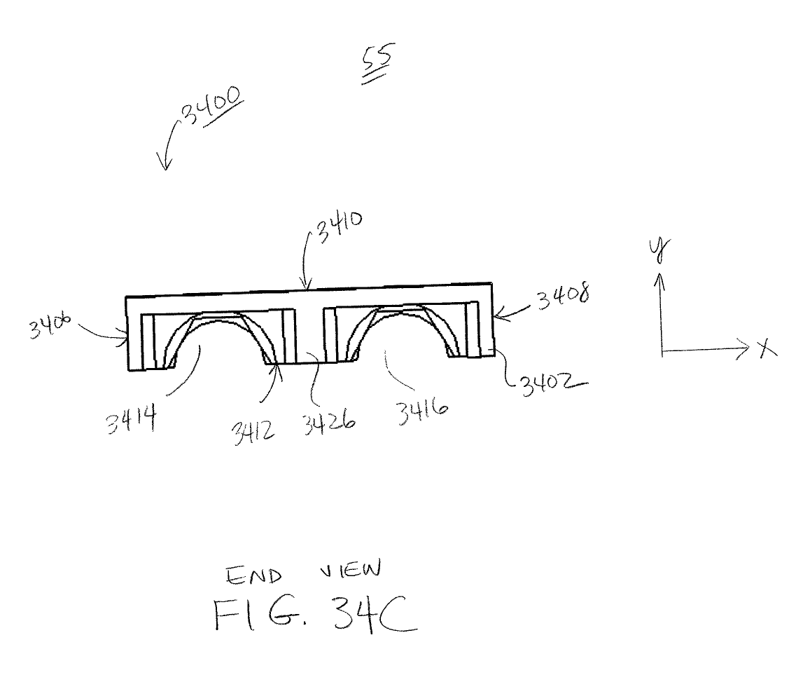

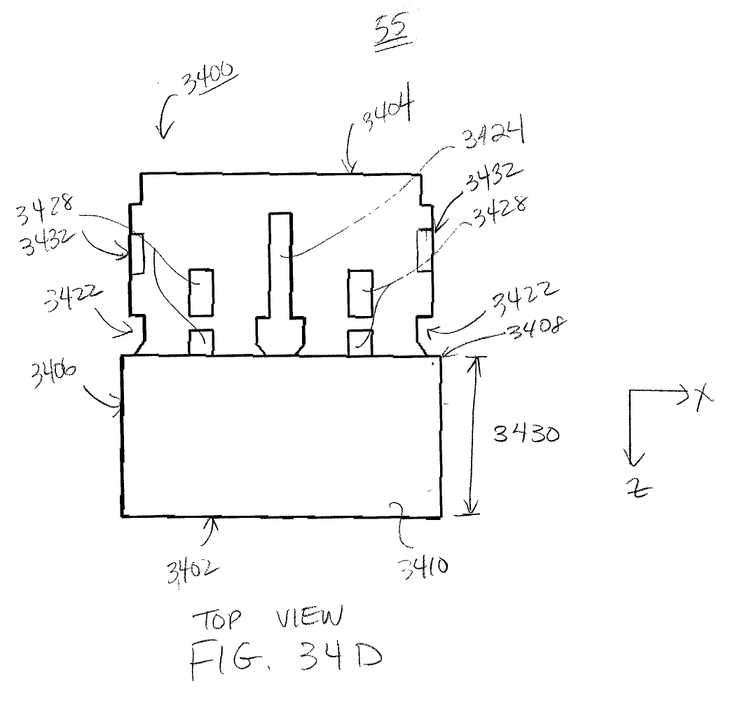

The bottom portion 3300 further comprises snaps 3334 coupled to the first 3306 and second 3308 side faces, protruding in the y-direction. Each snap 3334 comprises a lip 3336. The snaps 3334 and lips 3336 assist in coupling the bottom portion 3300 to the top portion 3400 (FIGS. 34A-34D) in a similar manner as the snaps 122 and lips 124 of the first embodiment of the harness 10 (FIGS. 1A-1I).

The bottom portion 3300 further comprises a post 3338 coupled to the top face 3310. The bottom portion 3300 further comprises openings 3340 which traverses from the top face 3310 to the bottom face 3312 and which is proximate to the first end face 3302. The post 3338 and openings 3340 assist in connecting the assembled device to a larger system. This connection utilizing the post 3338 and the openings 3340 is known in the art and will not be further described here.

FIGS. 34A-34D illustrate a top perspective view, bottom perspective view, end view, and top view, respectively, of the top portion 3400 of the sixth embodiment of the harness 55 in accordance with the present invention. The top portion 3400 comprises a block of material with a first end face 3402, a second end face 3404, a first side face 3406, a second side face 3408, a top face 3410, and bottom face 3412. At the bottom face 3412 are a first feature 3414 for the first optical subassembly (not shown), such as a ROSA, and a second feature 3416 for the second optical subassembly (not shown), such as a TOSA. In the sixth embodiment, the features 3314 and 3316 are cavities in which the first and second subassemblies may reside. The cavities 3314 and 3316 traverse the bottom face 3412 from the first end face 3302 to the second end face 3404. The features of the cavities 3414 and 3416 can mirror the features of the bodies of the particular ROSA and TOSA to be used. For example, ridges 3418 in the first cavity 3414 and ridges 3420 in the second cavity 3416 may mirror the ridges of the bodies of the ROSA and TOSA. Similar to the bottom portion 3300, the top portion 3400 also comprises an extension 3430 to accommodate a longer TOSA.

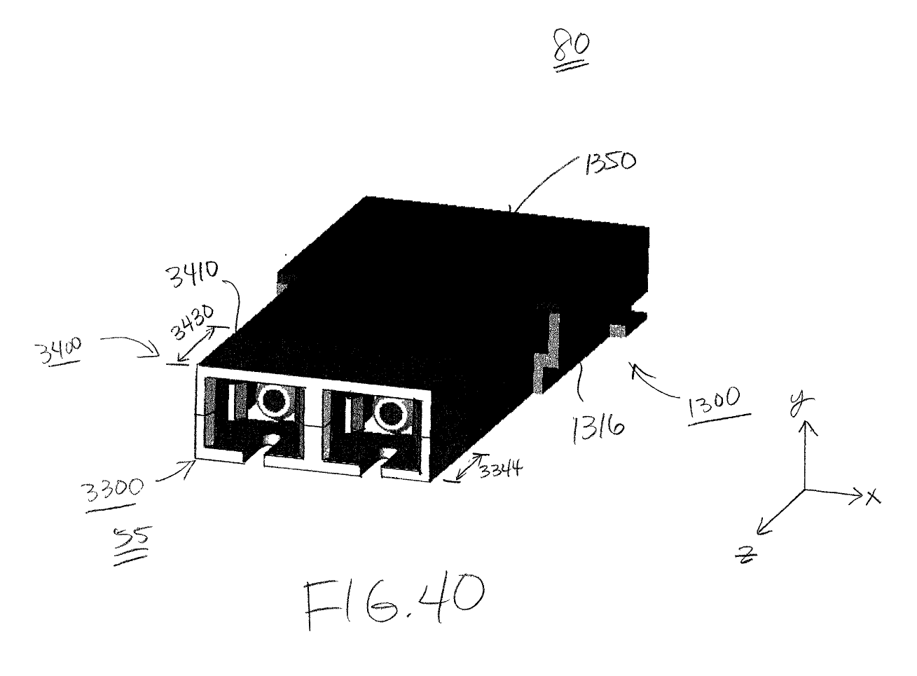

The top portion 3400 further comprises indentions 3422 at the first 3406 and second 3422 side faces, and an opening 3424 proximate to the second end face 3424 and which traverses the top face 3410 and bottom face 3412. The functions of the indentions 3422 and opening 3424 will be further described below with FIG. 39.

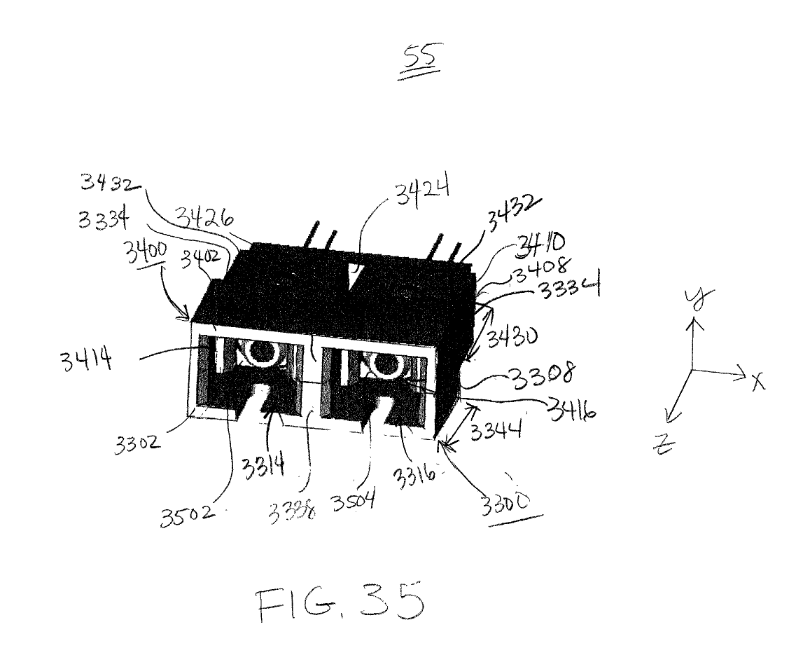

The top portion 3400 further comprises openings 3432 at the first 3406 and second 3422 side faces. Each opening 3432 comprises a ridge 3434. The snaps 3334 of the bottom portion 3300 may reside within the openings 3432, with the lips 3336 of the snaps 3334 engaging the ridges 3434, as further described with FIG. 35.

The top portion 3400 further comprises a post 3426 coupled to the bottom face 3412 at the extension 3430. The post 3426 assists in connecting the assembled device to a larger system in a similar manner as the post 3338 of the bottom portion 3300. This connection utilizing the post 3326 is known in the art and will not be further described here.

The top portion 3400 further comprises openings 3428 in the first 3414 and second 3416 cavities which traverse from the top face 3410 to the bottom face 3412. The openings 3428 assist in heat dissipation of the ROSA and TOSA. The openings 3428 may be in other locations in the top portion 3400 without departing from the spirit and scope of the present invention.

FIG. 35 illustrates a top perspective view of a combination of the bottom portion 3300 and top portion 3400 of the sixth embodiment of the harness 55, with a ROSA and TOSA, in accordance with the present invention. The bottom 3300 and top 3400 portions are coupled such that the top face 3310 (hidden) of the bottom portion 3300 abuts the bottom face 3412 (hidden) of the top portion 3400. The first end face 3302 of the bottom portion 3300 is proximate to the first end face 3402 of the top portion 3400. The snaps 3334 of the bottom portion 3300 reside within the openings 3432 of the top portion with the lips 3336 (hidden) of the snaps 3334 engaging the ridges 3434 (hidden). This couples the bottom portion 3300 and the top portion 3400 together. When coupled in this manner, the ROSA 3502 resides within the first cavity 3314 of the bottom portion 3300 and the first cavity 3414 of the top portion 3400, and the TOSA 3504 resides within the second cavity 3316 of the bottom portion 3300 and the second cavity 3416 of the top portion 3400. The location of the opening 3332 (hidden) of the bottom portion 3300 (hidden) approximately corresponds to the location of the opening 3424 of the top portion 3400. The location of the post 3338 of the bottom portion 3300 approximately corresponds to the location of the post 3426 of the top portion 3400. In the sixth embodiment, the length of the extension 3344 of the bottom portion 3300 is approximately the same as the extension 3430 of the top portion 3400.

When engaged in the above manner, the harness 55 constrains the ROSA 3502 and TOSA 3504 from translating in the x- and z-axes and from rotating from the x- and y-axes. The engagement also applies pressure in the y-direction to constrain the ROSA 3502 and TOSA 3504 from translating along the y-axis and from rotating about the z-axis. The ROSA 3502 and TOSA 3504 are thus constrained within the harness 55 in the six possible degrees of freedom.

Although the sixth embodiment is described with the above manner of constraining the ROSA 3502 and TOSA 3504, other methods of constraint may be used without departing from the spirit and scope of the present invention. For example, epoxy may be used to constrain the ROSA 3502 and TOSA 3504 within the harness 55.

As with the previous embodiments, the sixth embodiment of the harness 55 is comprised of a molded plastic, with the advantages as discussed above. Other materials may be used as well without departing from the spirit and scope of the present invention.

As with the previous embodiment, the bottom portion 3300 of the sixth embodiment of the harness 55 may comprise multiple pieces. For example, the bottom portion 3300 can be two pieces, with a first piece comprising the cavity 3314 for the ROSA 3502 and a second piece comprising the cavity 3316 for the TOSA 3504. By providing the bottom portion 3300 in this manner, the ROSA 3502 and TOSA 3504 may be replaced or upgraded independently. Other ways of providing the harness 55 as multiple pieces may be used without departing from the spirit and scope of the present invention.

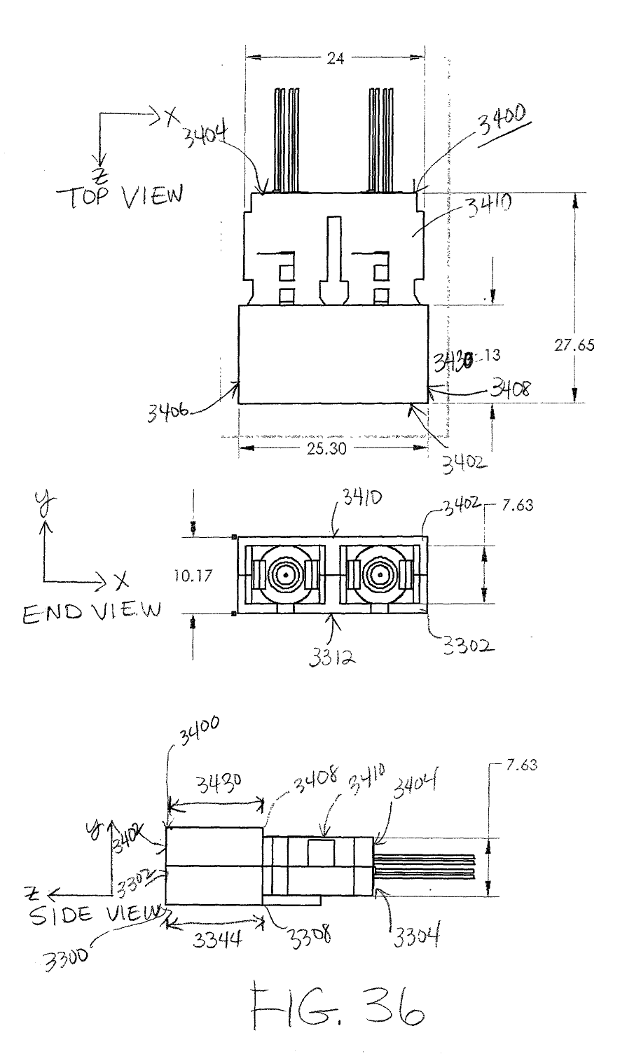

FIG. 36 illustrates a top view, end view, and side view of the combination of the bottom portion 3300 and top portion 3400 of the sixth embodiment of the harness 55, with approximate dimensions, in accordance with the present invention. In the sixth embodiment, the width of the first end face 3302 of the bottom portion 3300 and the first end face 3402 of the top portion 3400 are approximately 25.30 mm. The width of the second end face 3304 (hidden) of the bottom portion 3300 and the second end face 3404 of the top portion 3400 are approximately 24 mm. The length of the first side face 3306 (hidden) of the bottom portion 3300, the first side face 3406 of the top portion 3400, the second side face 3308 of the bottom portion 3300, and the second slide face 3408 of the top portion 3400 are approximately 27.65 mm. The length of the extension 3344 of the bottom portion 3300 and the extension 3430 of the top portion 3400 are approximately 13 mm. The height of the harness from the top face 3410 of the top portion 3400 proximate to the second end face 3404 to the bottom face 3312 of the bottom portion 3300 proximate to the second end face 3304 is approximately 7.63 mm. The dimensions above are approximate. Other dimensions may be used without departing from the spirit and scope of the present invention.

FIG. 37 illustrates a top perspective view of a combination of the bottom portion 3300 of the sixth embodiment of the harness 55 with a bottom portion 1300 of the third embodiment of the housing 80 in accordance with the present invention. The third embodiment of the housing 80 is described in detail above with FIGS. 13-16 and will not be repeated here. The bottom portion 3300 of the harness 55 resides within the bottom portion 1300 of the housing 80 so that the first 3306 and second 3308 side faces of the bottom portion 3300 of the harness 55 abut against the first 1314 and second 1316 side walls of the bottom portion 1300 of the housing 80, respectively. The protrusions 1324 of the bottom portion 1300 resides within the indentions 3328 of the bottom portion 3300, and the post 1320 of the bottom portion 1300 of the housing 80 resides within the opening 3326 of the bottom portion 3300 of the harness 55. The extension 3344 of the bottom portion 3300 of the harness 55 protrudes out of the first end 1304 of the bottom portion 1300 of the housing 80. The posts 3342 (hidden) on the bottom face 3312 of the bottom portion 3300 of the harness 55 reside within the openings 1322 (hidden) of the bottom portion 1300 of the housing 80.

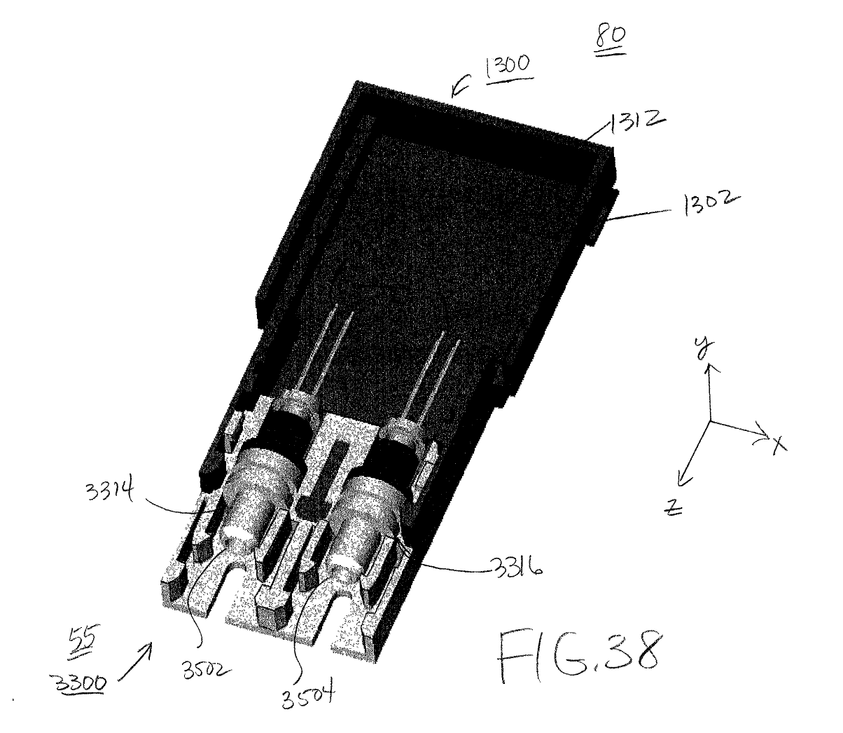

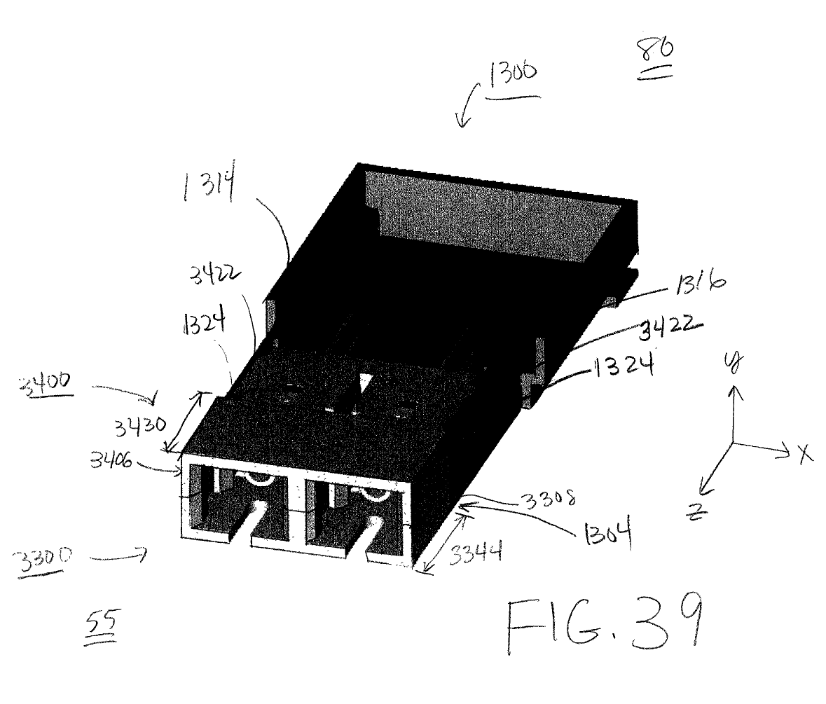

FIG. 38 illustrates a top perspective view of the combination of the bottom portion 3300 of the sixth embodiment of the harness 55, the bottom portion 1300 of the third embodiment of the housing 80, the ROSA 3502, and the TOSA 3504, in accordance with the present invention. While the bottom portion 3300 of the harness 55 resides within the bottom portion 1300 of the housing 80, the ROSA 3502 may reside within the first cavity 3314, and the TOSA 3504 may reside within the second cavity 3316.

In the sixth embodiment, a circuit board (not shown) would reside within the remaining portion of the top face 1312 of the bottom plate 1302. Connections 3506, such as pins, from the ROSA 3502 and TOSA 3504 can be coupled to the circuit board, either by solder or some other coupling means.

FIG. 39 illustrates a top perspective view of a combination of the sixth embodiment of the harness 55, the bottom portion 1300 of the third embodiment of the housing 80, the ROSA 3502, and TOSA 3504 in accordance with the present invention. The top portion 3400 of the harness 55 is placed over the bottom portion 3300 of the harness 55, the ROSA 3502, and the TOSA 3504, as described above with FIG. 35. Preferably, the first 3406 and second 3408 side faces abut the first 1314 and second 1316 side walls of the bottom portion of the housing 80, respectively. The protrusions 1324 reside within the indentions 3422 of the top portion 3400 of the harness 55. As with the extension 3344 of the bottom portion 3300, the extension 3430 of the top portion 3400 of the harness 55 protrudes from the first end 1304 of the bottom portion 1300 of the housing 80.

FIG. 40 illustrates a top perspective view of the third embodiment of the optical assembly housing 80 retrofitted with the sixth embodiment of the harness 55 in accordance with the present invention. The top plate 1350 of the housing 80 is placed such that the bottom face 1354 (hidden) abuts the first side wall 1314 (hidden) and the second side wall 1316 of the bottom portion 1300 of the housing 80, and abuts the top face 3410 of the top portion 3400 of the harness 55. Preferably, the top plate 1350 extends so that it abuts the entire length of the first 1314 and second 1316 side walls, with the extensions 3344 and 3430 of the harness 55 protruding from the housing 80. The top plate 1350 is fastened to the housing 80 through some type of fastening mechanism, such as epoxy. When fastened, pressure is applied in the y-direction to the top portion 3400 toward the bottom portion 3300 of the harness 55.

When residing within the bottom portion 1300 of the housing 80, the harness 55 is constrained from translating along the x- and z-axes and from rotating about the x-, y-, and z-axes. The pressure from the fastening of the top plate 1350 to the bottom portion 1300 constrains the harness 55 from translating along the y-axis. The harness 55 is thus constrained in the possible six degrees of freedom when residing within the housing 80.

Although the sixth embodiment is described with the above manner of constraining the harness 55, other methods of constraint may be used without departing from the spirit and scope of the present invention. For example, epoxy may be used to constrain the harness 55 within the housing 80.

The first through sixth embodiments of the harness 10-55 are described above as comprising a top and bottom portion. By providing the harness as two portions, particular features of the harness may be changed by changing either the top or the bottom portions, without needing to change the other. This reduces the cost of changing the harness.

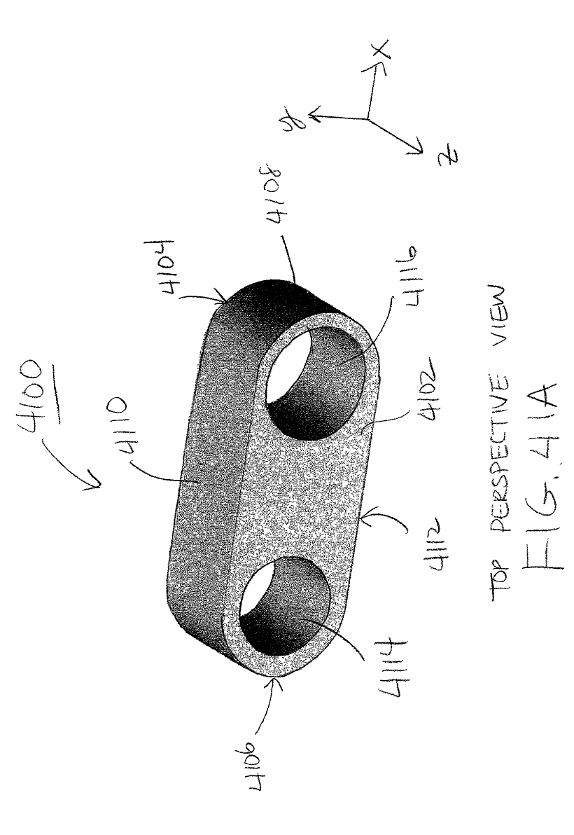

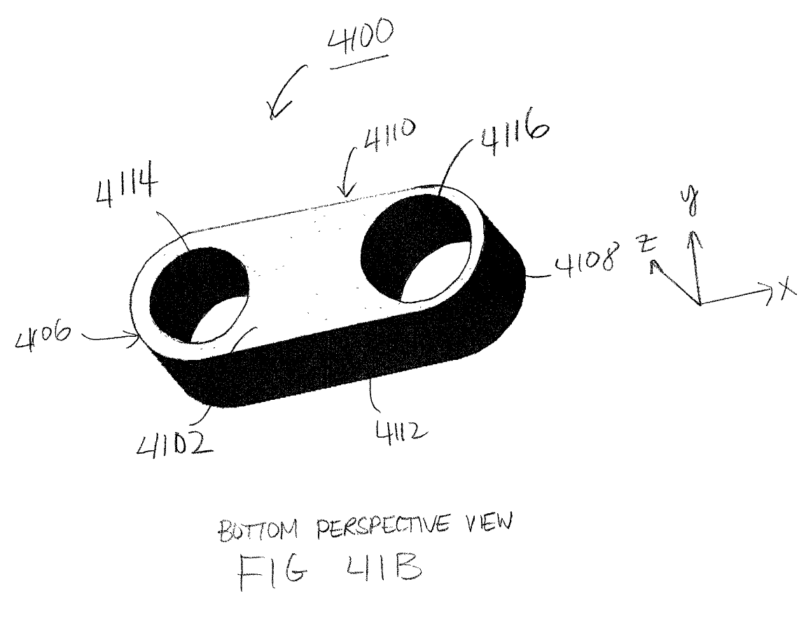

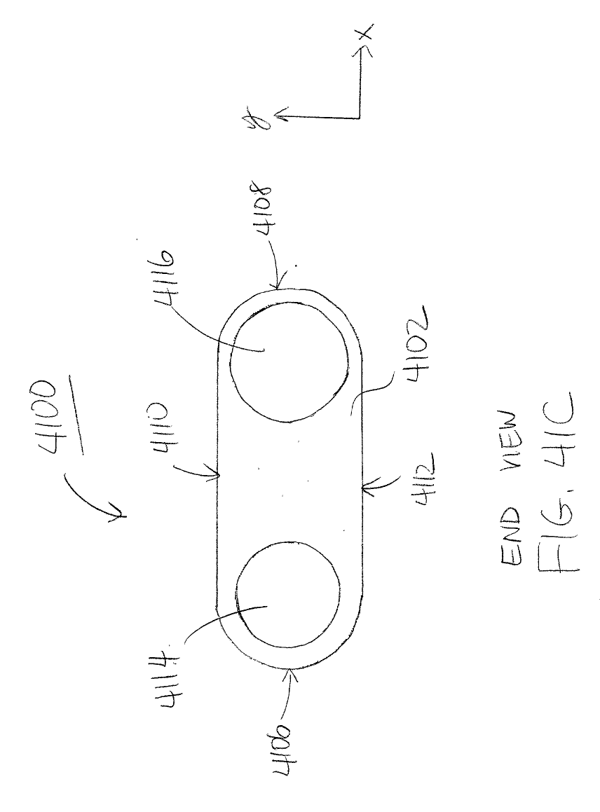

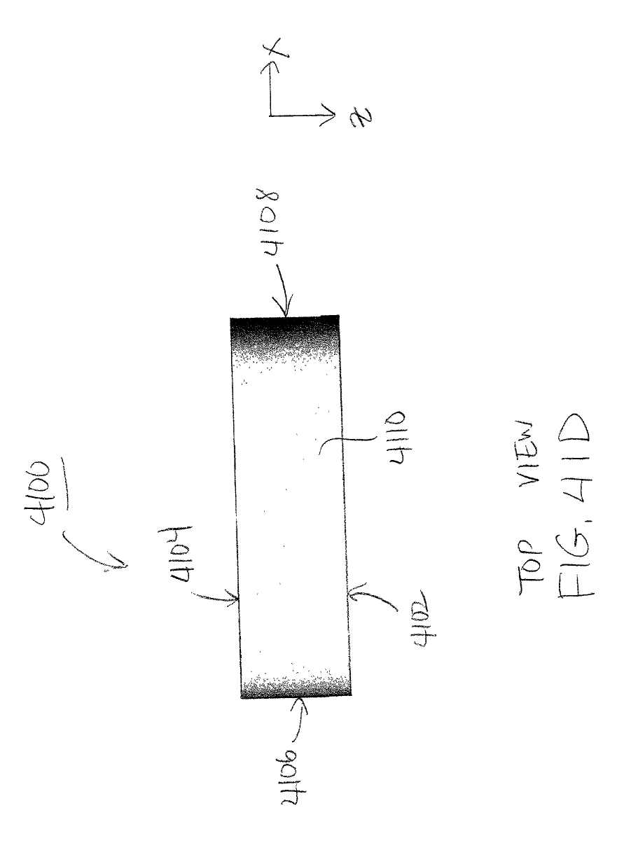

FIGS. 41A-44 illustrate a seventh embodiment of a harness for retrofitting an optical assembly housing in accordance with the present invention. The seventh embodiment of the harness 4100 may be used to retrofit a fifth embodiment of the optical assembly housing 4300.

FIGS. 41A-41D illustrate a top perspective view, bottom perspective view, end view, and top view, respectively, of the seventh embodiment of the harness in accordance with the present invention. The seventh embodiment of the harness 4100 comprises a block of material with a first end face 4102, a second end face 4104, a first curved side face 4106, a second curved side face 4108, a top face 4110, and the bottom face 4112. Traversing through the harness 4100 from the first end face 4102 to the second end face 4104 are a first feature 4114 and a second feature 4116. In the seventh embodiment, the first feature 4114 is cavities in which a ROSA and TOSA may reside, respectively.

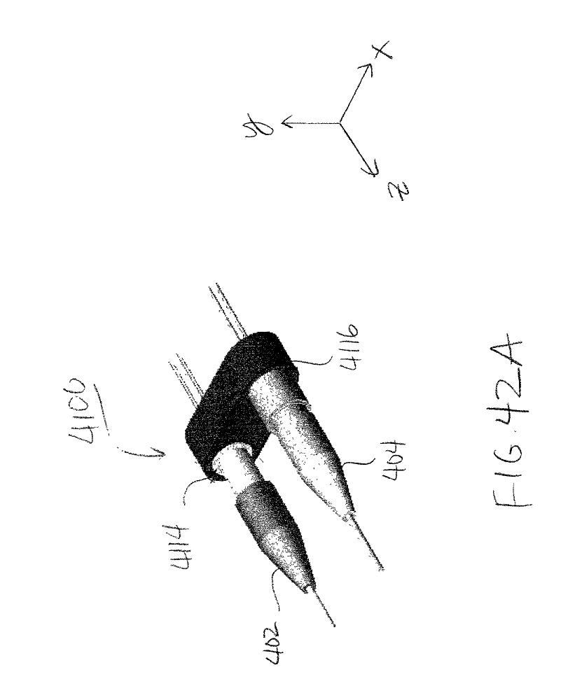

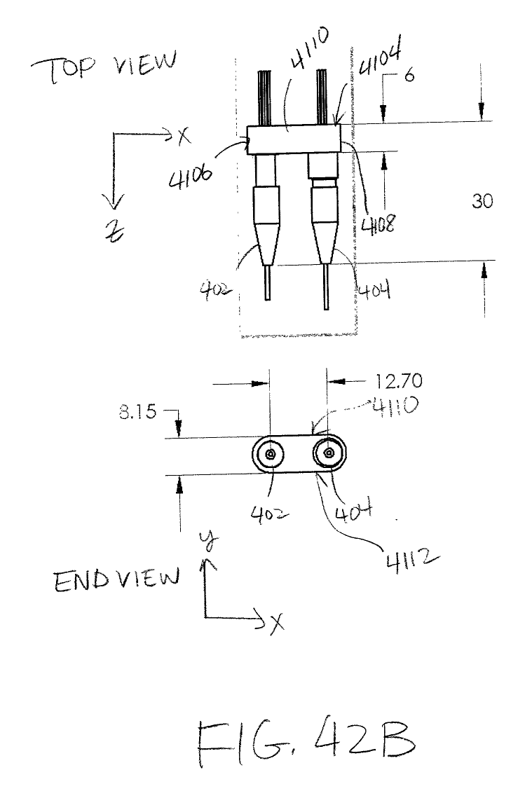

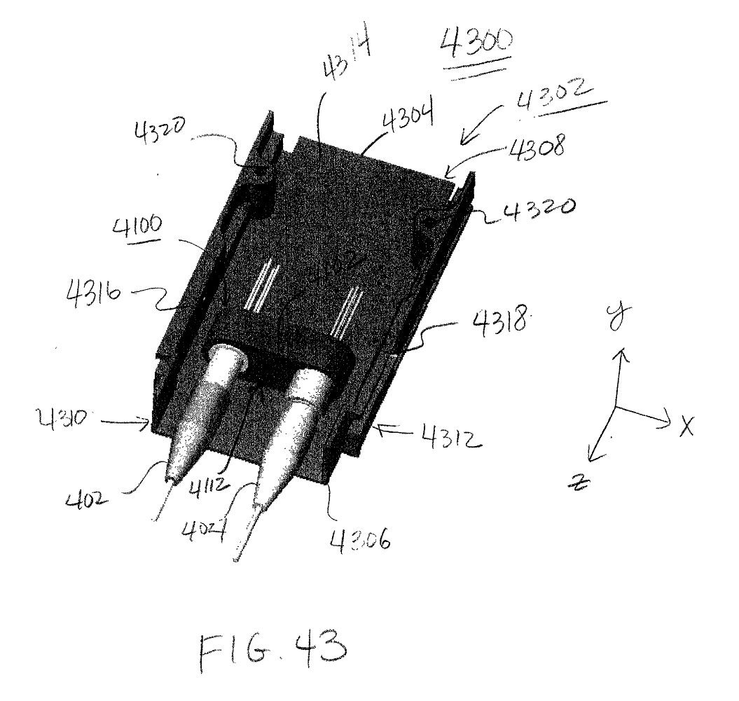

FIG. 42A illustrates a top perspective view of the seventh embodiment of the harness 4100 with a ROSA a TOSA. The ROSA 402 resides within the first cavity 4114, and the TOSA 404 resides within the second cavity 4116. In the seventh embodiment, the sizes of the cavities 4114 and 4116 are slightly smaller than the size of the bodies of the ROSA 402 and TOSA 404, respectively. Through interference, when residing within the cavities 4114 and 4416, the ROSA 402 and TOSA 404 are constrained from translating in the x-, y-, and z-axes and from rotating about the x-, y-, and z-axes. The ROSA 402 and TOSA 404 are thus constrained within the harness 4100 in the six possible degrees of freedom.

Although the seventh embodiment is described with the above manner of constraining the ROSA 402 and TOSA 404, other methods of constraint may be used without departing from the spirit and scope of the present invention. For example, epoxy may be used to constrain the ROSA 402 and/or TOSA 404 within the harness 4100.

FIG. 42B illustrates a top view and an end view of the seventh embodiment of the harness 4100 with the ROSA 402 and TOSA 404, with approximately dimensions, in accordance with the present invention. The width between the optical axes of the ROSA 402 and the TOSA 404 is approximately 12.70 mm. The lengths of the first 4106 and second 4108 curved side faces are approximately 6 mm. The length from the end of the ROSA 402 or TOSA 404 to the second end face 4104 is approximately 30 mm. The height of the harness 4100 from the top face 4110 to the bottom face 4112 is approximately 8.15 mm. The dimensions above are approximate. Other dimensions may be used without departing from the spirit and scope of the present invention.

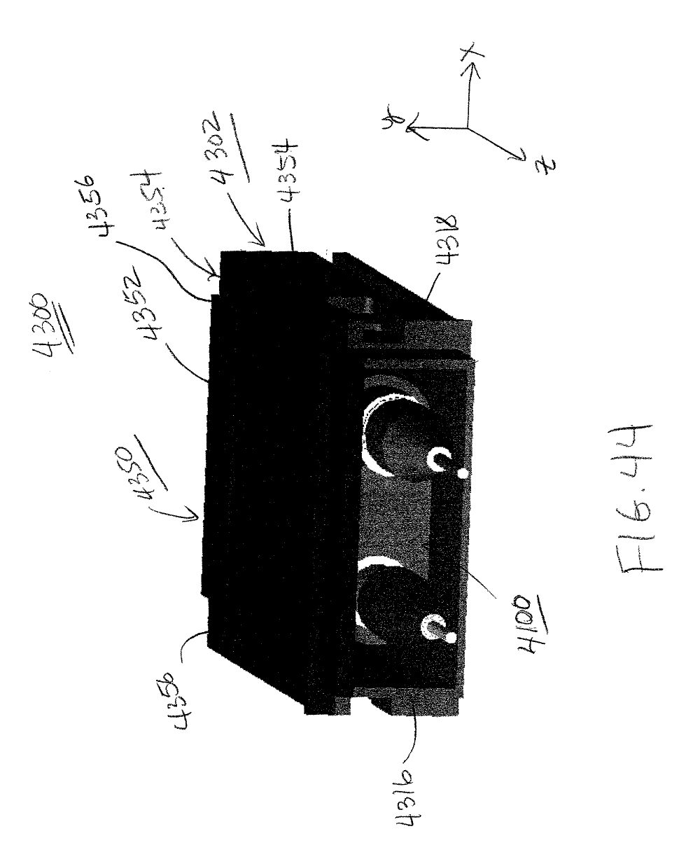

The fifth embodiment of the housing 4300 comprises a bottom portion and a top portion. FIG. 43 illustrates a top perspective view of a combination of the seventh embodiment of the harness 4100, a bottom portion 4302 of the fifth embodiment of the housing 4300, the ROSA 402, and the TOSA 404, in accordance with the present invention. The bottom portion 4302 of the housing 4300 comprises a bottom plate 4304 with a first end 4306, a second end 4308, a first side 4310, a second side 4312, and a top face 4314. Coupled to the first side 4310 and traversing from the first end 4306 to the second end 4308 is a first side wall 4316. Coupled to the second side 4312 and traversing from the first end 4306 to the second end 4308 is a second side wall 4318.

The harness 4100 resides within the bottom portion 4302 of the housing 4300 such that the bottom face 4112 (hidden) of the harness 4100 abuts the top face 4314 of the bottom plate 4304. The harness 4100 resides within the bottom portion 4302 such that the first end face 4102 is proximate to the first end 4306 of the bottom portion 4302 of the housing 4300. In the seventh embodiment, the other faces of the harness 4100 need not abut against any other face or wall of the bottom portion 4302 of the housing 4300.

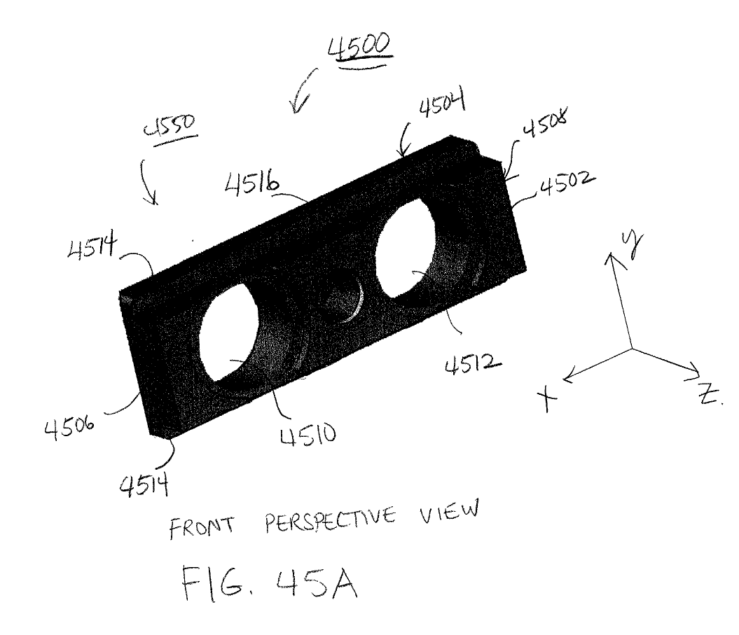

FIG. 44 illustrates a top perspective view of the fifth embodiment of the housing 4300 retrofitted with the seventh embodiment of the harness 4100 in accordance with the present invention. The housing 4300 comprises a top late 4350 with a top face 4352 and a bottom face 4354 (hidden). The top plate 4350 is placed such that the bottom face 4354 (hidden) abuts the first side wall 4316 and the second side wall 4318 of the bottom portion 4302 of the housing 4300, and abuts the top face 4110 (hidden) of the harness 4100. Preferably, the top plate 4350 extends so that it abuts the entire length of the side walls 4316 and 4318. The top plate 4300 is fastened to the bottom portion 4302 of the housing 4300 through some type of fastening mechanism, such as epoxy. When fastened, pressure in the y-direction is applied to the harness 4100 such that interference is created in the x- and z-directions. While residing in the housing 4300, the harness 4100 is constrained from translating along the x-, y-, and z-axes and from rotating about the x-, y-, and z-axes. The harness 4100 is thus constrained in the possible six degrees of freedom while within the housing 4300.

In the fifth embodiment, the bottom portion 4302 of the housing 4300 may also comprise holes 4320 (see FIG. 43) at the first side wall 4316 and the second side wall 4318. Additional holes 4356 may then be placed in the top plate 4350 of the housing 4300 (see FIG. 44), whose locations approximately match the locations of the holes 4320 in the side walls 4316 and 4318. Screws, or some other attachment mechanism, may then be inserted through the holes 4356 and attached to the bottom portion 4302 of the housing 4300. The screws may be used instead of or in addition to the fastening mechanism described above.

Although the seventh embodiment is described with the above manner of constraining the harness 4100, other methods of constraint may be used without departing from the spirit and scope of the present invention. For example, epoxy may be used to constrain the harness 4100 within the housing 4300.

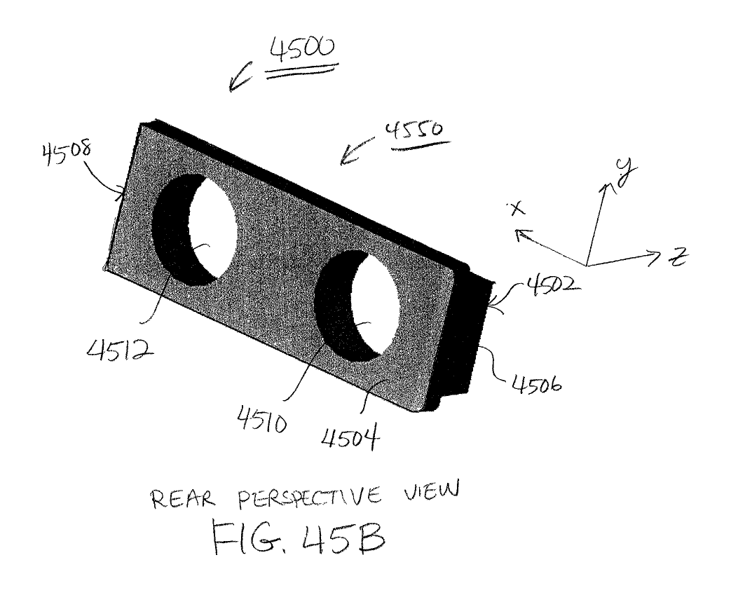

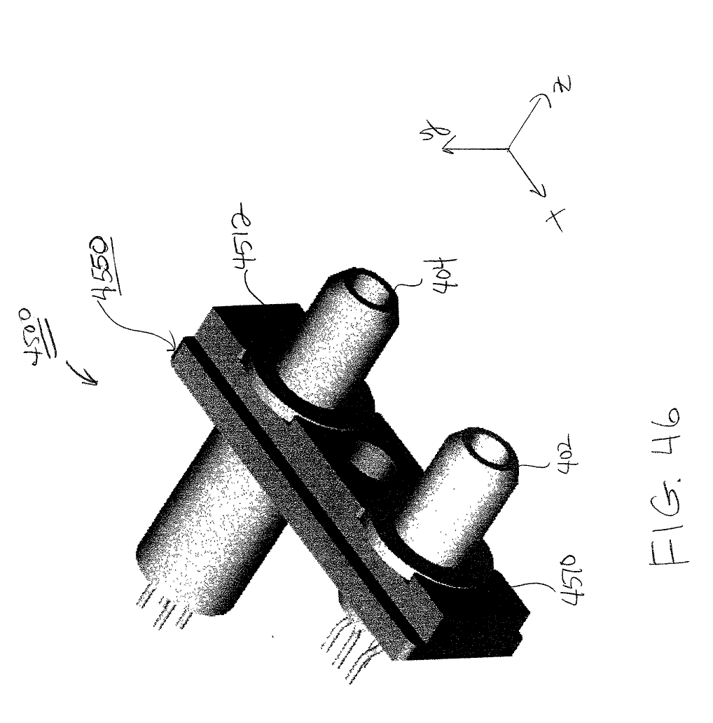

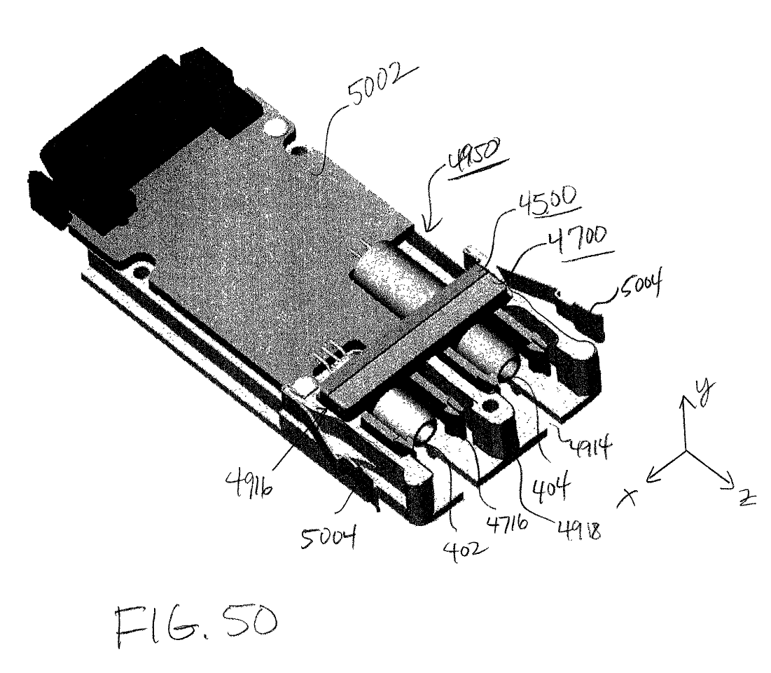

FIGS. 45A-51 illustrate an eighth embodiment of a harness for retrofitting an optical assembly housing in accordance with the present invention. The eighth embodiment of the harness 4500 comprises a back plate 4550 and a front plate 4700. The harness 4500 can be used to retrofit a sixth embodiment of an optical assembly housing 4900, illustrated in FIGS. 49-51.

FIGS. 45A-45B illustrate front and rear perspective views of a back plate of the eighth embodiment of a harness 4500 for retrofitting an optical assembly housing in accordance with the present invention. The back plate 4550 of the harness 4500 comprises a block of material with a first end 4502, a second end 4504, a first side 4506, and a second side 4508. Traversing from the first end 4502 to the second end 4504 is a first feature 4510 for a ROSA and a second feature 4512 for a TOSA. In the eighth embodiment, the features 4510 and 4512 are cavities within which the subassemblies may reside, respectively.

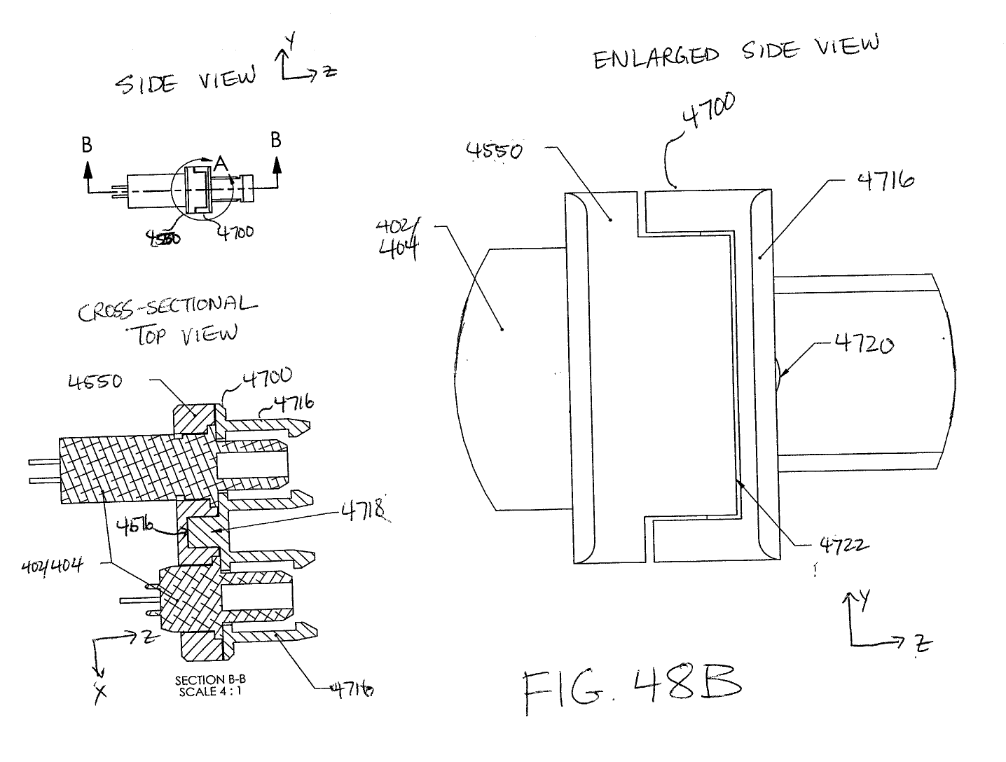

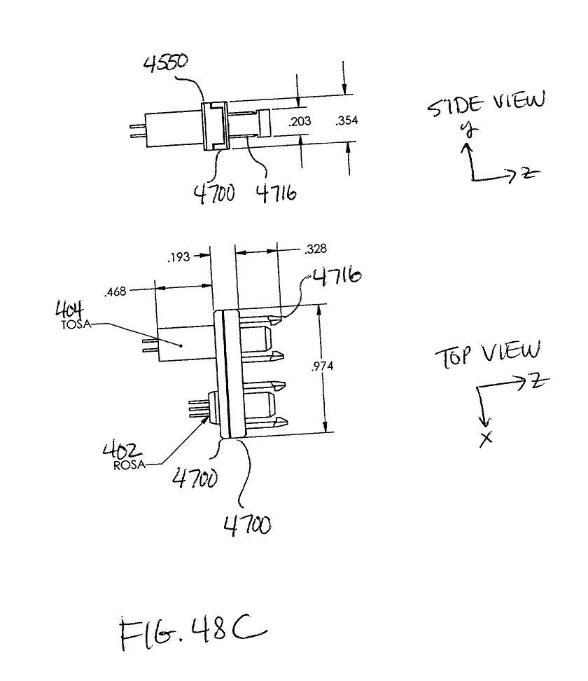

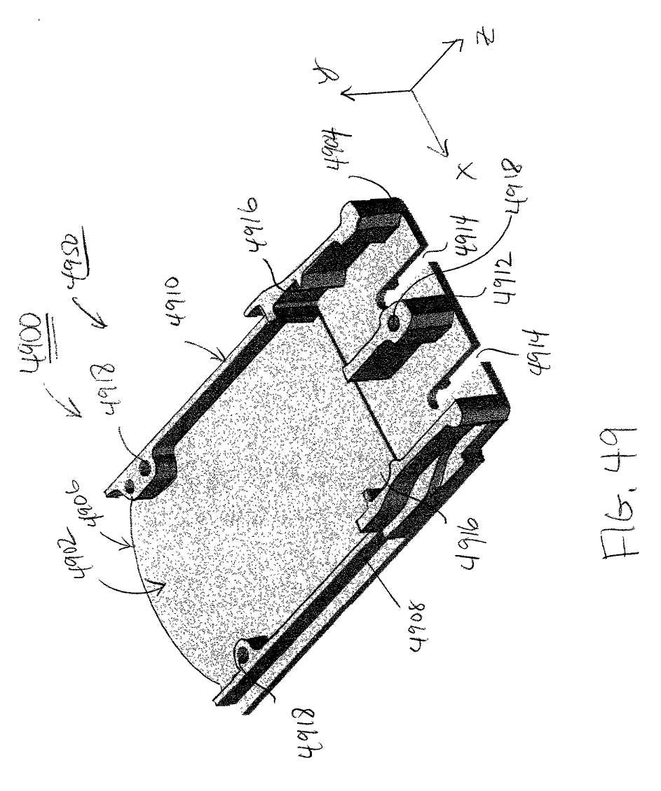

At the first end 4502, the back plate 4550 of the harness 4500 comprises an opening 4516. The first end 4502 also comprises ridges 4514 which traverse from the first side 4506 to the second side 4508. The functions of the opening 4516 and the ridges 4514 will be described below in conjunction with FIG. 48.

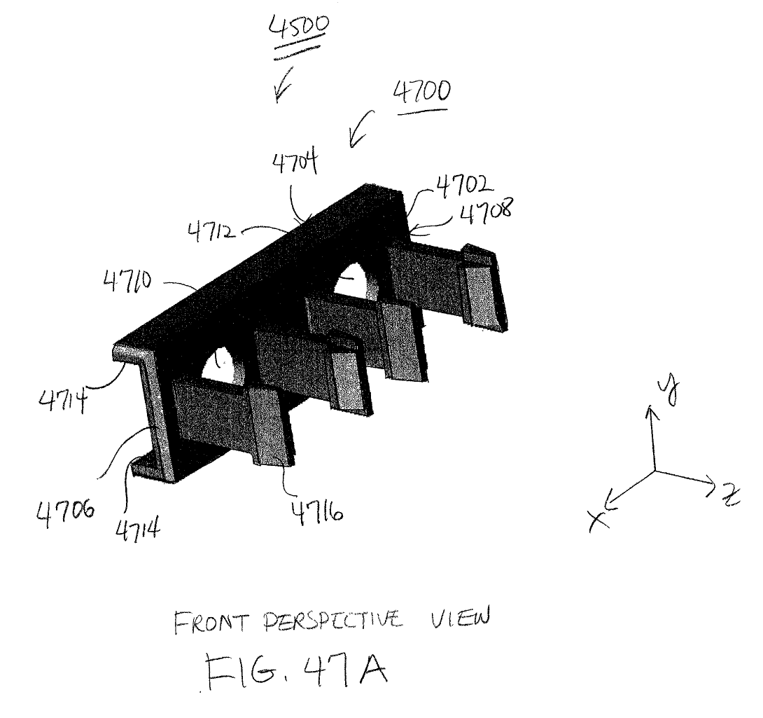

FIG. 46 illustrates a top perspective view of the back plate of the eighth embodiment of the harness with a ROSA and a TOSA in accordance with the present invention. The ROSA 402 resides within the first cavity 4510, and the TOSA 404 resides within the second cavity 4512. In the eighth embodiment, the sizes of the cavities 4510 and 4512 are slightly smaller than the size of the bodies of the ROSA 402 and TOSA 404, respectively.

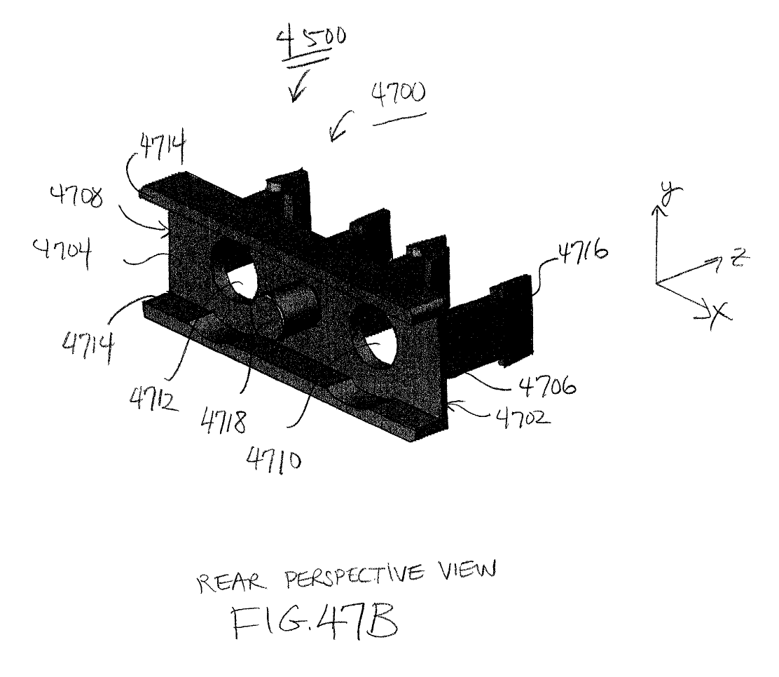

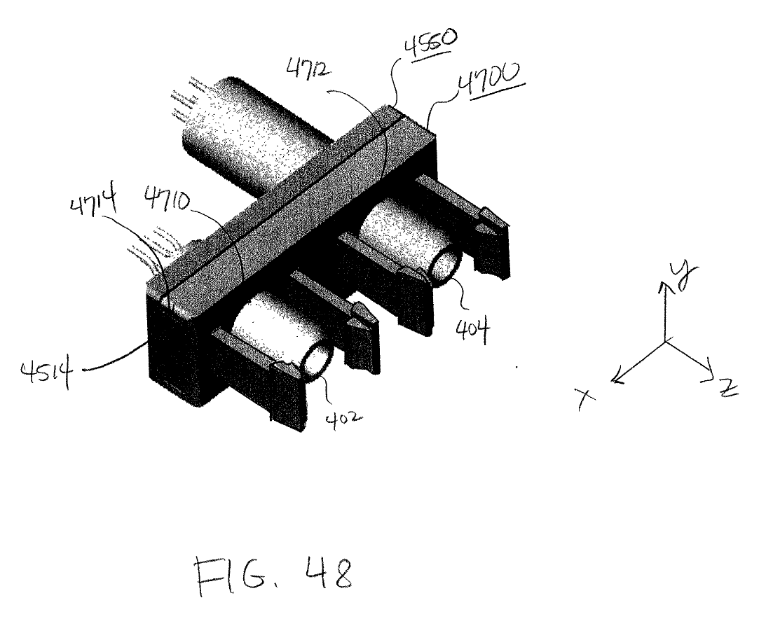

FIGS. 47A-47B illustrate front and rear perspective views of a front plate of the eighth embodiment of the harness for retrofitting an optical assembly housing in accordance with the present invention. The front plate 4700 of the harness 4500 comprises a block of material with a first end 4702, a second end 4704, a first side 4706, and a second side 4708. Traversing from the first end 4702 to the second end 4704 is a first feature 4710 for the ROSA 402 and a second feature 4712 for the TOSA 404. In the eighth embodiment, the features 4710 and 4712 are cavities within which the subassemblies may reside, respectively.

At the first end 4702, the front plate 4700 of the harness 4500 comprises clips 4716. The function of the clips 4716 will be described below with FIG. 50. The first end 4702 also comprises lips 4714 which traverse from the first side 4706 to the second side 4708. At the second end 4704, the front plate 4700 of the harness 4500 comprises a post 4718. The functions of the lips 4714 and the post 4718 will be described below in conjunction with FIG. 48.

FIGS. 48A-48B illustrate a top perspective view, side view, cross-sectional top view, and enlarged side view of the back plate 4550 and the front plate 4700 of the eighth embodiment of the harness 4500, with the ROSA 402 and TOSA 404, in accordance with the present invention. The back 4550 and front 4700 plates are coupled through interference such that the lips 4714 of the front plate 4700 engages the ridges 4514 of the back plate 4550. The post 4718 (hidden) of the front plate 4700 resides within the opening 4516 (hidden) of the back plate 4550. A bump 4720 on the first end 4702 of the front plate 4700 causes compression of the assembly when installed into a housing. A gap 4722 between the front 4700 and back 4550 plates allows the front plate 4700 to compress the TOSA 404 and ROSA 402 against the back plate 4550. When coupled in this manner, the ROSA 402 resides within the first cavities 4510 (hidden) and 4710 of the back 4550 and front 4700 plates, respectively. The TOSA 404 resides within the second cavities 4512 (hidden) and 4512 of the back 4550 and front 4700 plates, respectively. When residing with the cavities 4510, 4512, 4710, and 4712 in this manner, the ROSA 402 and TOSA 404 are constrained from translating in the x-, y-, and z-axes and from rotating about the x-, y-, and z-axes. The ROSA 402 and TOSA 404 are thus constrained within the harness 4500 in the six possible degrees of freedom.

FIG. 48C illustrates a side view and top view of the eighth embodiment of the harness 4500, with approximate dimensions, in accordance with the present invention. The height of the front 4700 and back 4550 plate assembly, is approximately 0.354 mm. The height between two of the clips 4716 is approximately 0.203 mm. The length of the assembly is approximately 0.974 mm. The width of the assembly is approximately 0.193 mm, and the width of the clips 4716 is approximately 0.328 mm. The TOSA 404 extends from the assembly for approximately 0.468 mm. The dimensions above are approximate. Other dimensions may be used without departing from the spirit and scope of the present invention.

Although the eighth embodiment is described with the above manner of constraining the ROSA 402 and TOSA 404, other methods of constraint may be used without departing from the spirit and scope of the present invention. For example, epoxy may be used to constrain the ROSA 402 and TOSA 404 within the harness 4500.

The eighth embodiment of the harness 4500 is comprised of a molded plastic. The material of the back plate 4550 of the harness 4500 may be chosen to provide the desired EMI shielding characteristics. Because the back plate 4550 is a single piece, the harness 4500 provides improved EMI shielding over the two-piece embodiments described above. Other materials may be used as well without departing from the spirit and scope of the present invention. For example, the back plate 4550 may be composed of a metalized plastic, or of metal, which provides better EMI shielding than plastic. Alternatively, the material of the front plate 4700 may be chosen to provide the desired EMIs shielding characteristics instead.

FIG. 49 illustrates a top perspective view of a bottom portion 4950 of a sixth embodiment of the optical assembly housing 4900 which can be retrofitted by the eighth embodiment of the harness 4500 in accordance with the present invention. The bottom portion 4950 of the housing 4900 comprises a bottom plate 4902 with a first end 4904, a second end 4906, a first side wall 4908, and a second side wall 4910. Coupled to the bottom plate 4902 and proximate to the first end 4904, the first and second side walls 4908 comprise indentions 4916. Also coupled to the bottom plate 4902 and proximate to the first end 4904 is a post 4912 and indentions 4914. The functions of the indentions 4916 and 4914, and the function of the post 4912, are described further below with FIG. 50.

FIG. 50 illustrates a top perspective view of a combination of the eighth embodiment of the harness 4500, the bottom portion 4950 of the sixth embodiment of the housing 4900, a ROSA, and a TOSA in accordance with the present invention. The harness 4500 resides within the indentions 4916, as illustrated. The ROSA 402 and TOSA 404 may be coupled to a printed circuit board 5002, which resides within the remainder of the bottom portion 4950. The clips 4716 of the harness 4500 and the post 4918 and indentions 4914 of the bottom portion 4950 of the housing 4900 allow the device to be coupled to a connector. Additional clips, such as clips 5004 coupled to the bottom portion 4950 of the housing 4900 also serve this function. The shape and size of the connectors are standardized in the industry and will not be further described here.

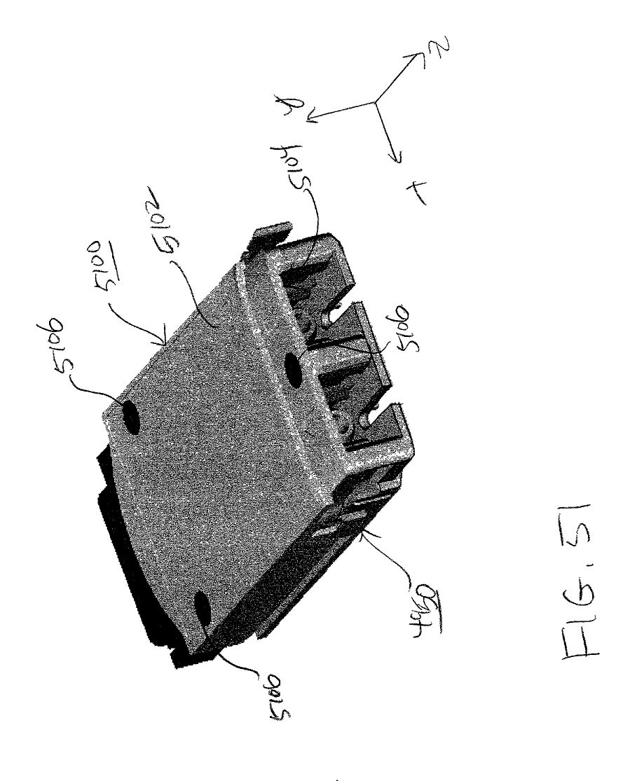

FIG. 51 illustrates a top perspective view of the sixth embodiment of the optical assembly housing 4900 retrofitted by the eighth embodiment of the harness 4500 in accordance with the present invention. The housing 4900 comprises a top plate 5100 with a top face 5102 and a bottom face 1504 (hidden). The top plate 5100 is placed such that the bottom face 5104 abuts the first 4908 and second 4910 side walls (hidden) of the bottom portion 4950 of the housing 4900, and abuts the harness 4500 as well. Preferably, the to plate 5100 is fastened to the housing 4900 through some type of fastening mechanism, such as epoxy. When fastened, pressure is applied to the harness 4500.

The bottom portion 4950 of the housing 4900 may also comprise holed 4918 (see FIG. 49) at the first 4908 and second 4910 side walls and at the post 4912. Additional holes 5106 may then be placed in the top plate 5100 of the housing 4900 (see FIG. 51), whose locations approximately match the locations of the holes 4918 in the side walls 4908 and 4910. Screws, or some other attachment mechanism, may then be inserted through the holes 5106 and attached to the bottom portion 4950 at the holes 4918. In this manner, the top plate 5100 is securely attached to the bottom portion 4950 of the housing 4900. The screws may be used instead of or in addition to the fastening mechanism described above.

When residing within the bottom portion 4950 of the housing 4900, the harness 4500 is constrained from translating along the x- and z-axes and rotating about the x-, y-, and z-axes. The pressure from the fastening of the top portion 5100 to the bottom portion 4950 constrains the harness 4500 from translating along the y-axis. The harness 4500 is thus constrained in the possible six degrees of freedom.

Although the sixth embodiment is described with the above manner of constraining the harness 4500, other methods of constraint may be used without departing from the spirit and scope of the present invention. For example, epoxy may be used to constrain the harness 4500 within the housing 4900.

Although the eighth embodiment of the harness 4500 is described above with a front 4700 and a back 4550 plate, the features of the front plate 4700 may be provided by the housing 4900 instead, such that the harness 4500 comprises a single piece, without departing from the spirit and scope of the present invention.

Although the embodiments of the harness in accordance with the present invention have been described above with a ROSA and a TOSA, other types of optical subassemblies may be used with the harness without departing from the spirit and scope of the present invention. For example, pigtailed lasers, may be used. The harness may also be used to hold other optical components, such as ferrules.

A harness for retrofitting optical subassemblies in an optical assembly housing has been disclosed. An embodiment of the present invention provides a harness which fits within an existing optical assembly housing. Each optical subassembly resides in a feature in the harness. The features of the harness constrain the optical subassemblies in the six possible degrees of freedom without requiring assistance from the housing. When residing with the housing, the harness is also constrained in the six possible degrees of freedom. When an optical subassembly is to be upgraded or replaced, a harness with different features may be used to facilitate the upgrade or replacement. In addition, the harness with different features may be used to change or add a characteristic of the assembled device without requiring significant changes to the optical assembly housing. The harness thus reduces the difficulties in adding or changing the assembly optical device, which may also reduce the costs of the addition or change.

For example, the harness may be used to retrofit a transceiver housing with a non-grating stabilized laser. The harness may be used to retrofit the housing for a grating stabilized laser. This grating stabilized laser can also be used with an uncooled N-channel hub. The harness would be longer than the non-grating stabilized laser and would receive at least a portion of the non-grating stabilized laser. The transceiver with the grating-stabilized laser and the uncooled N-channel hub is further described in co-pending provisional patent applications 60/276,639 and 60/276,636, filed on Mar. 16, 2001 and assigned to the assignee of the present application. These provisional patent applications are hereby incorporated by reference.

Although the present invention has been described in accordance with the embodiments shown, one of ordinary skill in the art will readily recognize that there could be variations to the embodiments and those variations would be within the spirit and scope of the present invention. Accordingly, many modifications may be made by one of ordinary skill in the art without departing from the spirit and scope of the appended claims.

What is claimed is:

1. A harness for securing a first optical subassembly in a housing, wherein the housing has been previously designed to hold a second optical subassembly having a form factor different than the first optical subassembly, the harness comprising:
a harness body;
the harness body having an external surface adapted to conform with at least one surface feature on an interior of the housing, wherein an interface between the harness body and the surface feature on the interior of the housing secures the harness body from moving within the housing; and
the harness body forming a cavity adapted to conform with at least one surface feature on the first optical subassembly, wherein the interface between the harness body and the surface feature on the first optical subassembly secures the first optical subassembly from moving within the harness.

2. The harness of claim 1, wherein the cavity comprises at least one ridge which approximately matches the at least one surface feature of the first optical subassembly.

3. The harness of claim 1, wherein the harness comprises a first portion and a second portion.

4. The harness of claim 3, wherein the harness comprises a mechanism for coupling the first portion to the second portion, wherein the mechanism comprises:
a first snap coupled to a first side face of the first portion, the first snap comprising a first lip;
a second snap coupled to a second side face of the first portion opposite to the first side face of the first portion, the second snap comprising a second lip;
a first opening at a first side face of the second portion, the first opening comprising a first ridge, wherein the first ridge is capable of engaging the first lip; and
a second opening at a second side face of the second portion, the second opening comprising a second ridge, wherein the second ridge is capable of engaging the second lip.

5. The harness of claim 3, wherein the first portion comprises a third opening traversing from a top face of the first portion to a bottom face of the first portion opposite to the top face of the first portion, wherein a post of the housing is capable of residing within the third opening.

6. The harness of claim 3, wherein the second portion comprises a fourth opening traversing from a top face of the second portion to a bottom face of the second portion opposite to the top face of the second portion, wherein a post of the housing is capable of residing within the fourth opening.

7. The harness of claim 3, further comprising a clip capable of engaging the first and second portions.

8. The harness of claim 7, wherein the clip comprises:
a first slanted surface coupled to a top face and a first side wall of the clip, wherein the first slanted surface is capable of abutting against a first slanted surface of the housing; and
a second slanted surface coupled to the top face and a second side wall of the clip opposite to the first side wall of the clip, wherein the second slanted surface is capable of abutting against a second slanted surface of the housing.

9. The harness of claim 8, wherein the clip further comprises:
a first protrusion coupled to a top face of the clip at a first end of the clip, wherein the first protrusion is capable of abutting against a first end face of the second portion;
a second protrusion coupled to the top face of the clip at a second end of the clip opposite to the first end of the clip, wherein the second protrusion is capable of abutting against a second end face of the second portion opposite to the first end face of the second portion;
a third protrusion coupled to a first side wall of the clip distal to the top face of the clip, wherein the third protrusion is capable of abutting against a bottom face of the first portion; and
a fourth protrusion coupled to a second side wall of the clip distal to the top face of the clip opposite to the first side face of the clip, wherein the fourth protrusion is capable of abutting against the bottom face of the first portion.

10. The harness of claim 8, wherein the clip further comprises at least one spring coupled to a top face of the clip.

11. The harness of claim 3, wherein the first portion further comprises a fifth opening at a second side face of the first portion proximate to the second feature, wherein a thermal electric cooler may reside within the fifth opening.

12. The harness of claim 11, wherein a thermal conductive material may further reside within the fifth opening.

13. The harness of claim 12, wherein a thermister may further reside within the fifth opening.

14. The harness of claim 3, further comprising:
a first extension coupled to a first end face of the first portion; and
a second extension coupled to a first end face of the second portion.

15. The harness of claim 14, wherein the first extension comprises at least one clip, the at least one clip comprising at least one lip, wherein the at least one lip is capable of engaging at least one connector.

16. The harness of claim 3, wherein the first portion comprises a front plate and the second portion comprises a back plate.

17. The harness of claim 16, wherein the front plate comprises at least one lip, wherein the back plate comprises at least one ridge, wherein the front plate is coupled to the back plate with an interference fit, wherein the at least one lip engages the at least one ridge.

18. The harness of claim 17, wherein the coupling of the front plate and the back plate provides electromagnetic interference shielding.

19. The harness of claim 17, wherein the coupling of the front plate and the back plate secures the first optical subassembly in place independent of the housing.

20. The harness of claim 3, wherein the coupling of the first and second portions form a first cavity and a second cavity, wherein a transmitting optical subassembly (TOSA) resides within the first cavity, wherein a receiving optical subassembly (ROSA) resides with the second cavity.

21. The harness of claim 20, wherein the first portion can be physically separated from the second portion.

22. The harness of claim 1, wherein the second optical subassembly comprises a non-grating stabilized laser, wherein the first optical subassembly comprises a grating stabilized laser.

23. The harness of claim 22, wherein the harness body is longer than the second optical subassembly, wherein the cavity receives at least a portion of the laser of the grating stabilized laser.

24. The harness of claim 1, wherein the harness body is configured to maintain substantially the same electromagnetic interference, thermal, and electrical properties substantially independent of the shape of the cavity and form factor of the optical subassembly.

25. A harness for retrofitting optical subassemblies in an optical assembly housing, comprising:
(a) a first portion capable of residing within the optical assembly housing, the first portion comprising:
(a1) a first feature in which a first subassembly may reside, the first feature comprising a first mechanism for substantially constraining the first subassembly in at least one degree of freedom, and
(a2) a second feature in which a second subassembly may reside, the second cavity comprising a second mechanism for substantially constraining the second subassembly in at least one degree of freedom; and
(b) a second portion capable of residing within the optical assembly housing, the second portion comprising:
(b1) a third feature in which the first subassembly may reside, the third feature comprising a third mechanism for substantially constraining the first subassembly in at least one degree of freedom, and
(b2) a fourth feature in which the second subassembly may reside, the fourth feature comprising a fourth mechanism for substantially constraining the second subassembly in at least one degree of freedom,
wherein when the first subassembly resides in the first and third features, and when the second subassembly resides in the second and fourth features, the first and second subassemblies are substantially constrained in six degrees of freedom.

26. The harness of claim 25, wherein the first, second, third, or fourth feature comprises a cavity.

27. The harness of claim 25, wherein the first or third features comprises at least one ridge which approximately matches at least one ridge of the first subassembly.

28. The harness of claim 25, wherein the second or fourth features comprises at least one ridge which approximately matches at least one ridge of the second subassembly.

29. The harness of claim 25, wherein the first or second feature traverses the first portion from a first end face of the first portion to a second end face of the first portion opposite to the first end face of the first portion.

30. The harness of claim 25, wherein the third or fourth feature traverses the second portion from a first end face of the second portion to a second end face of the second portion opposite to the first end face of the second portion.

31. The harness of claim 25, further comprising a mechanism for coupling the first portion to the second portion, wherein the first subassembly and the second subassembly are substantially constrained in the six degrees of freedom when the first and second portions are coupled.

32. The harness of claim 31, wherein the mechanism for coupling comprises:
a first snap coupled to a first side face of the first portion, the first snap comprising a first lip;
a second snap coupled to a second side face of the first portion opposite to the first side face of the first portion, the second snap comprising a second lip;
a first opening at a first side face of the second portion, the first opening comprising a first ridge, wherein the first ridge is capable of engaging the first lip; and
a second opening at a second side face of the second portion, the second opening comprising a second ridge, wherein the second ridge is capable of engaging the second lip.

33. The harness of claim 25, wherein the first portion further comprises a third opening traversing from a top face of the first portion to a bottom face of the first portion opposite to the top face of the first portion, wherein a post of the housing is capable of residing within the third opening.

34. The harness of claim 25, wherein the second portion further comprises a fourth opening traversing from a top face of the second portion to a bottom face of the second portion opposite to the top face of the second portion, wherein a post of the housing is capable of residing within the fourth opening.

35. The harness of claim 25, further comprising:
a third ridge coupled to a top face of the first portion; and
a first indention at the bottom face of the second portion, wherein the third ridge is capable of residing within the first indention.

36. The harness of claim 25, further comprising:
a second indention at a first side face of the first portion;
a third indention at a second side face of the first portion opposite to the first side face of the first portion;
a fourth indention at a first side face of the second portion; and
a fifth indention at a second side face of the second portion opposite to the first side face of the first portion, wherein a first protrusion of the housing may reside within the second and fourth indentions, wherein a second protrusion of the housing may reside within the third and fifth indentions.

37. The harness of claim 25, further comprising:
a fifth opening at the first feature;
a sixth opening at the second feature;
a seventh opening at the third feature; and
an eighth opening at the fourth feature, wherein the fifth, sixth, seventh, and eighth openings assist in heat dissipation of the first or second subassemblies.

38. The harness of claim 25, further comprising a clip capable of engaging the first and second portions.

39. The harness of claim 38, wherein the clip comprises:
a first slanted surface coupled to a top face and a first side wall of the clip, wherein the first slanted surface is capable of abutting against a first slanted surface of the housing; and
a second slanted surface coupled to the top face and a second side wall of the clip opposite to the first side wall of the clip, wherein the second slanted surface is capable of abutting against a second slanted surface of the housing.

40. The harness of claim 38, wherein the clip further comprises:
a third protrusion coupled to a top face of the clip at a first end of the clip, wherein the third protrusion is capable of abutting against a first end face of the second portion;
a fourth protrusion coupled to the top face of the clip at a second end of the clip opposite to the first end of the clip, wherein the fourth protrusion is capable of abutting against a second end face of the second portion opposite to the first end face of the second portion;
a fifth protrusion coupled to a first side wall of the clip distal to the top face of the clip, wherein the fifth protrusion is capable of abutting against a bottom face of the first portion; and
a sixth protrusion coupled to a second side wall of the clip distal to the top face of the clip opposite to the first side face of the clip, wherein the sixth protrusion is capable of abutting against the bottom face of the first portion.

41. The harness of claim 38, wherein the clip further comprises at least one spring coupled to a top face of the clip.

42. The harness of claim 25, wherein the first portion further comprises a ninth opening at a second side face of the first portion proximate to the second feature, wherein a thermal electric cooler may reside within the ninth opening.

43. The harness of claim 42, wherein a thermal conductive material may further reside within the ninth opening.

44. The harness of claim 43, wherein a thermister may further reside within the ninth opening.

45. The harness of claim 25, further comprising:
a first extension coupled to a first end face of the first portion; and
a second extension coupled to a first end face of the second portion.

46. The harness of claim 45, wherein the first extension comprises at least one clip, the at least one clip comprising at least one lip, wherein the at least one lip is capable of engaging at least one connector.

47. The harness of claim 1, wherein the first portion comprises a front plate, wherein the second portion comprises a back plate.

48. The harness of claim 47, wherein the front plate comprises at least one lip, wherein the back plate comprises at least one ridge, wherein the front plate is coupled to the back plate with an interference fit, wherein the at least one lip engages the at least one ridge.

49. A harness for retrofitting optical subassemblies in an optical assembly housing, comprising:
a first feature, wherein a first subassembly may reside within the first feature, wherein a size of the first feature is smaller than a size of the first subassembly, wherein when the first subassembly resides within the first feature, the first subassembly is substantially constrained in six degrees of freedom by interference; and
a second feature, wherein a second subassembly may reside within the second feature, wherein a size of the second feature is smaller than a size of the second subassembly, wherein when the second subassembly resides within the second feature, the second subassembly is substantially constrained in six degrees of freedom by interference.

50. A method of manufacturing a harness for securing a first optical subassembly and a second optical subassembly in a housing, wherein the first and second optical subassemblies have different form factors, the method comprising:
providing a first mold which defines external features of the harness which interface with am interior surface of the housing;
providing a second mold which defines internal features of the harness which interface with an exterior surface of the first optical subassembly;
using the first mold and the second mold to create the harness for securing the first optical subassembly in the housing;
providing a third mold which defines internal features of the harness which interface with the exterior surface of the second optical subassembly; and
using the first mold and the third mold to create the harness for securing the second optical subassembly in the housing.
